(19) United States
(12) Patent Application Publication
(10) Pub. No.: US 2008/0011172 A1
(43) Pub. Date: Jan. 17, 2008

(54) INK TRANSPORT ROUTE SWITCHING METHOD AND APPARATUS IN INKING DEVICE OF PRINTING PRESS

(75) Inventor: Hiroshi TAKAHASHI, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/567,639

(22) Filed: Dec. 6, 2006

(30) Foreign Application Priority Data
Dec. 7, 2005 (JP) 2005-353137

(51) Int. Cl. B41F 1/46; B41F 33/16

(52) U.S. Cl. 101/363; 101/484

(57) ABSTRACT

An ink transport route switching apparatus in an inking device of a printing press, the inking device being arranged to supply ink to a printing plate via an ink transport route composed of a plurality of ink rollers, and equipped with an ink distribution roller which moves to a first position and a second position to switch the ink transport route between a first ink transport route and a second ink transport route, the ink transport route switching apparatus comprising a control device which finds image area rates or image areas in a plurality of ranges, divided in a lateral direction, of an image to be printed; finds a difference between the image area rates or the image areas in the adjacent ranges; compares the difference between the image area rates or the image areas with a reference value for switching the ink transport route.

### BACKGROUND OF THE INVENTION

1. Field of the Invention

This invention relates to an ink transport route switching method and apparatus in an inking device of an offset printing press, an intaglio printing press, a gravure printing press, etc.

2. Description of the Related Art

Generally, an inking device of an offset printing press transports and transfers ink, which is stored in an ink fountain, in a roller arrangement by the following route: ink fountain roller→ink ductor roller→ink distribution roller→ink oscillating roller→ink form roller. In this manner, the inking device supplies ink to a printing plate wound round the circumferential surface of a plate cylinder, and a print (image) is produced on paper in a printing unit.

With the above-mentioned inking device, printing is performed via the ink transport route in which ink is always supplied, at a predetermined rate, to a plurality of ink form rollers for transfer of the ink, regardless of the image.

As shown in FIGS. 5a, 5b, therefore, the following printing troubles may be caused: If the image area (a hatched region in the drawings) is uniform in the sheet width direction, and the amount of dampening water supplied to the printing plate is too large (see FIG. 5a), color irregularities occur. If the image area is nonuniform in the sheet width direction (see FIG. 5b), a ghost appears in which the color density at a portion e, in particular, increases.

In earlier technologies, as disclosed in Japanese Unexamined Patent Publication No. 1997-272196, an operator confirms the image to be printed. If the image is such that the image area rate is greatly different in the sheet width direction and has a high possibility for ghost occurrence, the operator manually throws a switching roller onto a predetermined ink oscillating roller to supply a larger amount of ink to the ink form roller on the dampening side, thereby establishing an ink roller arrangement in which a ghost minimally appears. If the image is such that the image area rate is uniform in the sheet width direction and has a high possibility for color irregularities, the operator manually throws the switching roller off the predetermined ink oscillating roller to supply a smaller amount of ink to the ink form roller on the dampening side, thereby establishing an ink roller arrangement in which color irregularities minimally occur.

With the inking device disclosed in Japanese Unexamined Patent Publication No. 1997-272196, however, the operator makes a judgment and carries out switching manually. This has posed a first problem that the operator is burdened, the rate of operation is decreased, and the operator sometimes forgets to do switching, thus performing switching after start of printing. This has led to a further decrease in the rate of operation, and a waste of printing material.

If the image area rate is low overall, the following second problem is posed: In response to such a low image area rate, an attempt may be made to throw the switching roller onto the above-mentioned ink oscillating roller, thereby supplying a larger amount of ink to the ink form roller on the dampening side. In this case, an excess of dampening water rises into the inking device, emulsifying the ink. This makes the operator's judgment difficult, increasing burden on the operator and decreasing the rate of operation. Further, a mistake in switching is induced, whereby switching is performed after printing is started. This has led to an even greater decrease in the rate of operation, and a further waste of printing material.

The present invention has been accomplished in light of the above-described problems with the earlier technologies. The present invention provides an ink transport route switching method and apparatus in the inking device of a printing press, which, before start of printing, automatically perform switching to an ink transport route for supplying ink, at an optimum ink supply rate, to each ink form roller according to printing image conditions, thereby enabling a high quality printing product to be always produced, shortening the printing make-ready time and cutting down on the amount of printed wasted paper.

### SUMMARY OF THE INVENTION

A first aspect of the present invention is an ink transport route switching method in an inking device of a printing press, the inking device being arranged to supply ink stored in an ink fountain to a printing plate via an ink transport route composed of a plurality of ink rollers, and the inking device being equipped with a switching roller which moves to a first position and a second position to switch the ink transport route between a first ink transport route and a second ink transport route,

the ink transport route switching method comprising:

finding image area rates or image areas in a plurality of ranges, divided in a lateral direction, of an image to be printed;

finding a difference between the image area rates or the image areas in the adjacent ranges;

comparing the difference between the image area rates or the image areas with a first reference value for switching the ink transport route; and

moving the switching roller to the first position or the second position based on results of the comparison.

A second aspect of the invention is the ink transport route switching method in an inking device of a printing press according to the first aspect, wherein the first ink transport route is the ink transport route in which a ghost occurs with lower possibility than the second ink transport route, and when the difference between the image area rates or the image areas is equal to or greater than, or is greater than, the first reference value, the switching roller is moved to the first position.

A third aspect of the invention is the ink transport route switching method in an inking device of a printing press according to the first aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the difference between the image area rates or the image areas is equal to or greater than, or is greater than, the first reference value, the switching roller is moved to the first position.

A fourth aspect of the invention is the ink transport route switching method in an inking device of a printing press according to the first aspect, further comprising: finding an average of the image area rates, or an average or a sum of the image areas, of a whole of the image to be printed; comparing the average of the image area rates, or the average or the sum of the image areas, with a second reference value for switching the ink transport route; and moving the switching roller to the first position or the second position based on results of the comparison.

A fifth aspect of the invention is the ink transport route switching method in an inking device of a printing press according to the fourth aspect, wherein the first ink transport route is the ink transport route in which a ghost occurs with lower possibility than the second ink transport route, and when the average of the image area rates, or the average or the sum of the image areas is equal to or greater than, or is greater than, the second reference value, the switching roller is moved to the first position.

A sixth aspect of the invention is the ink transport route switching method in an inking device of a printing press according to the fourth aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the average of the image area rates, or the average or the sum of the image areas is equal to or greater than, or is greater than, the second reference value, the switching roller is moved to the first position.

A seventh aspect of the invention is the ink transport route switching method in an inking device of a printing press according to the first aspect, wherein the plurality of the ranges divided in the lateral direction are ranges corresponding to ink fountain keys.

An eighth aspect of the invention is an ink transport route switching method in an inking device of a printing press, the inking device being arranged to supply ink stored in an ink fountain to an ink fountain roller through clearances between ink fountain keys and the ink fountain roller, and supply the ink supplied to the ink fountain roller to a printing plate via an ink transport route composed of a plurality of ink rollers, and the inking device being equipped with a switching roller which moves to a first position and a second position to switch the ink transport route between a first ink transport route and a second ink transport route,

the ink transport route switching method comprising:

finding a difference between opening amounts of the adjacent ink fountain keys;

comparing the difference between the opening amounts of the ink fountain keys with a third reference value for switching the ink transport route; and

moving the switching roller to the first position or the second position based on results of the comparison.

A ninth aspect of the invention is the ink transport route switching method in an inking device of a printing press according to the eighth aspect, wherein the first ink transport route is the ink transport route in which a ghost occurs with lower possibility than the second ink transport route, and when the difference between the opening amounts of the ink fountain keys is equal to or greater than, or is greater than, the third reference value, the switching roller is moved to the first position.

A tenth aspect of the invention is the ink transport route switching method in an inking device of a printing press according to the eighth aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the difference between the opening amounts of the ink fountain keys is equal to or greater than, or is greater than, the third reference value, the switching roller is moved to the first position.

An eleventh aspect of the invention is the ink transport route switching method in an inking device of a printing press according to the eighth aspect, further comprising: finding an average or a sum of the opening amounts of all the ink fountain keys for each color; comparing the average or the sum of the opening amounts of all the ink fountain keys for each color with a fourth reference value for switching the ink transport route; and moving the switching roller to the first position or the second position based on results of the comparison.

A twelfth aspect of the invention is the ink transport route switching method in an inking device of a printing press according to the eleventh aspect, wherein the first ink transport route is the ink transport route in which a ghost occurs with lower possibility than the second ink transport route, and when the average or the sum of the opening amounts of all the ink fountain keys for each color is equal to or greater than, or is greater than, the fourth reference value, the switching roller is moved to the first position.

A thirteenth aspect of the invention is the ink transport route switching method in an inking device of a printing press according to the eleventh aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the average or the sum of the opening amounts of all the ink fountain keys for each color is equal to or greater than, or is greater than, the fourth reference value, the switching roller is moved to the first position.

A fourteenth aspect of the invention is the ink transport route switching method in an inking device of a printing press according to the first or eight aspect, further comprising performing processings for each color.

A fifteenth aspect of the invention is an ink transport route switching apparatus in an inking device of a printing press, the inking device being arranged to supply ink stored in an ink fountain to a printing plate via an ink transport route composed of a plurality of ink rollers, and the inking device being equipped with a switching roller which moves to a first position and a second position to switch the ink transport route between a first ink transport route and a second ink transport route,

the ink transport route switching apparatus comprising:

a control device which

finds image area rates or image areas in a plurality of ranges, divided in a lateral direction, of an image to be printed,

finds a difference between the image area rates or the image areas in the adjacent ranges,

compares the difference between the image area rates or the image areas with a first reference value for switching the ink transport route, and

moves the switching roller to the first position or the second position based on results of the comparison.

A sixteenth aspect of the invention is the ink transport route switching apparatus in an inking device of a printing press according to the fifteenth aspect, wherein the first ink transport route is the ink transport route in which a ghost occurs with lower possibility than the second ink transport route, and when the difference between the image area rates or the image areas is equal to or greater than, or is greater than, the first reference value, the control device moves the switching roller to the first position.

A seventeenth aspect of the invention is the ink transport route switching apparatus in an inking device of a printing press according to the fifteenth aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the difference between the image area rates or the image areas is equal to or greater than, or is greater than, the first reference value, the control device moves the switching roller to the first position.

An eighteenth aspect of the invention is the ink transport route switching apparatus in an inking device of a printing press according to the fifteenth aspect, wherein the control device finds an average of the image area rates, or an average or a sum of the image areas, of a whole of the image to be printed; compares the average of the image area rates, or the average or the sum of the image areas, with a second reference value for switching the ink transport route; and moves the switching roller to the first position or the second position based on results of the comparison.

A nineteenth aspect of the invention is the ink transport route switching apparatus in an inking device of a printing press according to the eighteenth aspect, wherein the first ink transport route is the ink transport route in which a ghost occurs with lower possibility than the second ink transport route, and when the average of the image area rates, or the average or the sum of the image areas is equal to or greater than, or is greater than, the second reference value, the control device moves the switching roller to the first position.

A twentieth aspect of the invention is the ink transport route switching apparatus in an inking device of a printing press according to the eighteenth aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the average of the image area rates, or the average or the sum of the image areas is equal to or greater than, or is greater than, the second reference value, the control device moves the switching roller to the first position.

A twenty-first aspect of the invention is the ink transport route switching apparatus in an inking device of a printing press according to the fifteenth aspect, wherein the plurality of the ranges divided in the lateral direction are ranges corresponding to ink fountain keys.

A twenty-second aspect of the invention is an ink transport route switching apparatus in an inking device of a printing press, the inking device being arranged to supply ink stored in an ink fountain to an ink fountain roller through clearances between ink fountain keys and the ink fountain roller, and supply the ink supplied to the ink fountain roller to a printing plate via an ink transport route composed of a plurality of ink rollers, and the inking device being equipped with a switching roller which moves to a first position and a second position to switch the ink transport route between a first ink transport route and a second ink transport route,

the ink transport route switching apparatus comprising:

a control device which

finds a difference between opening amounts of the adjacent ink fountain keys,

compares the difference between the opening amounts of the ink fountain keys with a third reference value for switching the ink transport route, and

moves the switching roller to the first position or the second position based on results of the comparison.

A twenty-third aspect of the invention is the ink transport route switching apparatus in an inking device of a printing press according to the twenty-second aspect, wherein the first ink transport route is the ink transport route in which a ghost occurs with lower possibility than the second ink transport route, and when the difference between the opening amounts of the ink fountain keys is equal to or greater than, or is greater than, the third reference value, the control device moves the switching roller to the first position.

A twenty-fourth aspect of the invention is the ink transport route switching apparatus in an inking device of a printing press according to the twenty-second aspect, the inkling device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the difference between the opening amounts of the ink fountain keys is equal to or greater than, or is greater than, the third reference value, the control device moves the switching roller to the first position.

A twenty-fifth aspect of the invention is the ink transport route switching apparatus in an inking device of a printing press according to the twenty-second aspect, wherein the control device finds an average or a sum of the opening amounts of all the ink fountain keys for each color; compares the average or the sum of the opening amounts of all the ink fountain keys for each color with a fourth reference value for switching the ink transport route; and moves the switching roller to the first position or the second position based on results of the comparison.

A twenty-sixth aspect of the invention is the ink transport route switching apparatus in an inking device of a printing press according to the twenty-fifth aspect, wherein the first ink transport route is the ink transport route in which a ghost occurs with lower possibility than the second ink transport route, and when the average or the sum of the opening amounts of all the ink fountain keys for each color is equal to or greater than, or is greater than, the fourth reference value, the control device moves the switching roller to the first position.

A twenty-seventh aspect of the invention is the ink transport route switching apparatus in an inking device of a printing press according to the twenty-fifth aspect, the inking device further comprising a plurality of ink form rollers for supplying the ink to the printing plate, and a dampener for supplying dampening water to the printing plate, wherein the first ink transport route is the ink transport route for supplying a larger amount of the ink to the ink form rollers on a side of the dampener than the second ink transport route, and when the average or the sum of the opening amounts of all the ink fountain keys for each color is equal to or greater than, or is greater than, the fourth reference value, the control device moves the switching roller to the first position.

A twenty-eighth aspect of the invention is the ink transport route switching apparatus in an inking device of a printing press according to the fifteenth or twenty-second aspect, arranged to perform processings for each color.

According to the present invention, switching to the ink transport route for supplying ink, at an optimum ink supply rate, to each ink form roller according to printing image conditions can be automatically performed before start of printing, whereby a high quality printing product can be always produced, the printing make-ready time can be shortened, and the amount of printed wasted paper can be decreased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an explanation drawing showing the roller arrangement of an inking device illustrating Embodiment 1 of the present invention;

FIG. 2 is a developed sectional plan view of an ink transport route switching apparatus;

FIG. 3 is a side view of the ink transport route switching apparatus;

FIG. 4 is an explanation drawing of an image area rate difference Dt between adjacent ink fountain keys, and an image area rate average value Dav of the adjacent ink fountain keys;

FIGS. 5a and 5b are explanation drawings of printing products having different images;

FIG. 6a is a block diagram of an ink supply amount control device;

FIG. 6b is a block diagram of the ink supply amount control device;

FIG. 7 is a block diagram of an ink fountain key opening amount control device;

FIG. 8 is a block diagram of an ink fountain roller rotation amount control device;

FIG. 9a is an action flow chart of the ink supply amount control device;

FIG. 9b is an action flow chart of the ink supply amount control device;

FIG. 9c is an action flow chart of the ink supply amount control device;

FIG. 10a is an action flow chart of the ink supply amount control device;

FIG. 10b is an action flow chart of the ink supply amount control device;

FIG. 11a is an action flow chart of the ink supply amount control device;

FIG. 11b is an action flow chart of the ink supply amount control device;

FIG. 12a is an action flow chart of the ink fountain key opening amount control device;

FIG. 12b is an action flow chart of the ink fountain key opening amount control device;

FIG. 13 is an action flow chart of the ink fountain roller rotation amount control device;

FIG. 14a is a block diagram of an ink supply amount control device showing Embodiment 2 of the present invention;

FIG. 14b is a block diagram of the ink supply amount control device;

FIG. 15 is a block diagram of an ink fountain key opening amount control device in Embodiment 2;

FIG. 16 is a block diagram of an ink fountain roller rotation amount control device in Embodiment 2;

FIG. 17a is an action flow chart of the ink supply amount control device;

FIG. 17b is an action flow chart of the ink supply amount control device;

FIG. 17c is an action flow chart of the ink supply amount control device;

FIG. 18a is an action flow chart of the ink supply amount control device;

FIG. 18b is an action flow chart of the ink supply amount control device;

FIG. 18c is an action flow chart of the ink supply amount control device;

FIG. 19a is an action flow chart of the ink supply amount control device;

FIG. 19b is an action flow chart of the ink supply amount control device;

FIG. 20a is an action flow chart of the ink fountain key opening amount control device;

FIG. 20b is an action flow chart of the ink fountain key opening amount control device;

FIG. 21 is an action flow chart of the ink fountain roller rotation amount control device;

FIG. 22a is a block diagram of an ink supply amount control device showing Embodiment 3 of the present invention;

FIG. 22b is a block diagram of the ink supply amount control device;

FIG. 23 is a block diagram of an ink fountain key opening amount control device in Embodiment 3;

FIG. 24 is a block diagram of an ink fountain roller rotation amount control device in Embodiment 3;

FIG. 25a is an action flow chart of the ink supply amount control device;

FIG. 25b is an action flow chart of the ink supply amount control device;

FIG. 25c is an action flow chart of the ink supply amount control device;

FIG. 25d is an action flow chart of the ink supply amount control device;

FIG. 25e is an action flow chart of the ink supply amount control device;

FIG. 26a is an action flow chart of the ink supply amount control device;

FIG. 26b is an action flow chart of the ink supply amount control device;

FIG. 26c is an action flow chart of the ink supply amount control device;

FIG. 27a is an action flow chart of the ink fountain key opening amount control device;

FIG. 27b is an action flow chart of the ink fountain key opening amount control device;

FIG. 28 is an action flow chart of the ink fountain roller rotation amount control device;

FIG. 29a is a block diagram of a switching control device showing Embodiment 4 of the present invention;

FIG. 29b is a block diagram of the switching control device;

FIG. 30 is a block diagram of an ink fountain key opening amount control device in Embodiment 4;

FIG. 31a is an action flow chart of the switching control device;

FIG. 31b is an action flow chart of the switching control device;

FIG. 31c is an action flow chart of the switching control device;

FIG. 31d is an action flow chart of the switching control device;

FIG. 31e is an action flow chart of the switching control device;

FIG. 32 is an action flow chart of the switching control device; and

FIG. 33 is an action flow chart of the ink fountain key opening amount control device.

### DETAILED DESCRIPTION OF THE INVENTION

The ink transport route switching method and apparatus in an inking device of a printing press according to the present invention will be described in detail by embodiments of the invention with reference to the accompanying drawings.

### Embodiment 1

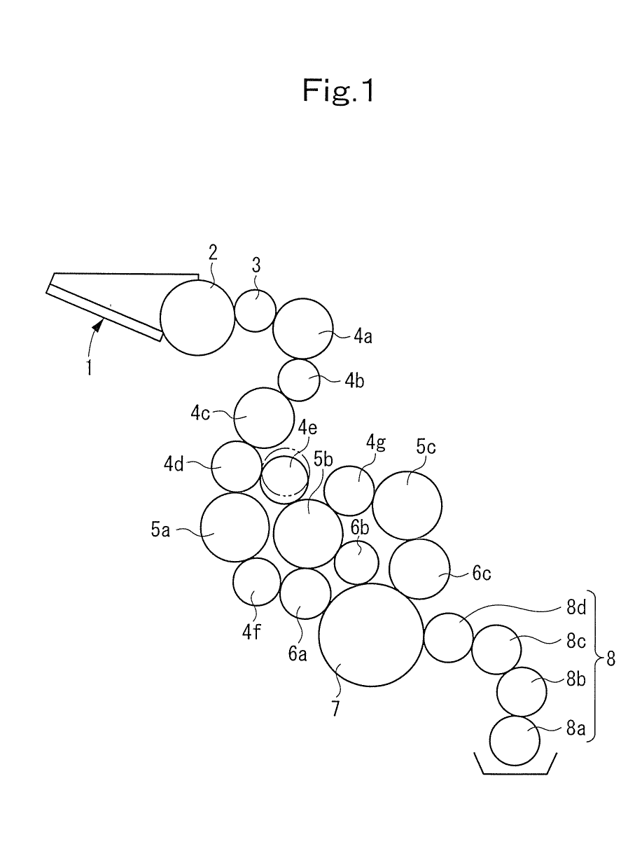

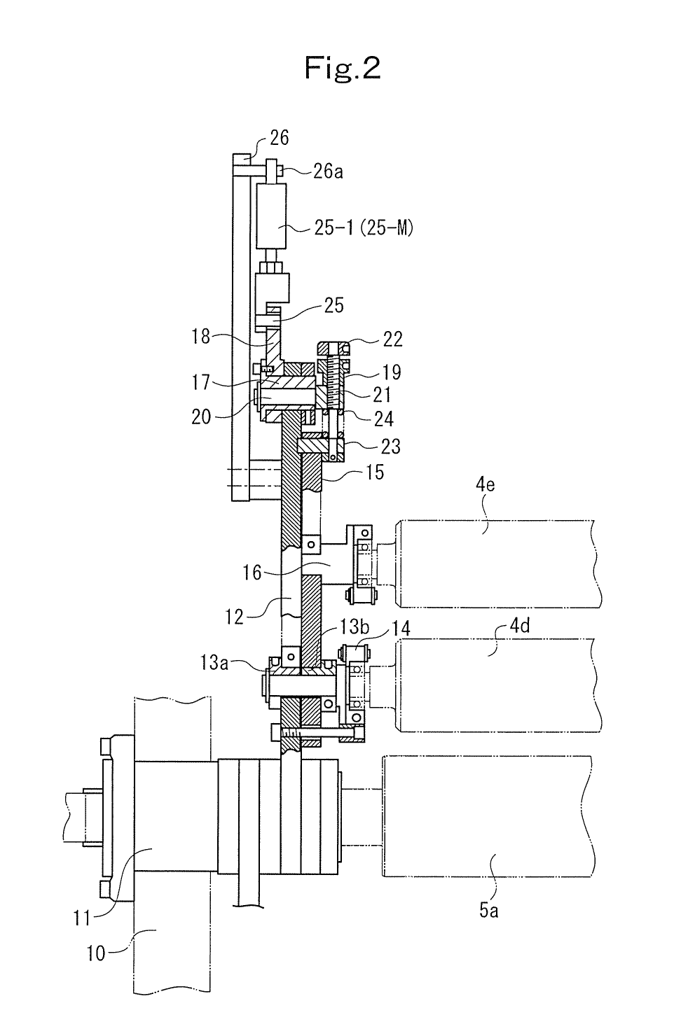

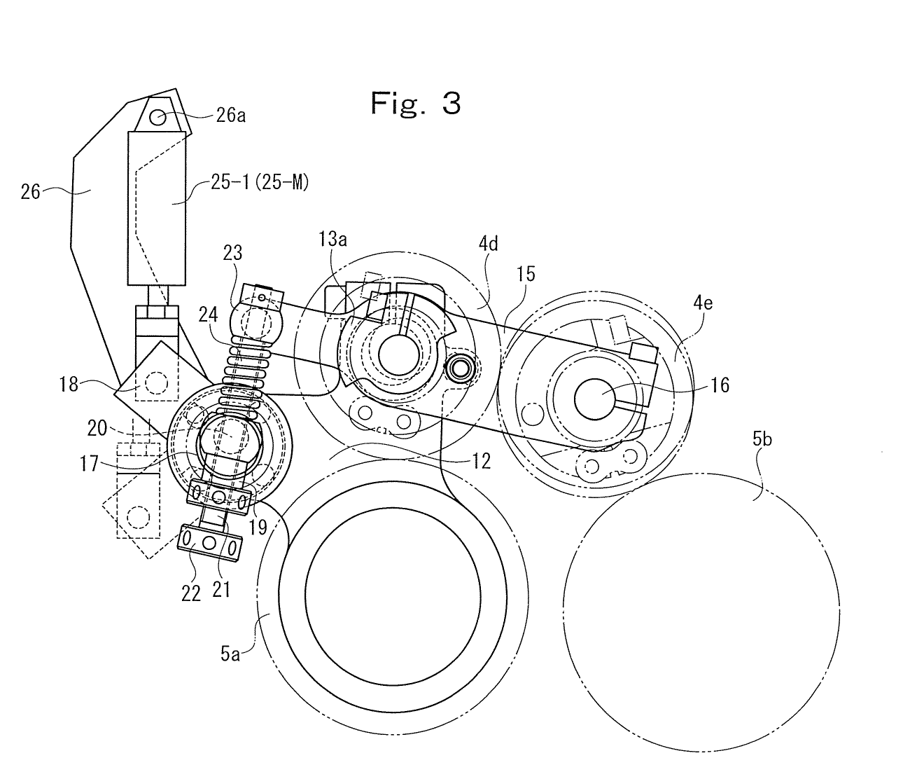

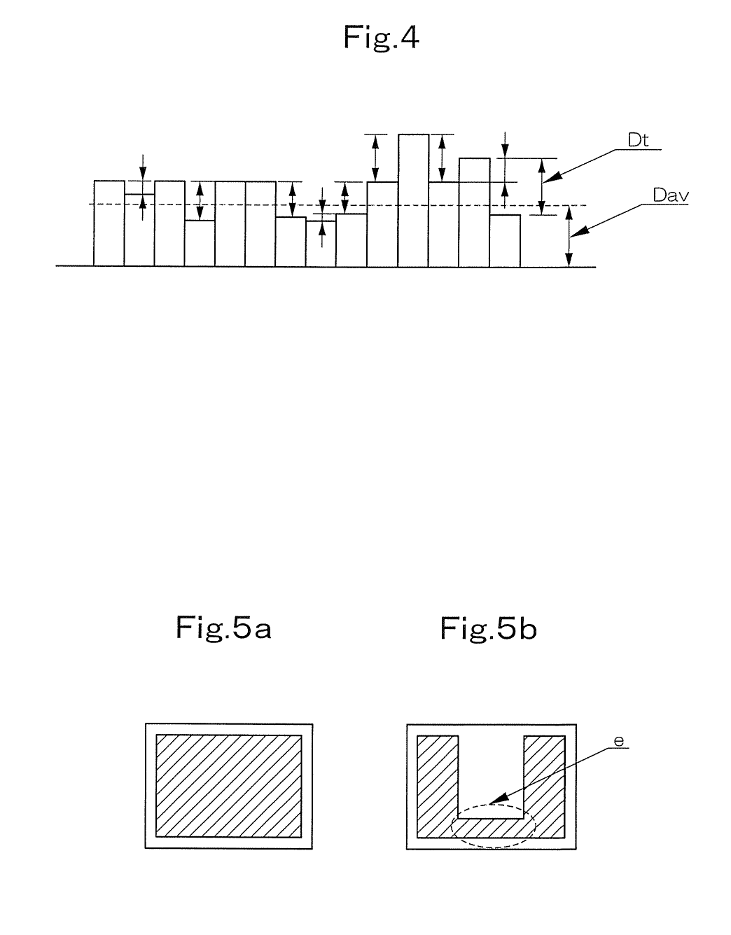

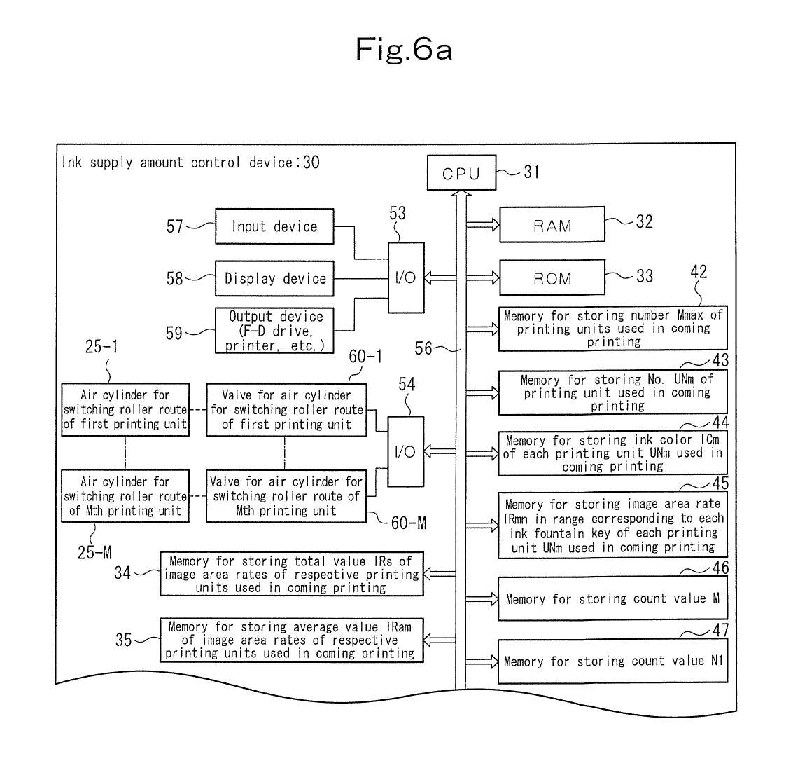

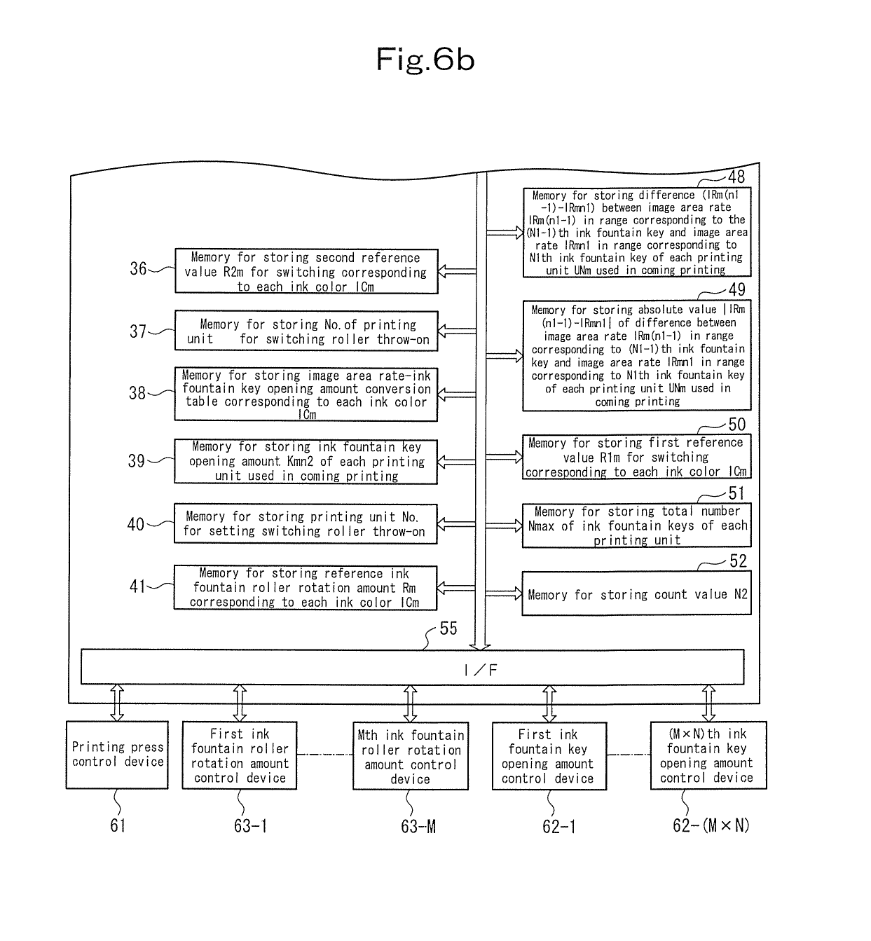

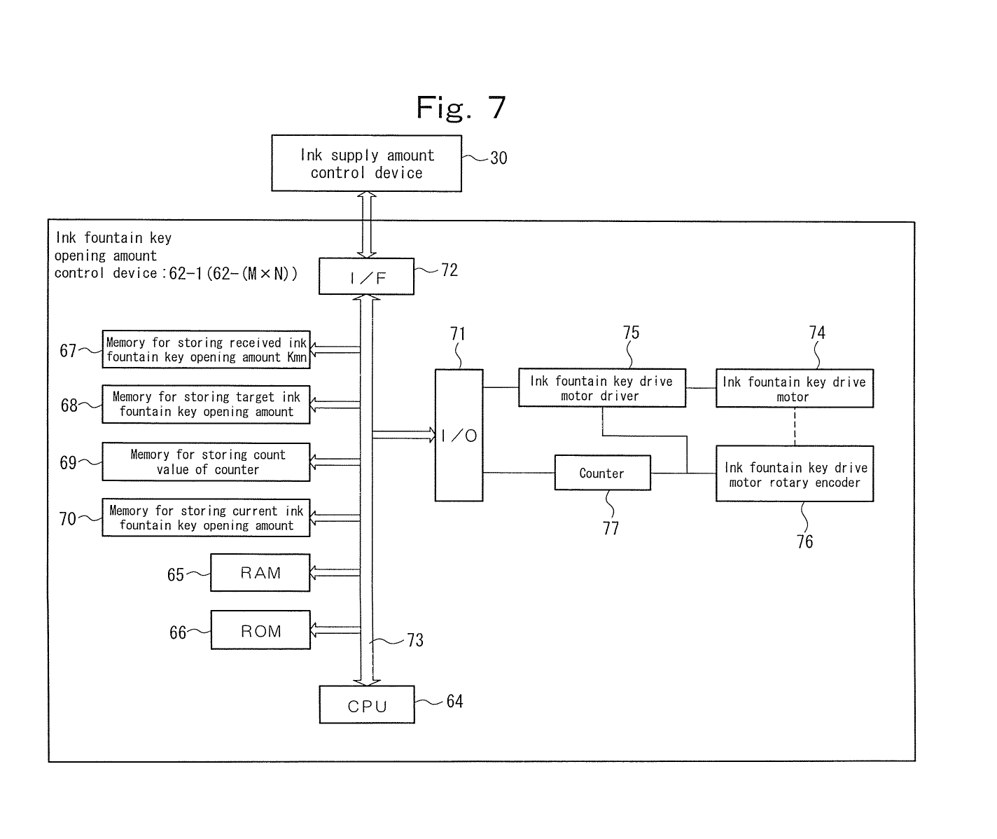

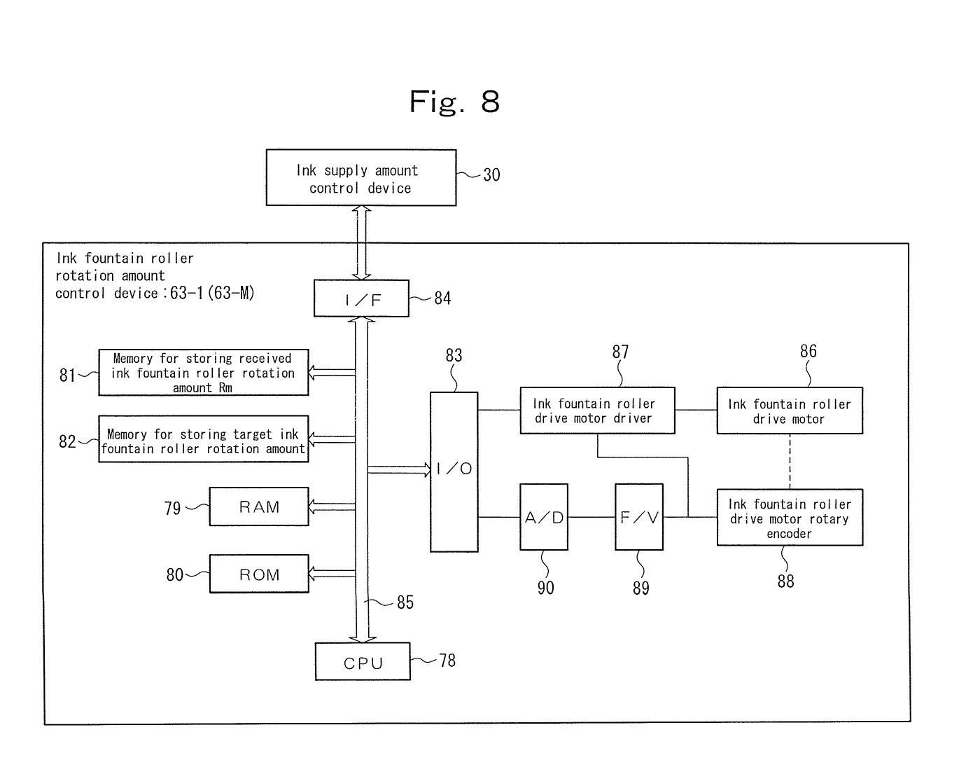

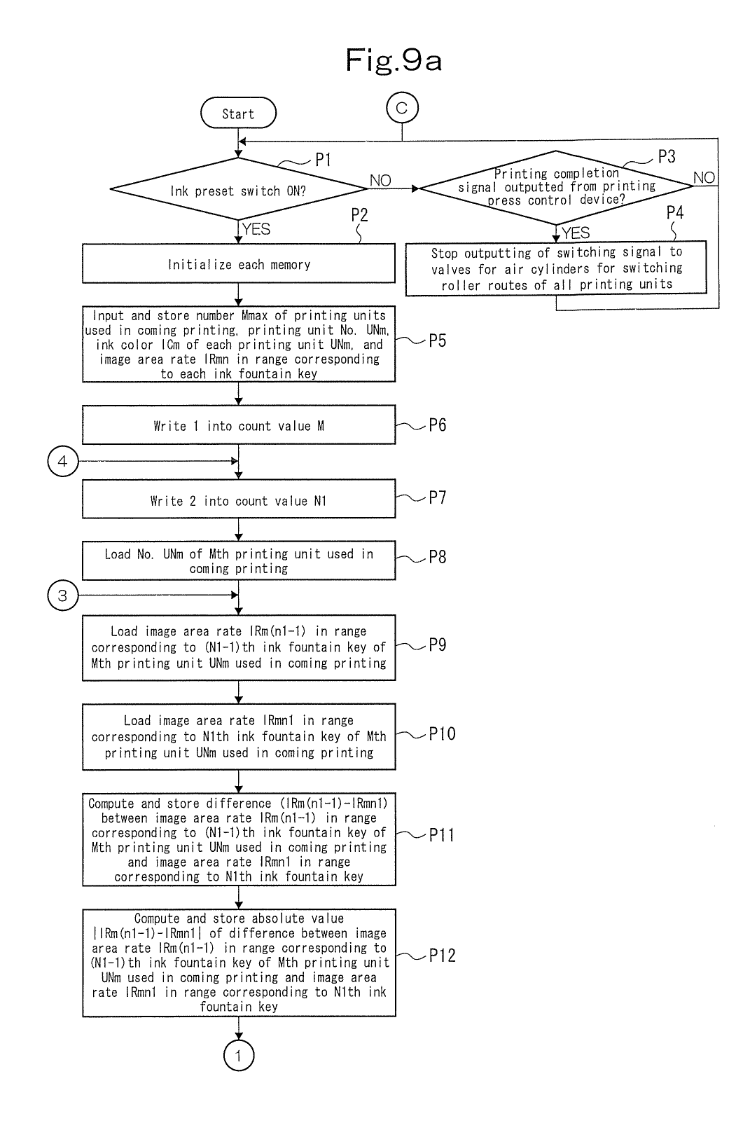

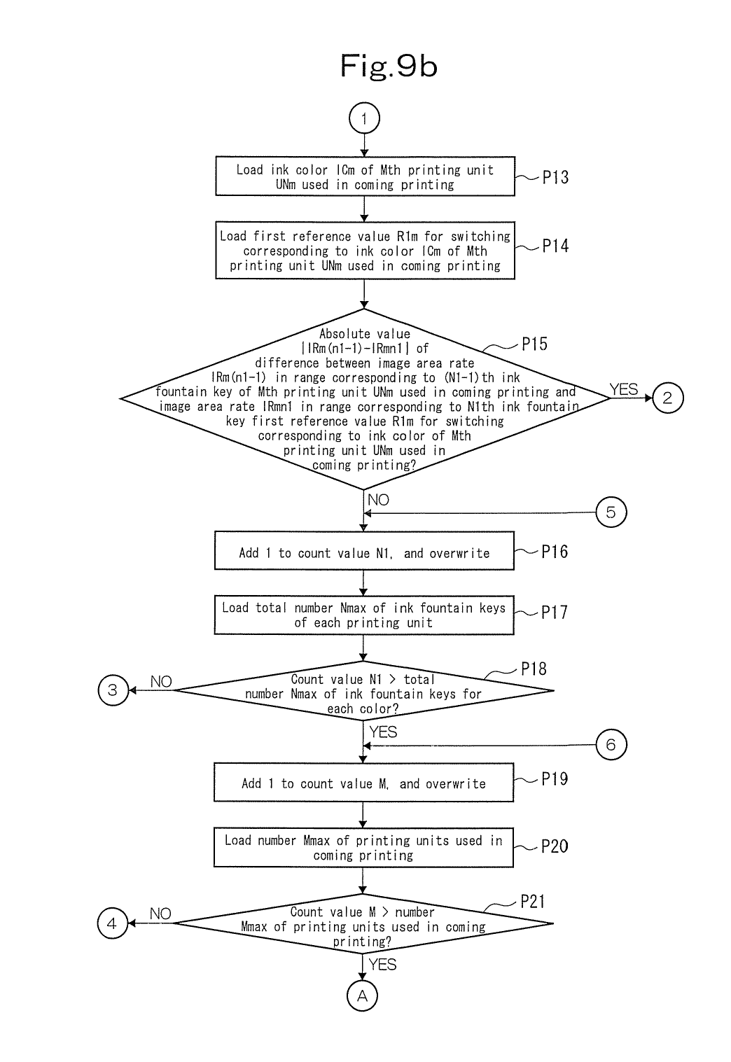

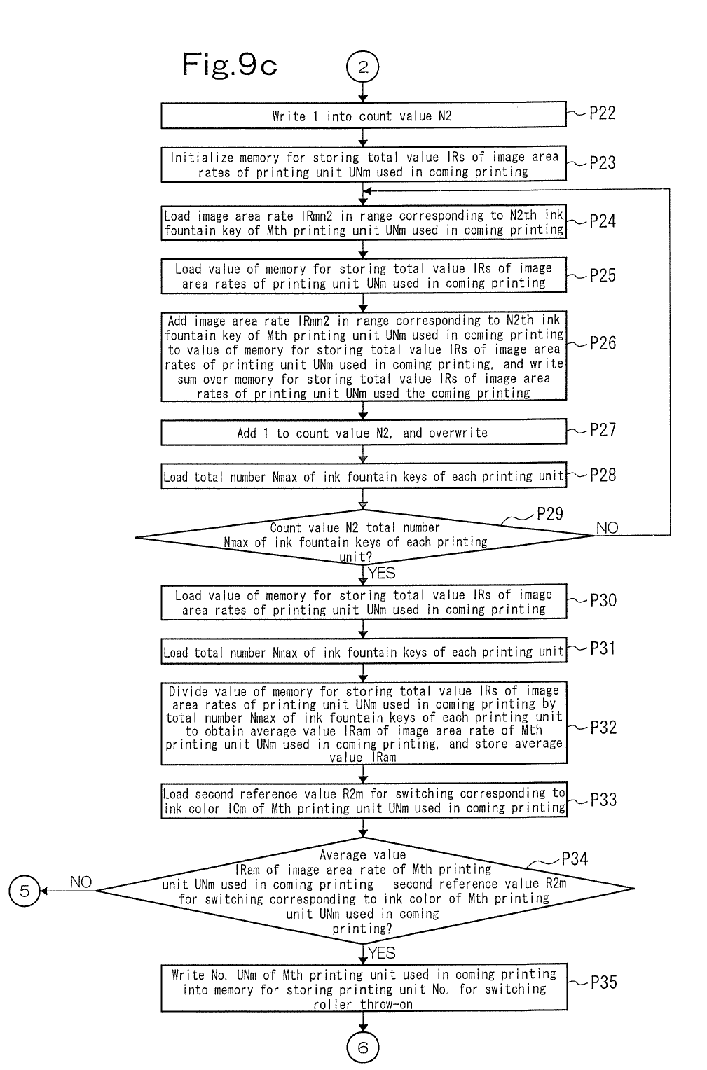

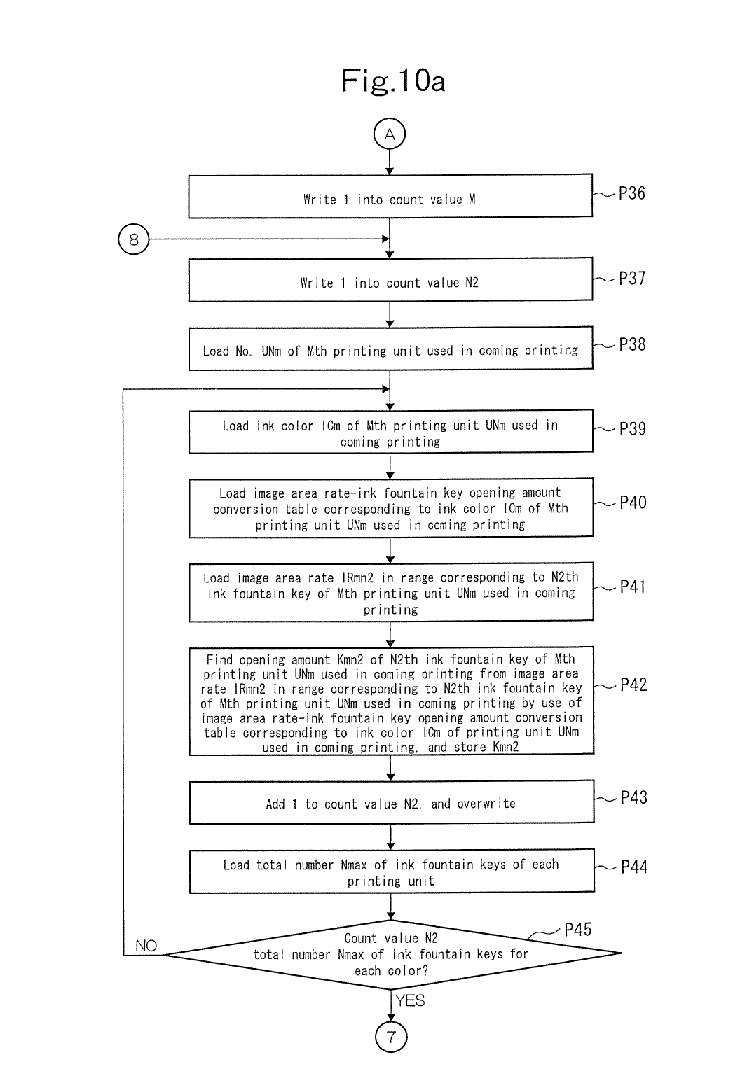

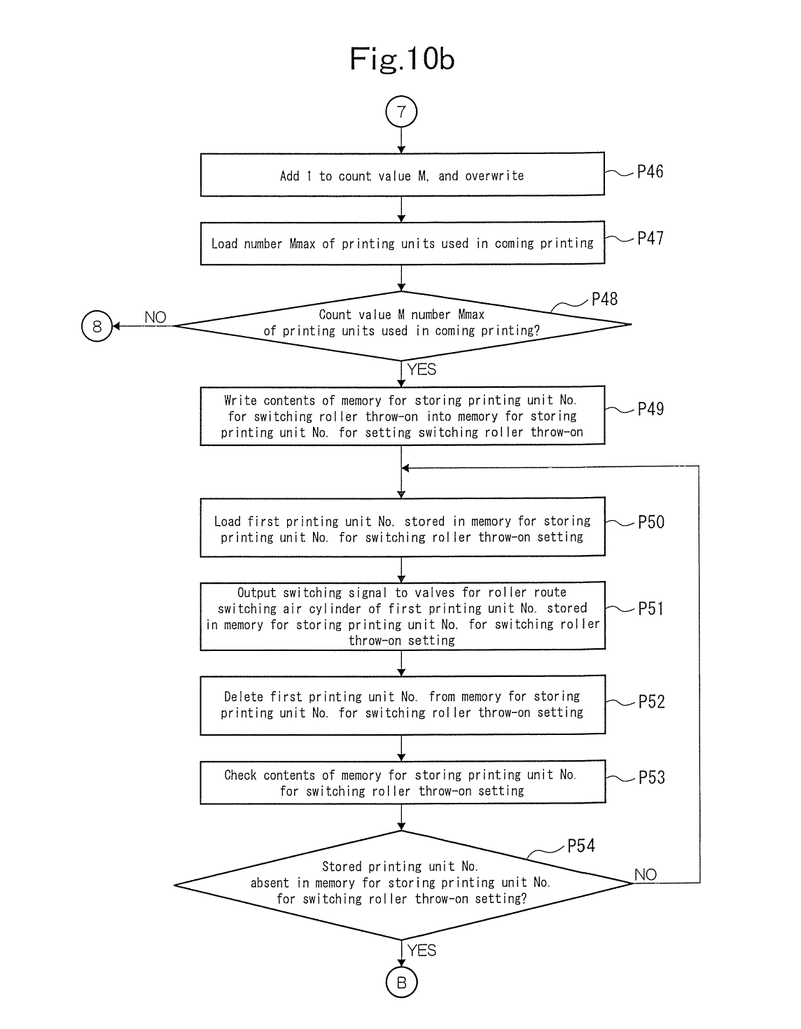

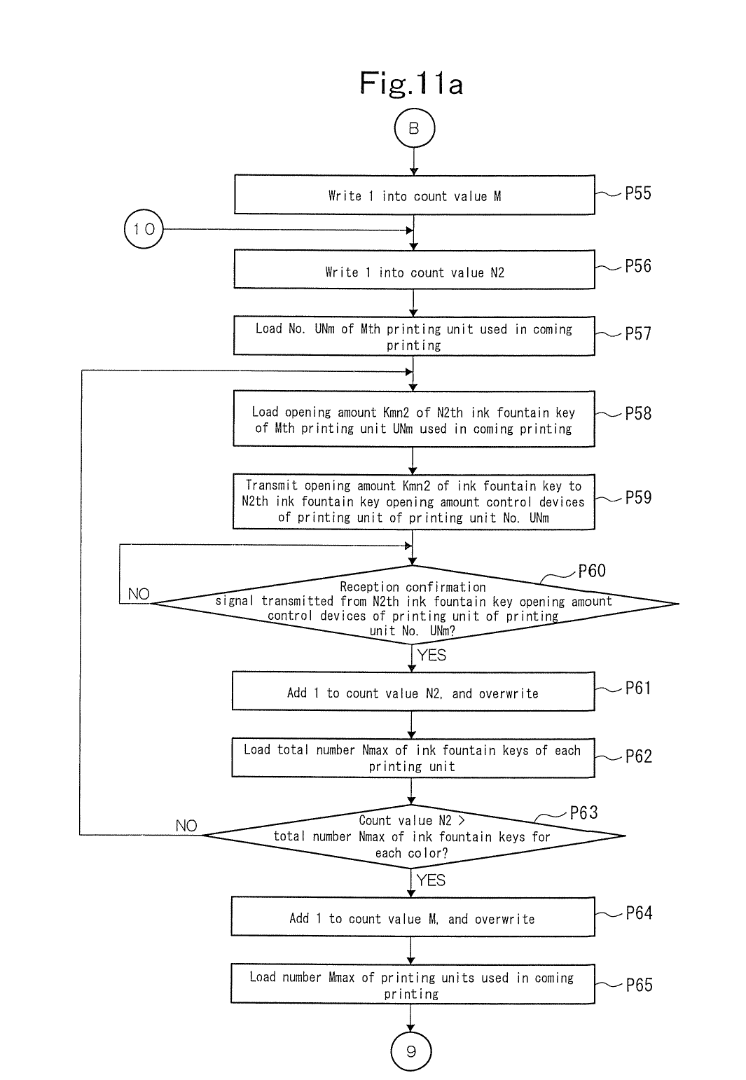

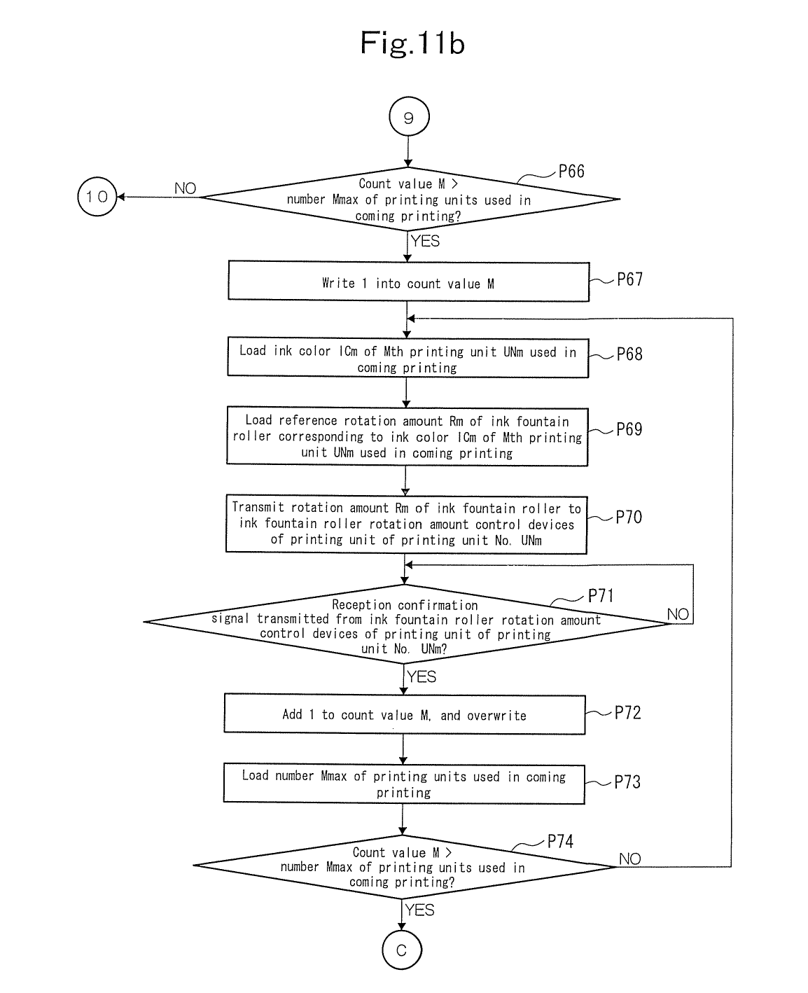

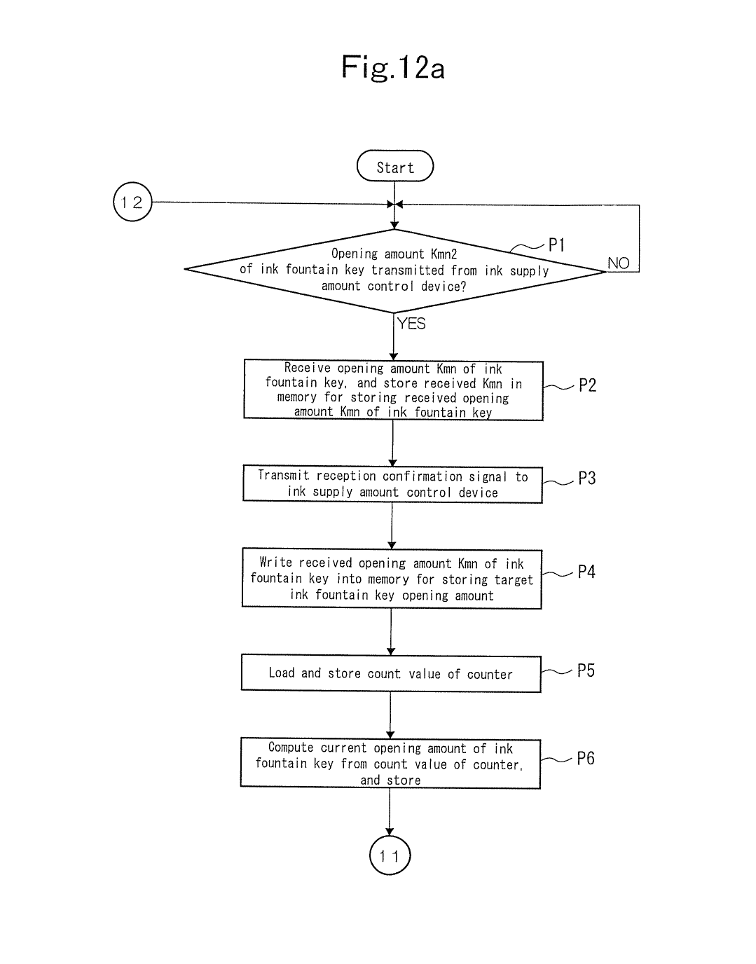

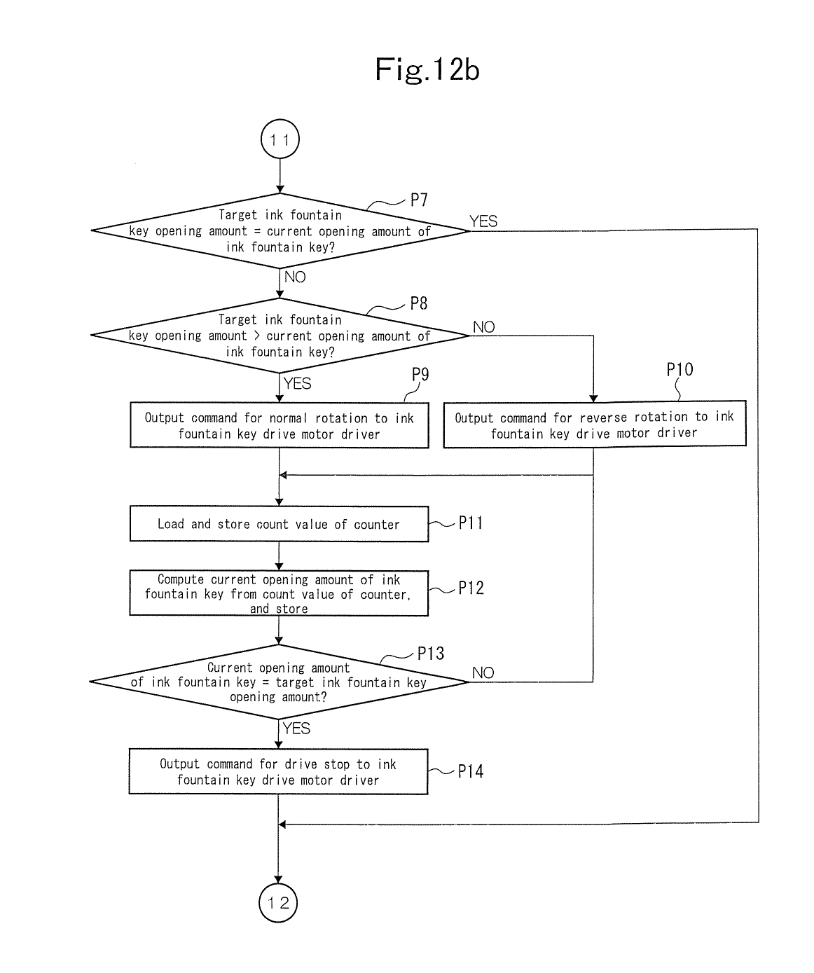

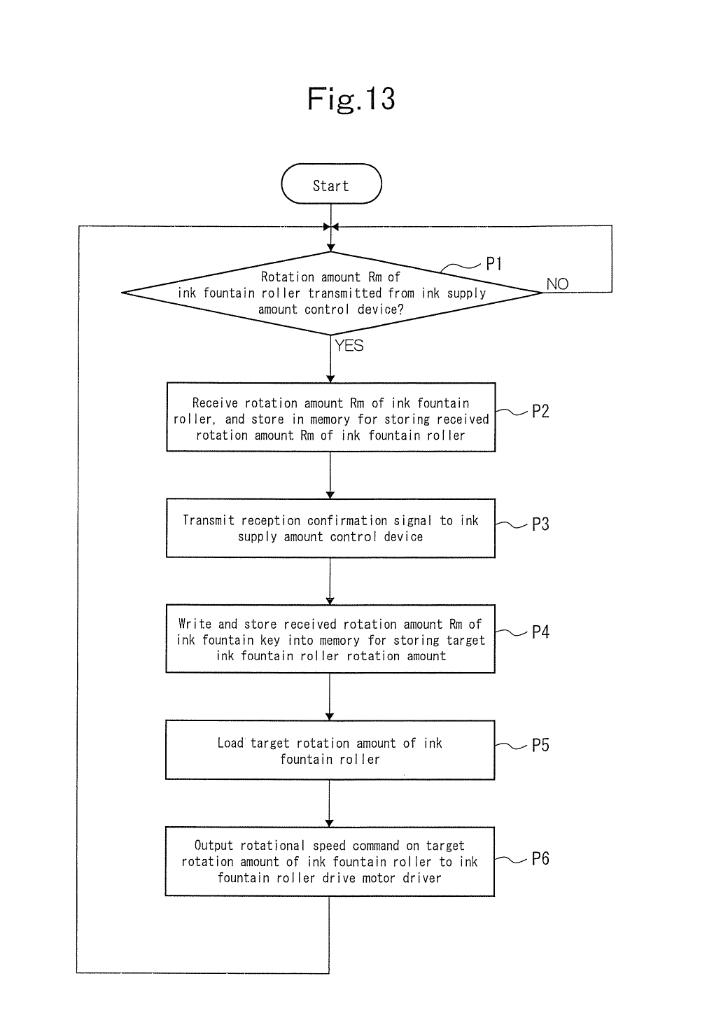

FIG. 1 is an explanation drawing showing the roller arrangement of an inking device illustrating Embodiment 1 of the present invention. FIG. 2 is a developed sectional plan view of an ink transport route switching apparatus. FIG. 3 is a side view of the ink transport route switching apparatus. FIG. 4 is an explanation drawing of an image area rate difference Dt between adjacent ink fountain keys, and an image area rate average value Dav of the adjacent ink fountain keys. FIGS. 5a and 5b are explanation drawings of printing products having different images. FIG. 6a is a block diagram of an ink supply amount control device. FIG. 6b is a block diagram of the ink supply amount control device. FIG. 7 is a block diagram of an ink fountain key opening amount control device. FIG. 8 is a block diagram of an ink fountain roller rotation amount control device. FIG. 9a is an action flow chart of the ink supply amount control device. FIG. 9b is an action flow chart of the ink supply amount control device. FIG. 9c is an action flow chart of the ink supply amount control device. FIG. 10a is an action flow chart of the ink supply amount control device. FIG. 10b is an action flow chart of the ink supply amount control device. FIG. 11a is an action flow chart of the ink supply amount control device. FIG. 11b is an action flow chart of the ink supply amount control device. FIG. 12a is an action flow chart of the ink fountain key opening amount control device. FIG. 12b is an action flow chart of the ink fountain key opening amount control device. FIG. 13 is an action flow chart of the ink fountain roller rotation amount control device.

As shown in FIG. 1, a roller arrangement for supplying ink stored in an ink fountain 1 to the plate surface (printing plate) of a plate cylinder 7 is composed of an ink fountain roller 2, an ink ductor roller 3, ink distribution rollers 4a to 4g, ink oscillating rollers 5a to 5c, and ink form rollers 6a to 6c. In the drawing, the numeral 8 denotes a dampener composed of a water fountain roller 8a, a ductor roller 8b, a reciprocating roller 8c, and a dampening form roller 8d, and adapted to supply dampening water to the surface of a non-image area in the plate surface of the plate cylinder 7.

In the present embodiment, the ink distribution roller 4e in constant contact with the ink distribution roller 4d disposed ahead of the ink oscillating roller 5a can be thrown on and off the ink oscillating roller 5b disposed directly behind the ink distribution roller 4e, and thus functions as a so-called switching roller.

When the ink distribution roller 4e contacts the ink oscillating roller 5b at a predetermined pressure (the position of contact: first position), the length of the ink transport route to the ink form rollers 6b, 6c, especially the ink form roller 6c, on the side of the dampener 8 becomes small, so that a larger amount of ink is supplied to the ink form rollers 6b, 6c, especially the ink form roller 6c (namely, the ink transport route for supply of a larger amount of ink to the ink form rollers 6b, 6c on the side of the dampener 8: first ink transport route). When the ink distribution roller 4e separates from the ink oscillating roller 5b (the position of non-contact: second position), on the other hand, the length of the ink transport route to the ink form rollers 6b, 6c, especially the ink form roller 6c, on the side of the dampener 8 becomes large, so that a smaller amount of ink is supplied to the ink form rollers 6b, 6c, especially the ink form roller 6c (namely, the ink transport route for supply of a smaller amount of ink to the ink form rollers 6b, 6c on the side of the dampener 8: second ink transport route).

A switching means for the ink distribution roller 4e has opposite end shaft portions of the ink oscillating roller 5a journaled pivotably and axially slidably on right and left frames 10 (only the left frame is shown) of the printing press via bearing housings 11, as shown in FIGS. 2 and 3.

A first lever 12, formed in a Y-shape, has a base end portion journaled to each of the opposite end shaft portions of the ink oscillating roller 5a. Opposite end shaft portions of the ink distribution roller 4d are pivotably journaled at leading end portions of one side (right-hand side in FIG. 3) of the first levers 12 via flanges 13a, 13b and bearing caps 14 pivotally supported by the flanges 13a, 13b.

An intermediate portion (in the right-and-left direction in FIG. 3) of a second lever 15 pivotably supported on the outer periphery of the flange 13b. Each of the opposite end shaft portions of the ink distribution roller 4e, as the switching roller, is pivotably supported at one end portion (right-hand portion in FIG. 3) of the second lever 15 via a bearing cap 16.

An eccentric bush 17 is unreleasably fitted to a leading end portion on the other side (left-hand side) of the first lever 12. A base end portion of a switching lever 18 is journaled on an outer end portion of the outer periphery of the eccentric bush 17. A stud pin 20 with a nut 19 is pivotably and unreleasably fitted into an inner peripheral axial hole of the eccentric bush 17 from the inner end side of the eccentric bush 17.

The nut 19 is attached perpendicularly to the axis of the stud pin 20. A leading end of an adjusting screw 21 with a knob 22, which is screwed to the nut 19, penetrates the stud pin 20, also penetrates a stud pin 23 unreleasably fitted to and passed through the other end portion (left-hand side in FIG. 3) of the second lever 15, and is then mounted to be unreleasable. A helical compression spring 24 is wound round the adjusting screw 21 between the stud pins 20 and 23.

Thus, by gripping the knob 22 and turning the adjusting screw 21, the distance between the stud pins 20 and 23 is changed according to the axial movement of the adjusting screw 21, whereby the second lever 15 swings about the flange 13a, 13b to adjust the nip pressure of the ink distribution roller 4e on the ink oscillating roller 5b.

A piston rod tip of an air cylinder 25-1 is bound to a leading end portion of the switching lever 18 by a pin 25. A head portion of the air cylinder 25-1 is downwardly bound, by a pin 26a, to a support lever 26 secured to the first lever 12.

In the state of the switching lever 18 (as indicated by solid lines in FIG. 3) in which the air cylinder 25-1 is contracted, the ink distribution roller 4e is contacted by the ink oscillating roller 5b. In the state of the switching lever 18 (as indicated by dashed lines in FIG. 3) in which the air cylinder 25-1 is expanded, on the other hand, the downward displacement of the adjusting screw 21 according to the eccentric rotation of the eccentric bush 17 pivots the second lever 15 counterclockwise in FIG. 3 about the flanges 13a, 13b to separate the ink distribution roller 4e from the ink oscillating roller 5b. The above-described switching means for the ink distribution roller 4e is similarly configured on the right frame side which is not illustrated.

As shown in FIGS. 6a and 6b, the air cylinder 25-1 is driven and controlled by an ink supply amount control device 30 to be capable of automatically performing, before start of printing, switching to the ink transport route (the first ink transport route or the second ink transport route) for supplying ink, at an optimum ink supply rate, to the ink form rollers 6a, 6b, 6c in accordance with printing image conditions as shown in FIGS. 5a, 5b.

The ink supply amount control device 30 comprises CPU 31, RAM 32, ROM 33, an input/output device 53, an input/output device 54, an interface 55, and the following memories connected by a bus-line (BUS) 56, as shown in FIGS. 6a and 6b: A memory 34 for storing the total value IRs of the image area rates of the respective printing units used in the coming printing; a memory 35 for storing the average value IRam of the image area rates of the respective printing units used in the coming printing; a memory 36 for storing a second reference value R2m for switching corresponding to each ink color ICm; a memory 37 for storing the No. of a printing unit for switching roller throw-on; a memory 38 for storing an image area rate-ink fountain key opening amount conversion table corresponding to each ink color ICm; a memory 39 for storing the ink fountain key opening amount Kmn2 of each printing unit used in the coming printing; a memory 40 for storing a printing unit No. for setting switching roller throw-on; a memory 41 for storing a reference ink fountain roller rotation amount Rm corresponding to each ink color ICm; a memory 42 for storing the number Mmax of the printing units used in the coming printing; a memory 43 for storing the No. UNm of a printing unit used in the coming printing; a memory 44 for storing the ink color ICm of each printing unit UNm used in the coming printing; a memory 45 for storing an image area rate IRmn in a range corresponding to each ink fountain key of each printing unit UNm used in the coming printing; a memory 46 for storing a count value M; a memory 47 for storing a count value N1; a memory 48 for storing the difference (IRm(n1-1)−IRmn1) between an image area rate IRm(n1-1) in a range corresponding to the (N1-1)th ink fountain key and an image area rate IRmn1 in a range corresponding to the N1th ink fountain key of each printing unit UNm used in the coming printing; a memory 49 for storing the absolute value |IRm(n1-1)−IRmn1| of the difference between the image area rate IRm(n1-1) in the range corresponding to the (N1-1)th ink fountain key and the image area rate IRmn1 in the range corresponding to the N1th ink fountain key of each printing unit UNm used in the coming printing; a memory 50 for storing a first reference value R1m for switching corresponding to each ink color ICm; a memory 51 for storing the total number Nmax of the ink fountain keys of each printing unit; and a memory 52 for storing a count value N2.

An input device 57, such as a keyboard, various switches, and a button, a display device 58, such as CRT and a lamp, and an output device 59, such as an F-D drive, and a printer, are connected to the input/output device 53. To the input/output device 54, there are connected a valve 60-1 for an air cylinder for switching the roller route of the first printing unit through a valve 60-M for an air cylinder for switching the roller route of the Mth printing unit corresponding to the air cylinder 25-1 for switching the roller route of the first printing unit through the air cylinder 25-M for switching the roller route of the Mth printing unit.

To the interface 55, there are connected a printing press control device 61, a first (first printing unit) ink fountain roller rotation amount control device 63-1 through an Mth (Mth printing unit) ink fountain roller rotation amount control device 63-M, and a first ink fountain key opening amount control device 62-1 through an (M×N)th ink fountain key opening amount control device 62-(M×N).

The printing press control device 61 controls the entire printing press, including a feeding unit, first to Mth printing units, and a delivery unit which are not shown.

As shown in FIG. 7, the first ink fountain key opening amount control device 62-1 through the (M×N)th ink fountain key opening amount control device 62-(M×N) comprise CPU 64, RAM 65, ROM 66, and a memory 67 for storing a received ink fountain key opening amount Kmn, a memory 68 for storing a target ink fountain key opening amount, a memory 69 for storing the count value of a counter, and a memory 70 for storing a current ink fountain key opening amount, which are connected via a bus-line (BUS) 73 together with an input/output device 71 and an interface 72.

To the input/output device 71, an ink fountain key drive motor 74 is connected via an ink fountain key drive motor driver 75, and an ink fountain key drive motor rotary encoder 76 incorporated in the ink fountain key drive motor 74 is connected via a counter 77. A detection signal from the ink fountain key drive motor rotary encoder 76 is inputted into the ink fountain key drive motor driver 75. The aforementioned ink supply amount control device 30 is connected to the interface 72.

As shown in FIG. 8, the first ink fountain roller rotation amount control device 63-1 through the Mth ink fountain roller rotation amount control device 63-M comprise CPU 78, RAM 79, ROM 80, and a memory 81 for storing a received ink fountain roller rotation amount Rm, and a memory 82 for storing a target ink fountain roller rotation amount, which are connected via a bus-line (BUS) 85 together with an input/output device 83 and an interface 84.

To the input/output device 83, an ink fountain roller drive motor 86 is connected via an ink fountain roller drive motor driver 87, and an ink fountain roller drive motor rotary encoder 88 incorporated in the ink fountain roller drive motor 86 is connected via an F/V converter 89 and an A/D converter 90. A detection signal from the ink fountain roller drive motor rotary encoder 88 is inputted into the ink fountain roller drive motor driver 87. The aforementioned ink supply amount control device 30 is connected to the interface 84.

Because of the above configuration, the ink supply amount control device 30 acts in accordance with action flows shown in FIGS. 9a through 9c, FIGS. 10a and 10b, and FIGS. 11a and 11b.

That is, it is determined in Step P1 whether an ink preset switch in the input/output device 57 is ON or not. If ON, each memory is initialized in Step P2. If not ON, it is determined in Step P3 whether a printing completion signal has been outputted from the printing press control device 61. If YES, outputting of a switching signal to the valves 60-1 through 60-M for air cylinders for switching the roller routes of all printing units is stopped in Step P4, and the program returns to Step P1. If NO, the program immediately returns to Step P1.

Then, in Step P5, the number Mmax of the printing units used in the coming printing, the printing unit No. UNm, the ink color ICm of each printing unit UNm, and the image area rate IRmn in a range corresponding to each ink fountain key are inputted, and stored into the memories 42 to 45. In Step P6, 1 is written into the memory 46 for storing the count value M. In Step P7, 2 is written into the memory 47 for storing the count value N1.

Then, in Step P8, the No. UNm of the Mth printing unit used in the coming printing is read from the memory 43. Then, in Step P9, the image area rate IRm(n1-1) in a range corresponding to the (N1-1)th ink fountain key of the Mth printing unit UNm used in the coming printing is read from the memory 45. Also, in Step P10, the image area rate IRmn1 in a range corresponding to the N1th ink fountain key of the Mth printing unit UNm used in the coming printing is read from the memory 45.

Then, in Step P11, the difference (IRm(n1-1)−IRmn1) between the image area rate IRm(n1-1) in the range corresponding to the (N1-1)th ink fountain key of the Mth printing unit UNm used in the coming printing and the image area rate IRmn1 in the range corresponding to the N1th ink fountain key is computed, and stored into the memory 48. In Step P12, the absolute value |IRm(n1-1)−IRmn1| of the difference between the image area rate IRm(n1-1) in the range corresponding to the (N1-1)th ink fountain key of the Mth printing unit UNm used in the coming printing and the image area rate IRmn1 in the range corresponding to the N1th ink fountain key is computed, and stored into the memory 49.

Then, in Step P13, the ink color ICm of the Mth printing unit UNm used in the coming printing is read from the memory 44. Also, in Step P14, the first reference value R1m for switching corresponding to the ink color ICm of the Mth printing unit UNm used in the coming printing is read from the memory 50. Then, in Step P15, it is determined whether the absolute value |IRm(n1-1)−IRmn1| of the difference between the image area rate IRm(n1-1) in the range corresponding to the (N1-1)th ink fountain key of the Mth printing unit UNm used in the coming printing and the image area rate IRmn1 in the range corresponding to the N1th ink fountain key is equal to or larger than the first reference value R1m for switching corresponding to the ink color of the Mth printing unit UNm used in the coming printing.

If YES in Step P15, the program shifts to Step P22 to be described later. IF NO in Step P15, 1 is added, in step P16, to the count value N1, and the sum is written over the memory 47.

Then, in Step 17, the total number Nmax of the ink fountain keys of each printing unit is read from the memory 51. Then, in Step 18, it is determined whether the count value N1 is greater than the total number Nmax of the ink fountain keys for each color. If YES, 1 is added to the count value M in Step P19, and the sum is written over the memory 46. If NO, the program returns to Step P9.

Then, in Step P20, the number Mmax of the printing units used in the coming printing is read from the memory 42. Then, in Step P21, it is determined whether the count value M is greater than the number Mmax of the printing units used in the coming printing. If YES, the program shifts to Step P36 to be described later. If NO, the program returns to Step P7.

Then, in Step P22, 1 is written into the memory 52 for storing the count value N2. Then, in Step P23, the memory 34 for storing the total value IRs of the image area rates of the printing unit UNm used in the coming printing is initialized. Then, in Step P24, the image area rate IRmn2 in a range corresponding to the N2th ink fountain key of the Mth printing unit UNm used in the coming printing is read from the memory 45.

Then, in Step P25, the value of the memory 34 for storing the total value IRs of the image area rates of the printing unit UNm used in the coming printing is loaded. Then, in Step P26, the image area rate IRmn2 in the range corresponding to the N2th ink fountain key of the Mth printing unit UNm used in the coming printing is added to the value of the memory 34 for storing the total value IRs of the image area rates of the printing unit UNm used in the coming printing, and the sum is written over the memory 34 for storing the total value IRs of the image area rates of the printing unit UNm used in the coming printing.

Then, in Step P27, 1 is added to the count value N2, and the sum is written over the memory 52. Then, in Step P28, the total number Nmax of the ink fountain keys of each printing unit is read from the memory 51. Then, in Step P29, it is determined whether the count value N2 is equal to or larger than the total number Nmax of the ink fountain keys of each printing unit.

Then, in Step P30, the value of the memory 34 for storing the total value IRs of the image area rates of the printing unit UNm used in the coming printing is loaded. Then, in Step 31, the total number Nmax of the ink fountain keys of each printing unit is read from the memory 51. Then, in Step P32, the value of the memory 34 for storing the total value IRs of the image area rates of the printing unit UNm used in the coming printing is divided by the total number Nmax of the ink fountain keys of each printing unit to obtain the average value IRam of the image area rate of the Mth printing unit UNm used in the coming printing, and this average value IRam is stored in the memory 35.

Then, in Step P33, the second reference value R2m for switching corresponding to the ink color ICm of the Mth printing unit UNm used in the coming printing is read from the memory 36. Then, in Step P34, it is determined whether the average value IRam of the image area rate of the Mth printing unit UNm used in the coming printing is equal to or greater than the second reference value R2m for switching corresponding to the ink color of the Mth printing unit UNm used in the coming printing.

If YES in Step P34, the No. UNm of the Mth printing unit used in the coming printing is written into the memory for storing the printing unit No. for switching roller throw-on in Step P35. Then, the program returns to Step P19. If NO in Step P34, the program returns to Step P16.

If YES in Step 21, 1 is written into the memory 46 for storing the count value M in Step P36, and 1 is written into the memory 52 for storing the count value N2 in Step P37. Then, in Step P38, the No. UNm of the Mth printing unit used in the coming printing is read from the memory 43.

Then, in Step P39, the ink color ICm of the Mth printing unit UNm used in the coming printing is read from the memory 44. Then, in Step P40, the image area rate-ink fountain key opening amount conversion table corresponding to the ink color ICm of the Mth printing unit UNm used in the coming printing is read from the memory 38. Then, in Step P41, the image area rate IRmn2 in a range corresponding to the N2th ink fountain key of the Mth printing unit UNm used in the coming printing is read from the memory 45.

Then, in Step P42, the opening amount Kmn2 of the N2th ink fountain key of the Mth printing unit UNm used in the coming printing is found from the image area rate IRmn2 in the range corresponding to the N2th ink fountain key of the Mth printing unit UNm used in the coming printing by use of the image area rate-ink fountain key opening amount conversion table corresponding to the ink color ICm of the printing unit UNm used in the coming printing.

Then, in Step P43, 1 is added to the count value N2, and the sum is written over the memory 52. Then, in Step P44, the total number Nmax of the ink fountain keys of each printing unit is read from the memory 51, and in Step P45, it is determined whether the count value N2 is greater than the total number Nmax of the ink fountain keys for each color.

If YES in Step P45, 1 is added to the count value M, and the sum is written over the memory 46 in Step P46. If NO in Step P45, the program returns to Step P39.

Then, in Step P47, the number Mmax of the printing units used in the coming printing is read from the memory 42. Then, in Step P48, it is determined whether the count value M is greater than the number Mmax of the printing units used in the coming printing. If YES, the contents of the memory 37 for storing the printing unit No. for switching roller throw-on are written, in Step P49, into the memory 40 for storing the printing unit No. for setting switching roller throw-on. If NO, the program returns to Step P37.

Then, the first printing unit No. stored in the memory 40 for storing the printing unit No. for switching roller throw-on setting is loaded in Step P50. Then, in Step P51, a switching signal is outputted to the valves 60-1 through 60-M for the roller route switching air cylinder of the first printing unit No. stored in the memory 40 for storing the printing unit No. for switching roller throw-on setting. Then, in Step P52, the first printing unit No. is deleted from the memory 40 for storing the printing unit No. for switching roller throw-on setting.

Then, in Step P53, the contents of the memory 40 for storing the printing unit No. for switching roller throw-on setting are checked. Then, in Step P54, it is determined whether the stored printing unit No. is absent in the memory 40 for storing the printing unit No. for switching roller throw-on setting. If YES, 1 is written into the memory 46 for storing the count value M in Step P55. If NO, the program returns to Step P50.

Then, in Step P56, 1 is written into the memory 52 for storing the count value N2. Then, in Step P57, the No. UNm of the Mth printing unit used in the coming printing is read from the memory 43. Then, in Step P58, the opening amount Kmn2 of the N2th ink fountain key of the Mth printing unit UNm used in the coming printing is read from the memory 39.

Then, in Step P59, the opening amount Kmn2 of the ink fountain key is transmitted to the N2th ink fountain key opening amount control devices 62-1 through 62-(M×N) of the printing unit of the printing unit No. UNm. Then, if a reception confirmation signal is transmitted from the N2th ink fountain key opening amount control devices 62-1 through 62-(M×N) of the printing unit of the printing unit No. UNm in Step P60, 1 is added to the count value N2, and written over the memory 52, in Step P61.

Then, in Step P62, the total number Nmax of the ink fountain keys of each printing unit is read from the memory 51. Then, in Step P63, it is determined whether the count value N2 is greater than the total number Nmax of the ink fountain keys for each color. If YES, 1 is added to the count value M, and written over the memory 46, in Step P64. If NO, the program returns to Step P58.

Then, in Step P65, the number Mmax of the printing units used in the coming printing is read from the memory 42. Then, in Step P66, it is determined whether the count value M is greater than the number Mmax of the printing units used in the coming printing. If YES, 1 is written into the memory 46 for storing the count value M in Step P67. If NO, the program returns to Step P56.

Then, in Step P68, the ink color ICm of the Mth printing unit UNm used in the coming printing is read from the memory 44. Then, in Step P69, the reference rotation amount Rm of the ink fountain roller corresponding to the ink color ICm of the Mth printing unit UNm used in the coming printing is read from the memory 41. Then, in Step P70, the rotation amount Rm of the ink fountain roller is transmitted to the ink fountain roller rotation amount control devices 63-1 through 63-M of the printing unit of the printing unit No. UNm.

Then, if a reception confirmation signal is transmitted from the ink fountain roller rotation amount control devices 63-1 through 63-M of the printing unit of the printing unit No. UNm in Step P71, 1 is added to the count value M, and the sum is written over the memory 46, in Step P72. Then, in Step P73, the number Mmax of the printing units used in the coming printing is read from the memory 42.

Then, in Step P74, it is determined whether the count value M is greater than the number Mmax of the printing units used in the coming printing. If YES, the program returns to Step P1. If NO, the program returns to Step P68. Thereafter, this procedure is repeated.

The first ink fountain key opening amount control device 62-1 through the (M×N)th ink fountain key opening amount control device 62-(M×N) act in accordance with action flows shown in FIGS. 12a and 12b.

That is, if the opening amount Kmn2 of the ink fountain key is transmitted from the ink supply amount control device 30 in Step P1, the opening amount Kmn of the ink fountain key is received, and stored in the memory 67 for storing the opening amount Kmn of the ink fountain key in Step P2. Then, in Step P3, a reception confirmation signal is transmitted to the ink supply amount control device 30.

Then, in Step P4, the received opening amount Kmn of the ink fountain key is written into the memory 68 for storing the target ink fountain key opening amount. Then, in Step P5, the count value of the counter 77 is loaded. Then, in Step P6, the current opening amount of the ink fountain key is computed from the count value of the counter 77, and stored in the memory 70.

Then, in Step P7, it is determined whether the target ink fountain key opening amount is equal to the current opening amount of the ink fountain key. If YES, the program returns to Step P1. If NO, it is determined in Step P8 whether the target ink fountain key opening amount is larger than the current opening amount of the ink fountain key.

If YES in Step P8, a command for normal rotation is outputted to the ink fountain key drive motor driver 75 in Step P9. If NO, a command for reverse rotation is outputted to the ink fountain key drive motor driver 75 in Step P10.

Then, in Step P11, the count value of the counter 77 is loaded, and stored in the memory 69. Then, in Step P12, the current opening amount of the ink fountain key is computed from the count value of the counter 77, and stored in the memory 70.

Then, in Step P13, it is determined whether the current opening amount of the ink fountain key is equal to the target ink fountain key opening amount. If YES, a command for drive stop is outputted to the ink fountain key drive motor driver 75 in Step P14. Then, the program returns to Step P1. If NO, the program returns to Step P11. Thereafter, this procedure is repeated.

The first ink fountain roller rotation amount control device 63-1 through the Mth ink fountain roller rotation amount control device 63-M act in accordance with an action flow shown in FIG. 13.

That is, if the rotation amount Rm of the ink fountain roller is transmitted from the ink supply amount control device 30 in Step P1, the rotation amount Rm of the ink fountain roller is received, and stored in the memory 81 for storing the received rotation amount Rm of the ink fountain roller in Step P2. Then, in Step P3, a reception confirmation signal is transmitted to the ink supply amount control device 30.

Then, in Step P4, the received rotation amount Rm of the ink fountain key is written into the memory 82 for storing the target ink fountain roller rotation amount, and stored. Then, in Step P5, the target rotation amount of the ink fountain roller is read from the memory 82.

Then, in Step P6, a rotational speed command on the target rotation amount of the ink fountain roller is outputted to the ink fountain roller drive motor driver 87, and the program returns to Step P1. Thereafter, this procedure is repeated.

In the present embodiment described above, as shown in FIG. 4, the image area rate (IRmn) in the range corresponding to each ink fountain key of each printing unit is found, and the difference Dt (IRm(n1-1)−IRmn1) between the image area rates of the adjacent ink fountain keys is found. If this difference (absolute value) is equal to or greater than a certain value (first reference value R1m: first reference value in the claim) in even one of the ranges (see FIG. 5b), the ink distribution roller 4e is automatically thrown on the ink oscillating roller 5b to supply a larger amount of ink to the ink form rollers 6b, 6c on the dampening side, thus establishing an ink transport route where a ghost or the like minimally occurs (i.e., first ink transport route). If there is no such range (see FIG. 5a), on the other hand, the ink distribution roller 4e is automatically thrown off the ink oscillating roller 5b to supply a smaller amount of ink to the ink form rollers 6b, 6c on the dampening side, thus establishing an ink transport route where color irregularities or the like minimally occur (i.e., second ink transport route).

By so doing, the burden on the operator is lightened, and the rate of operation is increased. Furthermore, forgetting to do switching is avoided, thus eliminating a waste of printing material.

If, in the present embodiment described above, the difference Dt (IRm(n1-1)−IRmn1) between the image area rates of the adjacent ink fountain keys is equal to or greater than the certain value (first reference value R1m), as shown in FIG. 4, the average of the image area rates (IRmn) of the entire image is obtained. Only when the obtained average value Dav (IRam) is equal to or greater than a certain value (second reference value R2m: second reference value in the claim), the ink distribution roller 4e is automatically thrown on the ink oscillating roller 5b to supply a larger amount of ink to the ink form rollers 6b, 6c on the dampening side, thus establishing the ink transport route where a ghost or the like minimally occurs (i.e., first ink transport route). When the average value Dav is smaller than the certain value (second reference value R2m), on the other hand, the ink distribution roller 4e is automatically thrown off the ink oscillating roller 5b to supply a smaller amount of ink to the ink form rollers 6b, 6c on the dampening side, thus establishing the ink transport route where the ink is minimally emulsified (i.e., second ink transport route).

By so doing, the operator's judgment becomes unnecessary, the burden on the operator is lightened, the operator's mistake in switching is avoided, and the rate of operation is further increased. Also, a waste of printing material is eliminated further. In the above embodiment, the ink distribution roller 4e is thrown on the ink oscillating roller 5b when the image area rate difference Dt is equal to or greater than the first reference value and the average value Dav is equal to or greater than the second reference value. However, the ink distribution roller 4e may be thrown on the ink oscillating roller 5b when the image area rate difference Dt is greater than the first reference value and the average value Dav is greater than the second reference value.

### Embodiment 2

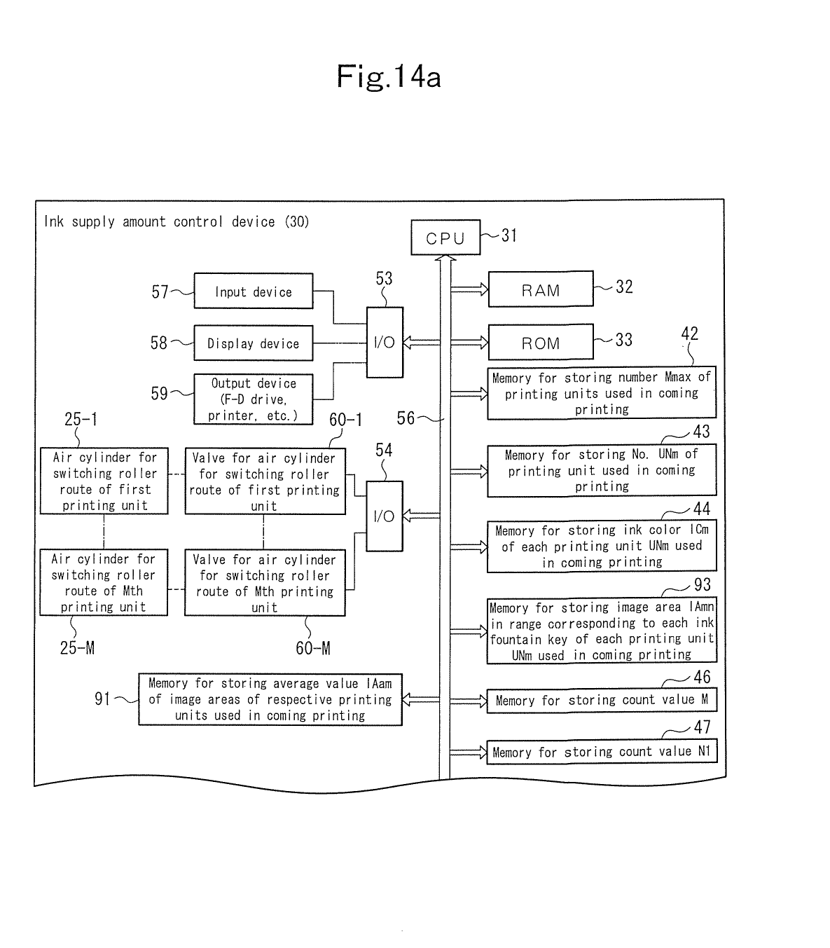

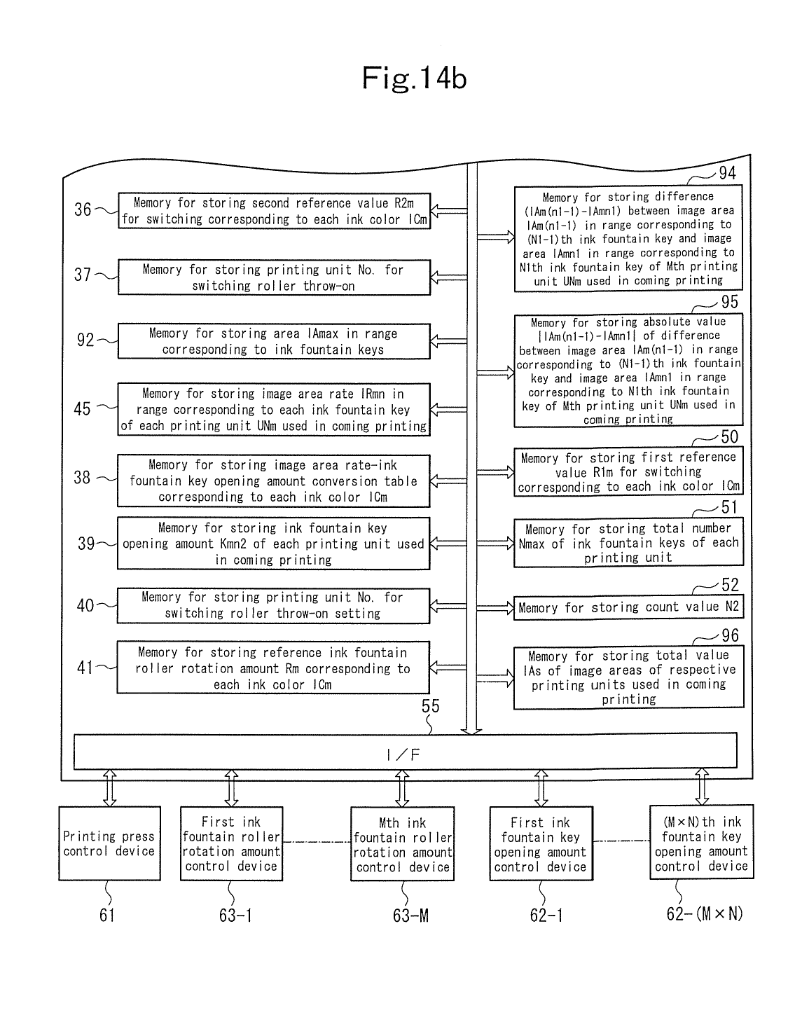

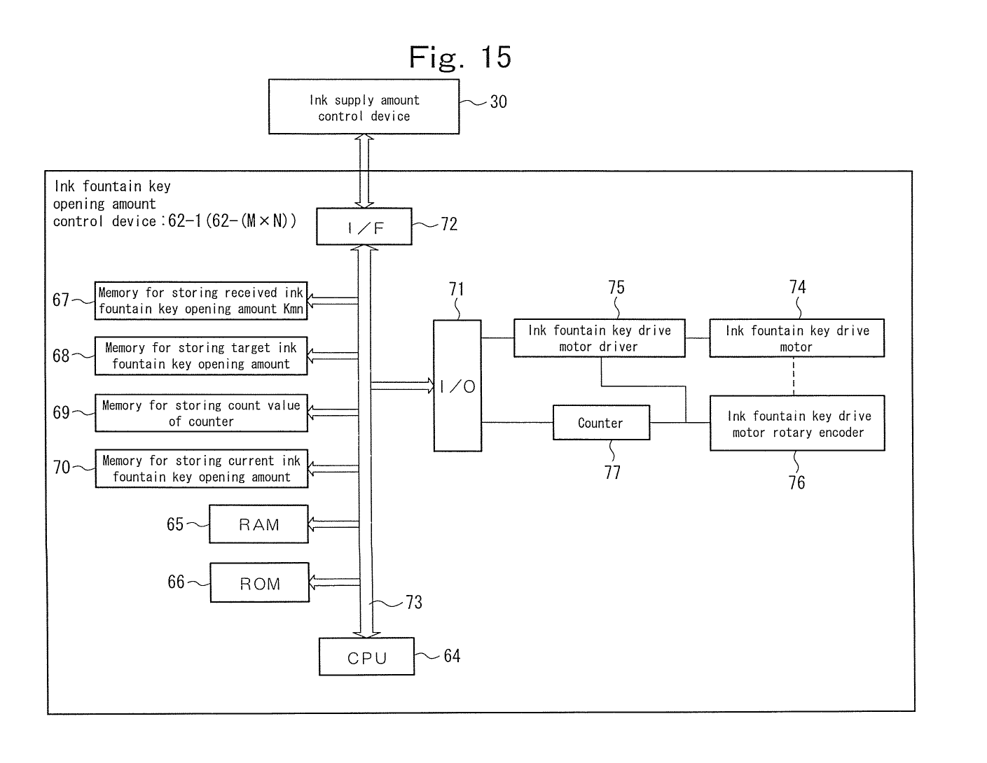

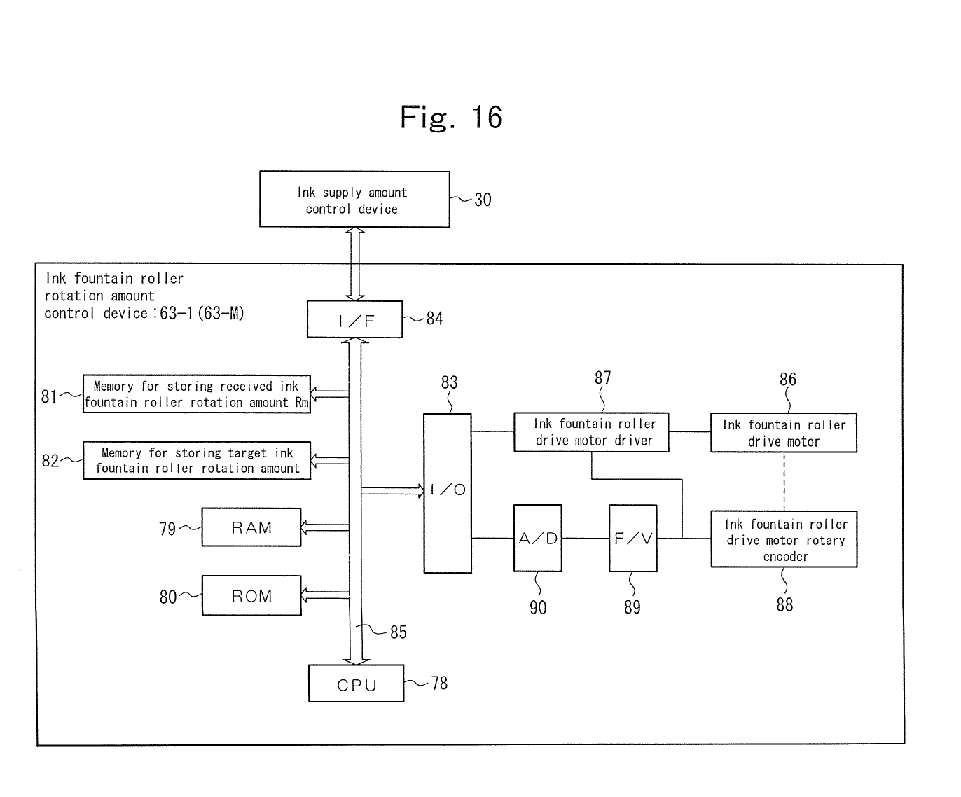

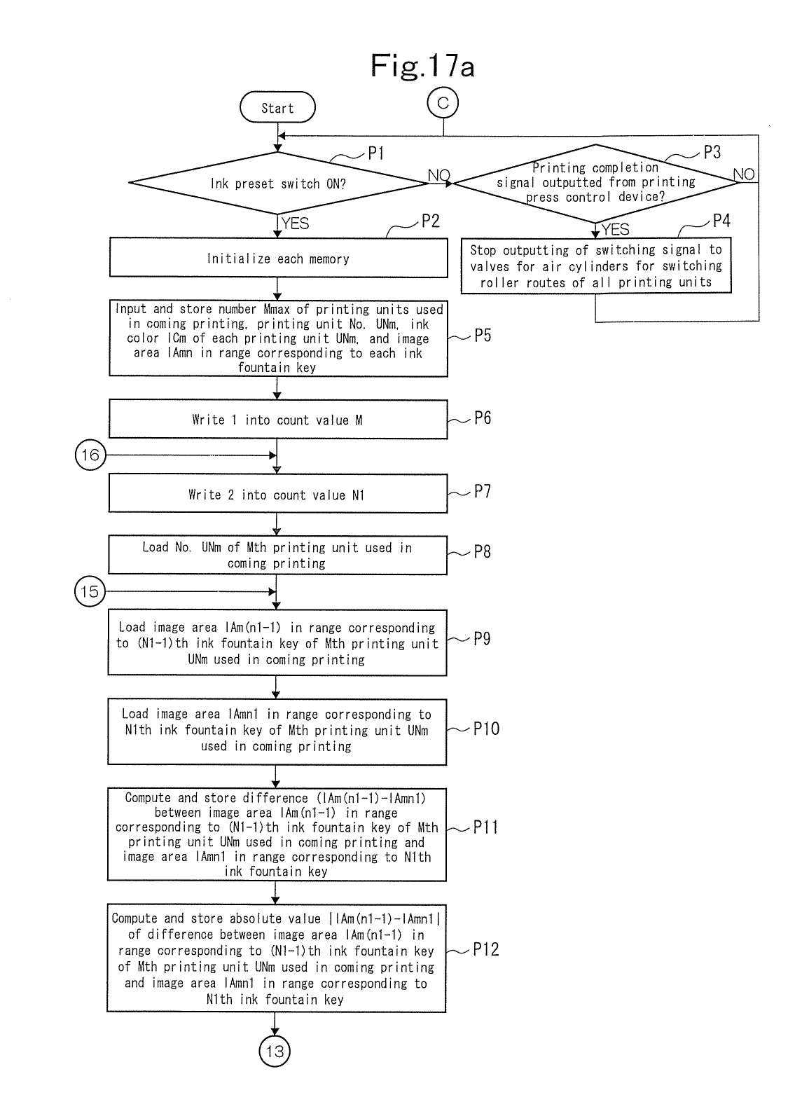

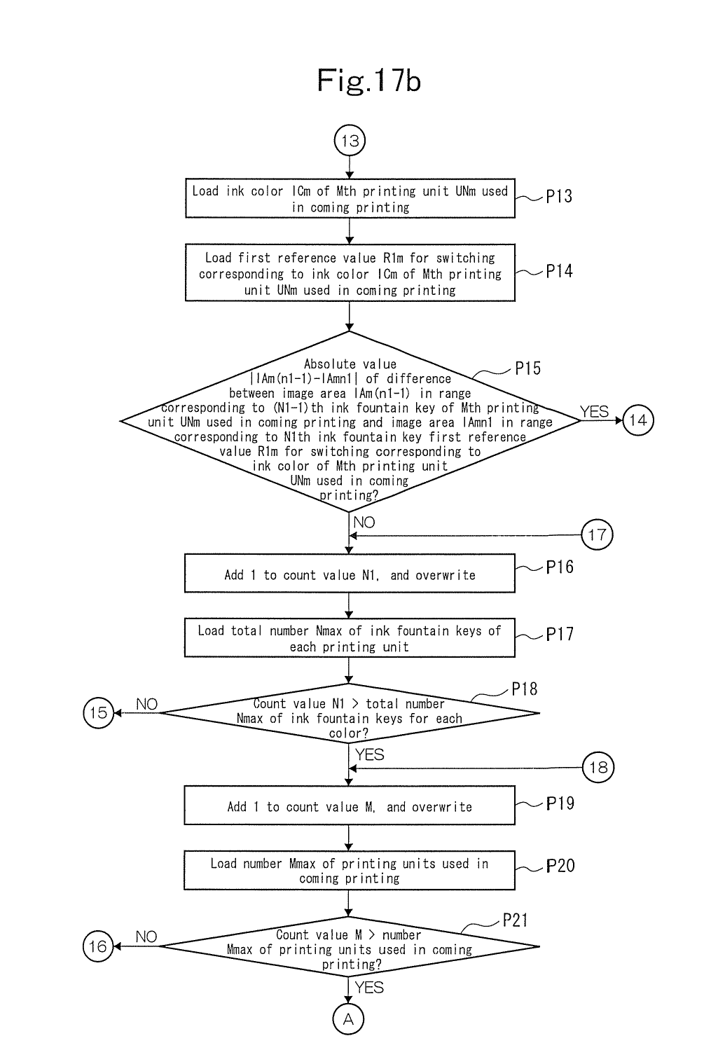

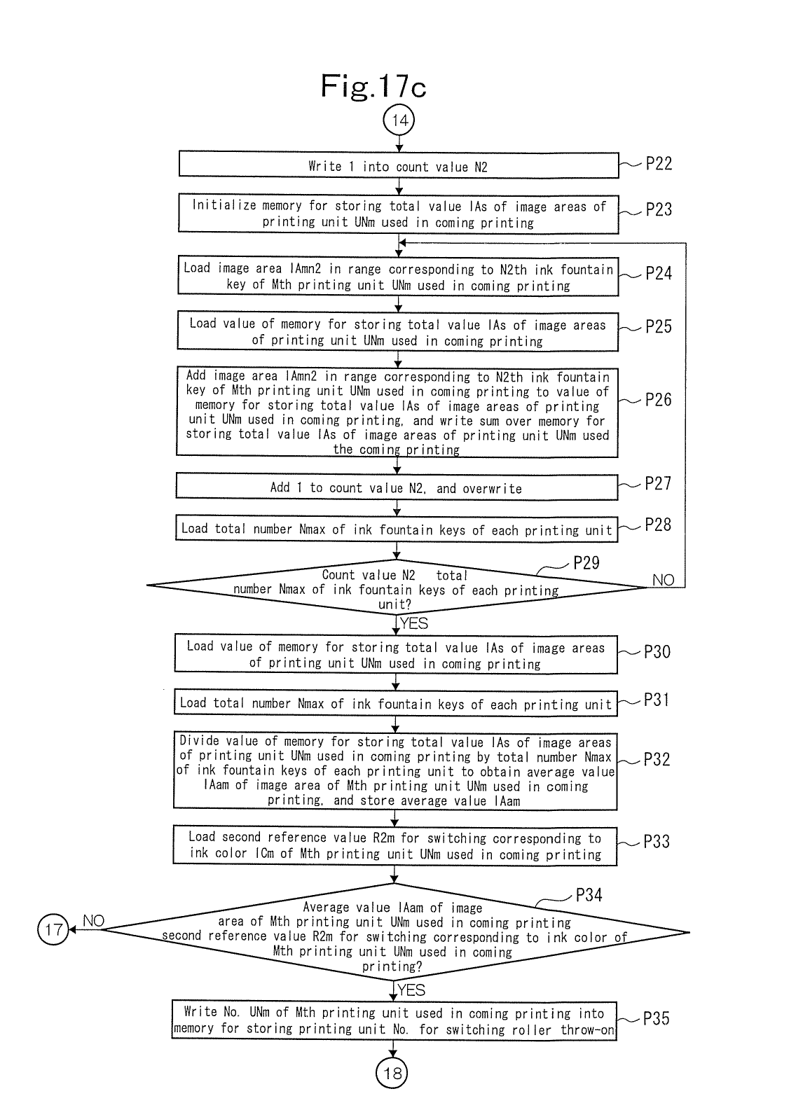

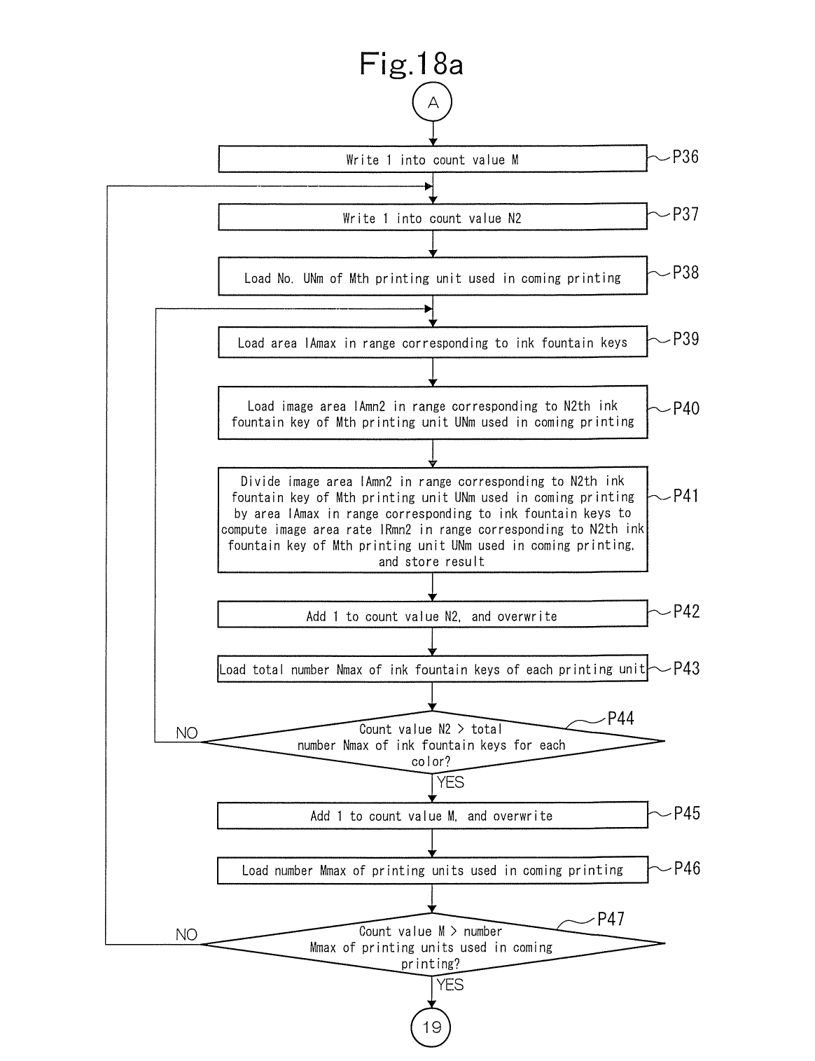

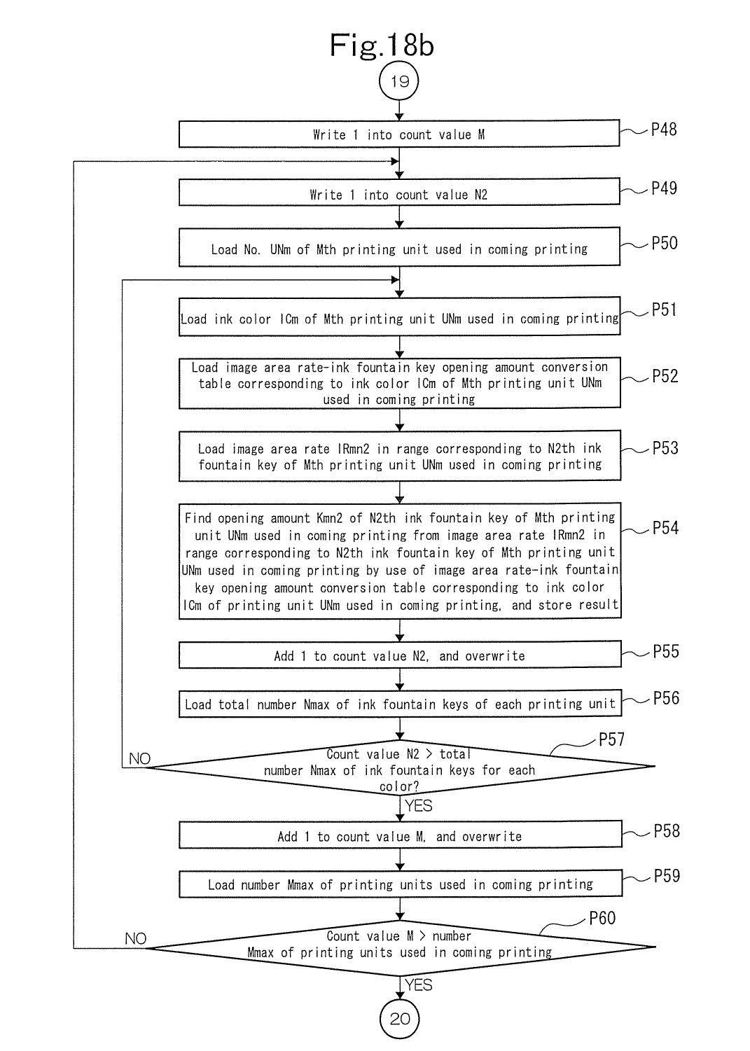

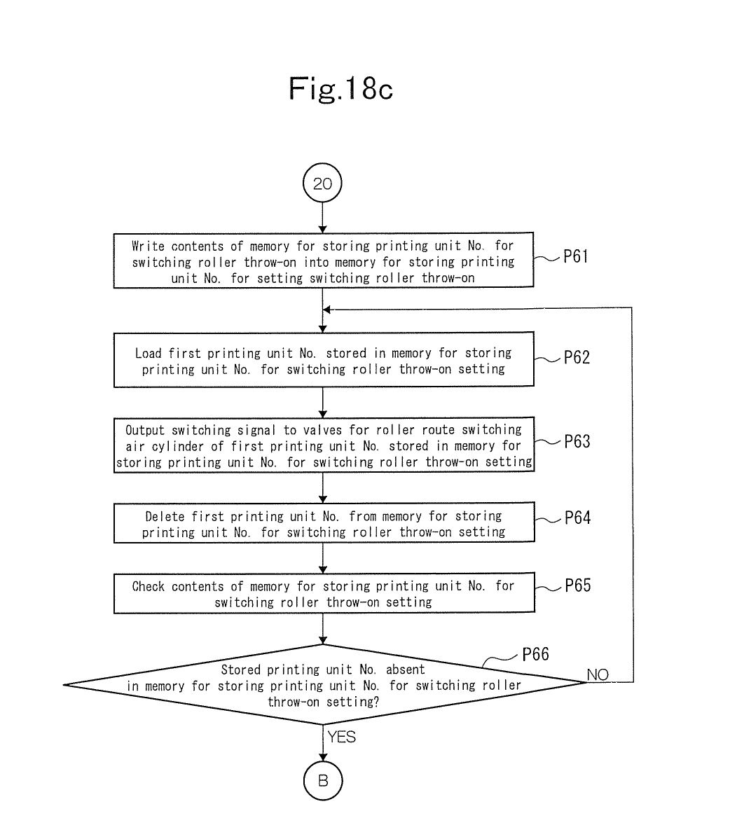

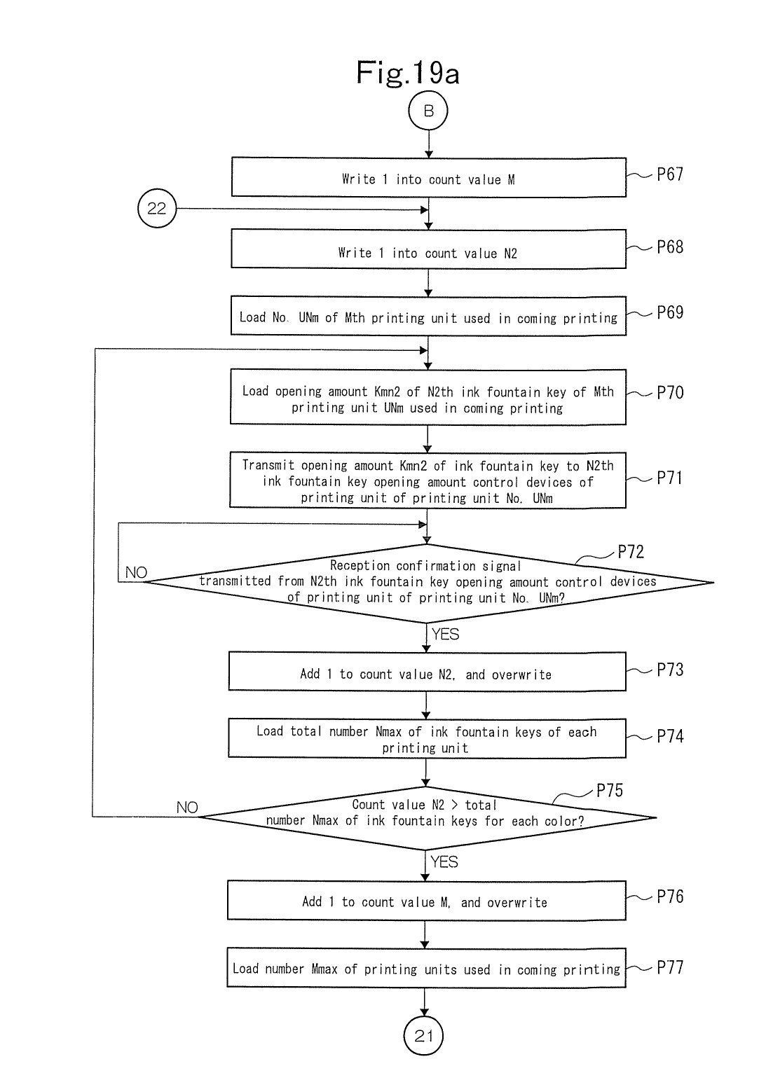

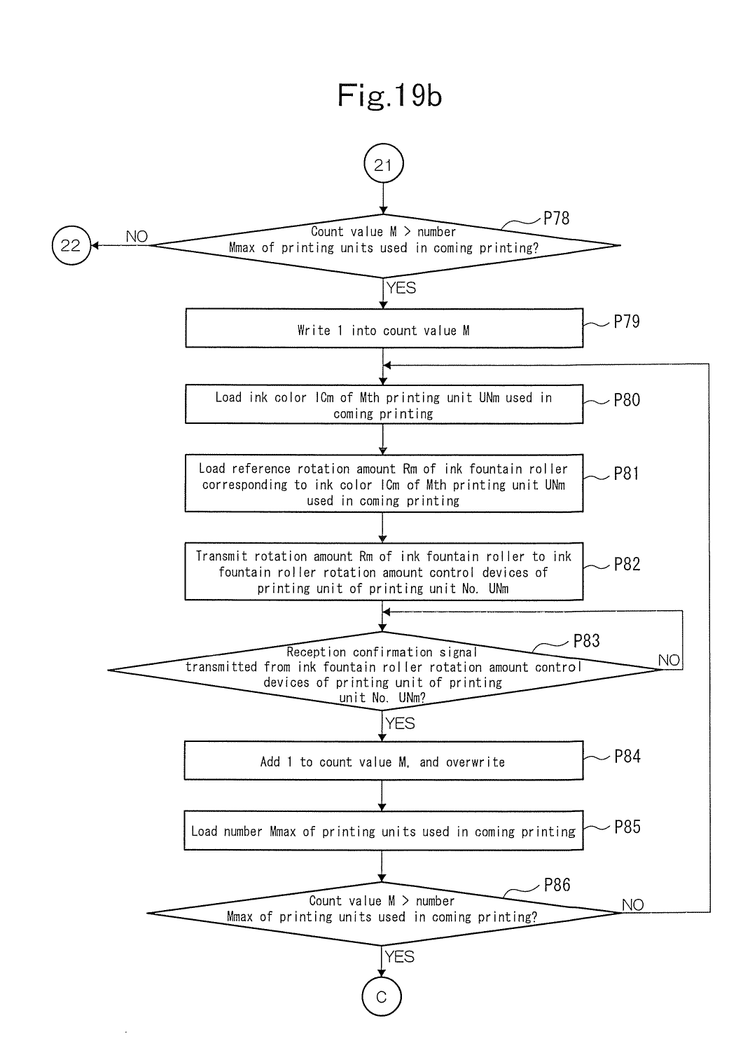

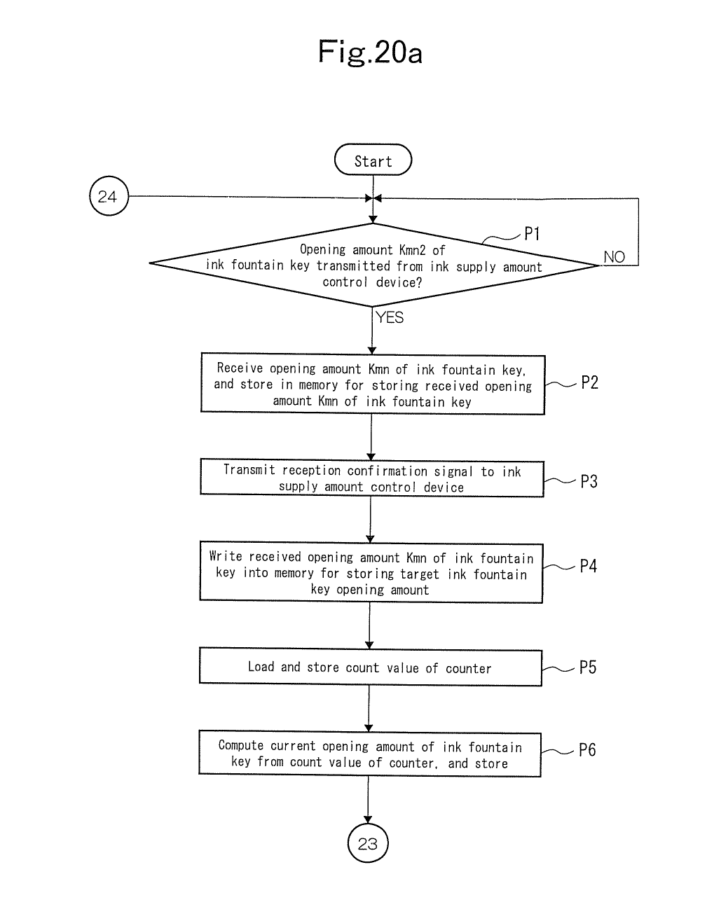

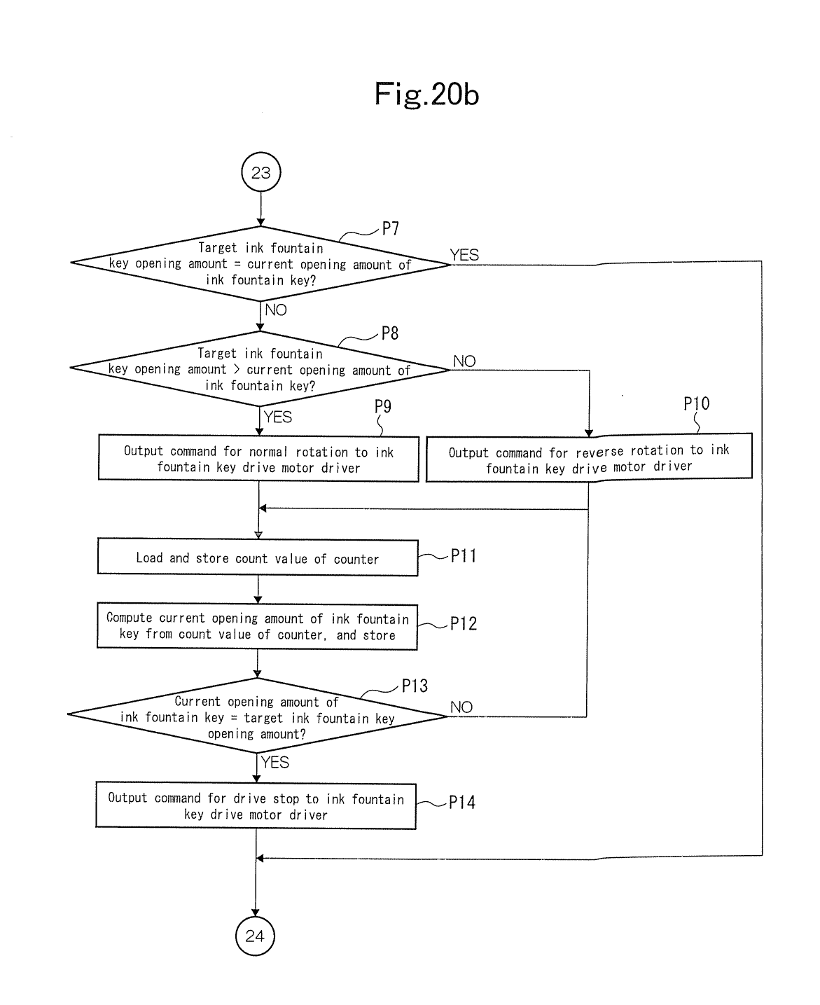

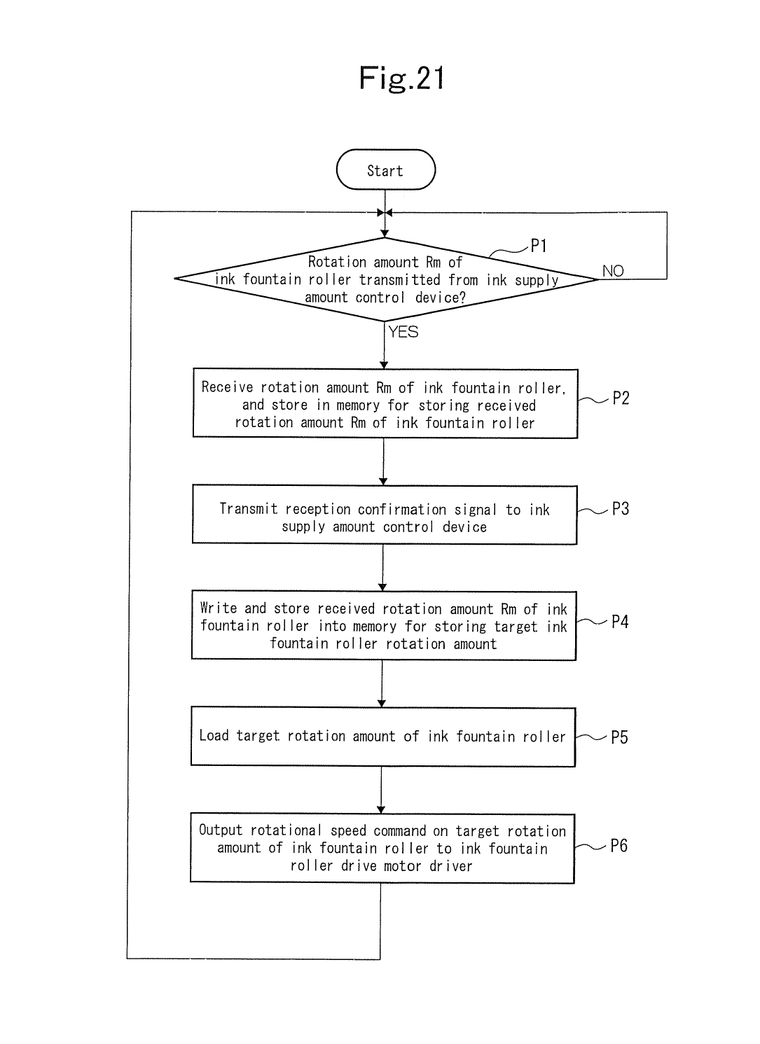

FIG. 14a is a block diagram of an ink supply amount control device showing Embodiment 2 of the present invention. FIG. 14b is a block diagram of the ink supply amount control device. FIG. 15 is a block diagram of an ink fountain key opening amount control device in Embodiment 2. FIG. 16 is a block diagram of an ink fountain roller rotation amount control device in Embodiment 2. FIG. 17a is an action flow chart of the ink supply amount control device. FIG. 17b is an action flow chart of the ink supply amount control device. FIG. 17c is an action flow chart of the ink supply amount control device. FIG. 18a is an action flow chart of the ink supply amount control device. FIG. 18b is an action flow chart of the ink supply amount control device. FIG. 18c is an action flow chart of the ink supply amount control device. FIG. 19a is an action flow chart of the ink supply amount control device. FIG. 19b is an action flow chart of the ink supply amount control device. FIG. 20a is an action flow chart of the ink fountain key opening amount control device. FIG. 20b is an action flow chart of the ink fountain key opening amount control device. FIG. 21 is an action flow chart of the ink fountain roller rotation amount control device.

The configuration of the switching means for the ink transport route in the present embodiment is the same as that in Embodiment 1. Thus, duplicate explanations will be omitted by reference to FIGS. 1 to 3.

The ink supply amount control device 30 of the present embodiment comprises CPU 31, RAM 32, ROM 33, an input/output device 53, an input/output device 54, an interface 55, and the following memories connected by a bus-line (BUS) 56, as shown in FIGS. 14a and 14b: A memory 36 for storing a second reference value R2m for switching corresponding to each ink color ICm; a memory 37 for storing a printing unit No. for switching roller throw-on; a memory 38 for storing an image area rate-ink fountain key opening amount conversion table corresponding to each ink color ICm; a memory 39 for storing the ink fountain key opening amount Kmn2 of each printing unit used in the coming printing; a memory 40 for storing a printing unit No. for switching roller throw-on setting; a memory 41 for storing a reference ink fountain roller rotation amount Rm corresponding to each ink color ICm; a memory 42 for storing the number Mmax of the printing units used in the coming printing; a memory 43 for storing the No. UNm of a printing unit used in the coming printing; a memory 44 for storing the ink color ICm of each printing unit UNm used in the coming printing; a memory 45 for storing an image area rate IRmn in a range corresponding to each ink fountain key of each printing unit UNm used in the coming printing; a memory 46 for storing a count value M; a memory 47 for storing a count value N1; a memory 50 for storing a first reference value R1m for switching corresponding to each ink color ICm; a memory 51 for storing the total number Nmax of the ink fountain keys of each printing unit; a memory 52 for storing a count value N2; a memory 91 for storing the average value IAam of the image areas of the respective printing units used in the coming printing; a memory 92 for storing the area IAmax in a range corresponding to the ink fountain key; a memory 93 for storing an image area IAmn in a range corresponding to each ink fountain key of each printing unit UNm used in the coming printing; a memory 94 for storing the difference (IAm(n1-1)−IAmn1) between an image area IAm(n1-1) in a range corresponding to the (N1-1)th ink fountain key and an image area IAmn1 in a range corresponding to the N1th ink fountain key of the Mth printing unit UNm used in the coming printing; a memory 95 for storing the absolute value |IAm(n1-1)−IAmn1| of the difference between the image area rate IAm(n1-1) in the range corresponding to the (N1-1)th ink fountain key and the image area rate IAmn1 in the range corresponding to the N1th ink fountain key of the Mth printing unit UNm used in the coming printing; and a memory 96 for storing the total value IAs of the image areas of the respective printing units used in the coming printing.

An input device 57, such as a keyboard, various switches, and a button, a display device 58, such as CRT and a lamp, and an output device 59, such as an F-D drive, and a printer, are connected to the input/output device 53. To the input/output device 54, there are connected a valve 60-1 for an air cylinder for switching the roller route of the first printing unit through a valve 60-M for an air cylinder for switching the roller route of the Mth printing unit corresponding to the air cylinder 25-1 for switching the roller route of the first printing unit through the air cylinder 25-M for switching the roller route of the Mth printing unit.

To the interface 55, there are connected a printing press control device 61, a first (first printing unit) ink fountain roller rotation amount control device 63-1 through an Mth (Mth printing unit) ink fountain roller rotation amount control device 63-M, and a first ink fountain key opening amount control device 62-1 through an (M×N)th ink fountain key opening amount control device 62-(M×N).

The printing press control device 61 controls the entire printing press, including a feeding unit, first to Mth printing units, and a delivery unit which are not shown.

As shown in FIG. 15, the first ink fountain key opening amount control device 62-1 through the (M×N)th ink fountain key opening amount control device 62-(M×N) comprise the following: CPU 64, RAM 65, ROM 66, and a memory 67 for storing a received ink fountain key opening amount Kmn, a memory 68 for storing a target ink fountain key opening amount, a memory 69 for storing the count value of a counter, and a memory 70 for storing a current ink fountain key opening amount are connected via a bus-line (BUS) 73 together with an input/output device 71 and an interface 72.

To the input/output device 71, an ink fountain key drive motor 74 is connected via an ink fountain key drive motor driver 75, and an ink fountain key drive motor rotary encoder 76 incorporated in the ink fountain key drive motor 74 is connected via a counter 77. A detection signal from the ink fountain key drive motor rotary encoder 76 is inputted into the ink fountain key drive motor driver 75. The aforementioned ink supply amount control device 30 is connected to the interface 72.

As shown in FIG. 16, the first ink fountain roller rotation amount control device 63-1 through the Mth ink fountain roller rotation amount control device 63-M comprise CPU 78, RAM 79, ROM 80, and a memory 81 for storing a received ink fountain roller rotation amount Rm, and a memory 82 for storing a target ink fountain roller rotation amount connected via a bus-line (BUS) 85 together with an input/output device 83 and an interface 84.

To the input/output device 83, an ink fountain roller drive motor 86 is connected via an ink fountain roller drive motor driver 87, and an ink fountain roller drive motor rotary encoder 88 incorporated in the ink fountain roller drive motor 86 is connected via an F/V converter 89 and an A/D converter 90. A detection signal from the ink fountain roller drive motor rotary encoder 88 is inputted into the ink fountain roller drive motor driver 87. The aforementioned ink supply amount control device 30 is connected to the interface 84.

Because of the above configuration, the ink supply amount control device 30 acts in accordance with action flows shown in FIGS. 17a through 17c, FIGS. 18a to 18c, and FIGS. 19a and 19b.

That is, it is determined in Step P1 whether an ink preset switch in the input/output device 57 is ON or not. If ON, each memory is initialized in Step P2. If not ON, it is determined in Step P3 whether a printing completion signal has been outputted from the printing press control device 61. If YES, outputting of a switching signal to the valves 60-1 through 60-M for air cylinders for switching the roller routes of all printing units is stopped in Step P4, and the program returns to Step P1. If NO, the program immediately returns to Step P1.

Then, in Step P5, the number Mmax of the printing units used in the coming printing, the printing unit No. UNm, the ink color ICm of each printing unit UNm, and the image area IAmn in a range corresponding to each ink fountain key are inputted, and stored into the memories 42 to 44 and 93. Then, in Step P6, 1 is written into the memory 46 for storing the count value M. In Step P7, 2 is written into the memory 47 for storing the count value N1.

Then, in Step P8, the No. UNm of the Mth printing unit used in the coming printing is read from the memory 43. Then, in Step P9, the image area IAm(n1-1) in a range corresponding to the (N1-1)th ink fountain key of the Mth printing unit UNm used in the coming printing is read from the memory 93. Also, in Step P10, the image area IAmn1 in a range corresponding to the N1th ink fountain key of the Mth printing unit UNm used in the coming printing is read from the memory 93.

Then, in Step P11, the difference (IAm(n1-1)−IAmn1) between the image area IAm(n1-1) in the range corresponding to the (N1-1)th ink fountain key of the Mth printing unit UNm used in the coming printing and the image area IAmn1 in the range corresponding to the N1th ink fountain key is computed, and stored into the memory 94. In Step P12, the absolute value |IAm(n1-1)−IAmn1| of the difference between the image area IAm(n1-1) in the range corresponding to the (N1-1)th ink fountain key of the Mth printing unit UNm used in the coming printing and the image area IAmn1 in the range corresponding to the N1th ink fountain key is computed, and stored into the memory 95.

Then, in Step P13, the ink color ICm of the Mth printing unit UNm used in the coming printing is read from the memory 44. Also, in Step P14, the first reference value R1m for switching corresponding to the ink color ICm of the Mth printing unit UNm used in the coming printing is read from the memory 50. Then, in Step P15, it is determined whether the absolute value |IAm(n1-1)−IAmn1| of the difference between the image area IAm(n1-1) in the range corresponding to the (N1-1)th ink fountain key of the Mth printing unit UNm used in the coming printing and the image area IAmn1 in the range corresponding to the N1th ink fountain key is equal to or larger than the first reference value R1m for switching corresponding to the ink color of the Mth printing unit UNm used in the coming printing.

If YES in Step P15, the program shifts to Step P22 to be described later. IF NO in Step P15, 1 is added to the count value N1, and the sum is written over the memory 47, in Step P16.

Then, in Step P17, the total number Nmax of the ink fountain keys of each printing unit is read from the memory 51. Then, in Step P18, it is determined whether the count value N1 is greater than the total number Nmax of the ink fountain keys for each color. If YES, 1 is added to the count value M in Step P19, and the sum is written over the memory 46. If NO, the program returns to Step P9.

Then, in Step P20, the number Mmax of the printing units used in the coming printing is read from the memory 42. Then, in Step P21, it is determined whether the count value M is greater than the number Mmax of the printing units used in the coming printing. If YES, the program shifts to Step P36 to be described later. If NO, the program returns to Step P7.

Then, in Step P22, 1 is written into the memory 52 for storing the count value N2. Then, in Step P23, the memory 96 for storing the total value IAs of the image areas of the printing unit UNm used in the coming printing is initialized. Then, in Step P24, the image area IAmn2 in a range corresponding to the N2th ink fountain key of the Mth printing unit UNm used in the coming printing is read from the memory 93.

Then, in Step P25, the value of the memory 96 for storing the total value IAs of the image areas of the printing unit UNm used in the coming printing is loaded. Then, in Step P26, the image area IAmn2 in the range corresponding to the N2th ink fountain key of the Mth printing unit UNm used in the coming printing is added to the value of the memory 96 for storing the total value IAs of the image areas of the printing unit UNm used in the coming printing, and the sum is written over the memory 96 for storing the total value IAs of the image areas of the printing unit UNm used in the coming printing.

Then, in Step P27, 1 is added into the memory 52 for storing the count value N2, and the sum is written over the memory 52. Then, in Step P28, the total number Nmax of the ink fountain keys of each printing unit is read from the memory 51. Then, in Step P29, it is determined whether the count value N2 is equal to or larger than the total number Nmax of the ink fountain keys of each printing unit.

Then, in Step P30, the value of the memory 96 for storing the total value IAs of the image areas of the printing unit UNm used in the coming printing is loaded. Then, in Step P31, the total number Nmax of the ink fountain keys of each printing unit is read from the memory 51. Then, in Step P32, the value of the memory for storing the total value IAs of the image areas of the printing unit UNm used in the coming printing is divided by the total number Nmax of the ink fountain keys of each printing unit to obtain the average value IAam of the image areas of the Mth printing unit UNm used in the coming printing, and this average value IAam is stored in the memory 91.

Then, in Step P33, the second reference value R2m for switching corresponding to the ink color ICm of the Mth printing unit UNm used in the coming printing is read from the memory 36. Then, in Step P34, it is determined whether the average value IAam of the image areas of the Mth printing unit UNm used in the coming printing is equal to or greater than the second reference value R2m for switching corresponding to the ink color of the Mth printing unit UNm used in the coming printing.

If YES in Step P34, the No. UNm of the Mth printing unit used in the coming printing is written into the memory 37 for storing the printing unit No. for switching roller throw-on in Step P35. Then, the program returns to Step P19. If NO in Step P34, the program returns to Step P16.

If YES in Step P21, 1 is written into the memory 46 for storing the count value M in Step P36, and 1 is written into the memory 52 for storing the count value N2 in Step P37. Then, in Step P38, the No. UNm of the Mth printing unit used in the coming printing is read from the memory 43.

Then, in Step P39, the area IAmax in a range corresponding to the ink fountain keys is read from the memory 92. In Step P40, the image area IAmn2 in a range corresponding to the N2th ink fountain key of the Mth printing unit UNm used in the coming printing is read from the memory 93.

Then, in Step P41, the image area IAmn2 in a range corresponding to the N2th ink fountain key of the Mth printing unit UNm used in the coming printing is divided by the area IAmax in the range corresponding to the ink fountain keys to compute the image area rate IRmn2 in the range corresponding to the N2th ink fountain key of the Mth printing unit UNm used in the coming printing, and the result is stored in the memory 45. Then, in Step P42, 1 is added to the count value N2, and written over the memory 52.

Then, in Step P43, the total number Nmax of the ink fountain keys of each printing unit is read from the memory 51. Then, in Step P44, it is determined whether the count value N2 is greater than the total number Nmax of the ink fountain keys for each color. If YES, 1 is added to the count value M, and written over the memory 46, in Step P45 If NO, the program returns to Step P39.

Then, in Step P46, the number Mmax of the printing units used in the coming printing is read from the memory 42. Then, in Step P47, it is determined whether the count value M is greater than the number Mmax of the printing units used in the coming printing. If YES, 1 is written into the memory 46 for storing the count value M, in Step P48. If NO, the program returns to Step P37.

Then, in Step P49, 1 is written into the memory 52 for storing the count value N2. Then, in Step P50, the No. UNm of the Mth printing unit used in the coming printing is read from the memory 43.

Then, in Step P51, the ink color ICm of the Mth printing unit UNm used in the coming printing is read from the memory 44. Then, in Step P52, the image area rate-ink fountain key opening amount conversion table corresponding to the ink color ICm of the Mth printing unit UNm used in the coming printing is read from the memory 38. Then, in Step P53, the image area rate IRmn2 in the range corresponding to the N2th ink fountain key of the Mth printing unit UNm used in the coming printing is read from the memory 45.

Then, in Step P54, the opening amount Kmn2 of the N2th ink fountain key of the Mth printing unit UNm used in the coming printing is found from the image area rate IRmn2 in the range corresponding to the N2th ink fountain key of the Mth printing unit UNm used in the coming printing by use of the image area rate-ink fountain key opening amount conversion table corresponding to the ink color ICm of the printing unit UNm used in the coming printing, and the result is stored in the memory 39.

Then, in Step P55, 1 is added to the count value N2, and the sum is written over the memory 52. Then, in Step P56, the total number Nmax of the ink fountain keys of each printing unit is read from the memory 51, and in Step P57, it is determined whether the count value N2 is greater than the total number Nmax of the ink fountain keys for each color.

If YES in Step P57, 1 is added to the count value M, and the sum is written over the memory 46 in Step P58. If NO in Step P57, the program returns to Step P51.

Then, in Step P59, the number Mmax of the printing units used in the coming printing is read from the memory 42. Then, in Step P60, it is determined whether the count value M is greater than the number Mmax of the printing units used in the coming printing. If YES, the contents of the memory 37 for storing the No. of the printing unit for switching roller throw-on are written, in Step P61, into the memory 40 for storing the No. of the printing unit for setting switching roller throw-on. If NO, the program returns to Step P49.

Then, the first printing unit No. stored in the memory 40 for storing the printing unit No. for switching roller throw-on setting is loaded in Step P62. Then, in Step P63, a switching signal is outputted to the valves 60-1 through 60-M for the roller route switching air cylinder of the first printing unit No. stored in the memory 40 for storing the printing unit No. for switching roller throw-on setting. Then, in Step P64, the first printing unit No. is deleted from the memory 40 for storing the printing unit No. for switching roller throw-on setting.

Then, in Step P65, the contents of the memory 40 for storing the printing unit No. for switching roller throw-on setting are checked. Then, in Step P66, it is determined whether the stored printing unit No. is absent in the memory 40 for storing the printing unit No. for switching roller throw-on setting. If YES, 1 is written into the memory 46 for storing the count value M in Step P67. If NO, the program returns to Step P62.

Then, in Step P68, 1 is written into the memory 52 for storing the count value N2. Then, in Step P69, the No. UNm of the Mth printing unit used in the coming printing is read from the memory 43. Then, in Step P70, the opening amount Kmn2 of the N2th ink fountain key of the Mth printing unit UNm used in the coming printing is read from the memory 39.

Then, in Step P71, the opening amount Kmn2 of the ink fountain key is transmitted to the N2th ink fountain key opening amount control devices 62-1 through 62-(M×N) of the printing unit of the printing unit No. UNm. Then, if a reception confirmation signal is transmitted from the N2th ink fountain key opening amount control devices 62-1 through 62-(M×N) of the printing unit of the printing unit No. UNm in Step P72, 1 is added to the count value N2, and written over the memory 52, in Step P73.

Then, in Step P74, the total number Nmax of the ink fountain keys of each printing unit is read from the memory 51. Then, in Step P75, it is determined whether the count value N2 is greater than the total number Nmax of the ink fountain keys for each color. If YES, 1 is added to the count value M, and written over the memory 46, in Step P76. If NO, the program returns to Step P70.

Then, in Step P77, the number Nmax of the printing units used in the coming printing is read from the memory 42. Then, in Step P78, it is determined whether the count value M is greater than the number Mmax of the printing units used in the coming printing. If YES, 1 is written into the memory 46 for storing the count value M in Step P79. If NO, the program returns to Step P68.

Then, in Step P80, the ink color ICm of the Mth printing unit UNm used in the coming printing is read from the memory 44. Then, in Step P81, the reference rotation amount Rm of the ink fountain roller corresponding to the ink color ICm of the Mth printing unit UNm used in the coming printing is read from the memory 41. Then, in Step P82, the rotation amount Rm of the ink fountain roller is transmitted to the ink fountain roller rotation amount control devices 63-1 through 63-M of the printing unit of the printing unit No. UNm.

Then, if a reception confirmation signal is transmitted from the ink fountain roller rotation amount control devices 63-1 through 63-M of the printing unit of the printing unit No. UNm in Step P83, 1 is added to the count value M, and the sum is written over the memory 46, in Step P84. Then, in Step P85, the number Mmax of the printing units used in the coming printing is read from the memory 42.

Then, in Step P86, it is determined whether the count value M is greater than the number Mmax of the printing units used in the coming printing. If YES, the program returns to Step P1. If NO, the program returns to Step P80. Thereafter, this procedure is repeated.

The first ink fountain key opening amount control device 62-1 through the (M×N)th ink fountain key opening amount control device 62-(M×N) also act in accordance with action flows shown in FIGS. 20a and 20b.

That is, if the opening amount Kmn2 of the ink fountain key is transmitted from the ink supply amount control device 30 in Step P1, the opening amount Kmn of the ink fountain key is received, and stored in the memory 67 for storing the opening amount Kmn of the ink fountain key in Step P2. Then, in Step P3, a reception confirmation signal is transmitted to the ink supply amount control device 30.

Then, in Step 4, the received opening amount Kmn of the ink fountain key is written into the memory 68 for storing the target ink fountain key opening amount. Then, in Step P5, the count value of the counter 77 is loaded, and stored into the memory 69. Then, in Step P6, the current opening amount of the ink fountain key is computed from the count value of the counter 77, and stored in the memory 70.

Then, in Step P7, it is determined whether the target ink fountain key opening amount is equal to the current opening amount of the ink fountain key. If YES, the program returns to Step P1. If NO, it is determined in Step P8 whether the target ink fountain key opening amount is larger than the current opening amount of the ink fountain key.

If YES in Step P8, a command for normal rotation is outputted to the ink fountain key drive motor driver 75 in Step P9. If NO, a command for reverse rotation is outputted to the ink fountain key drive motor driver 75 in Step P10.

Then, in Step P11, the count value of the counter 77 is loaded, and stored in the memory 69. Then, in Step P12, the current opening amount of the ink fountain key is computed from the count value of the counter 77, and stored in the memory 70.

Then, in Step P13, it is determined whether the current opening amount of the ink fountain key is equal to the target ink fountain key opening amount. If YES, a command for drive stop is outputted to the ink fountain key drive motor driver 75 in Step P14. Then, the program returns to Step P1. If NO, the program returns to Step P11. Thereafter, this procedure is repeated.

The first ink fountain roller rotation amount control device 63-1 through the Mth ink fountain roller rotation amount control device 63-M act in accordance with an action flow shown in FIG. 21.

That is, if the rotation amount Rm of the ink fountain roller is transmitted from the ink supply amount control device 30 in Step P1, the rotation amount Rm of the ink fountain roller is received, and stored in the memory 81 for storing the received rotation amount Rm of the ink fountain roller in Step P2. Then, in Step P3, a reception confirmation signal is transmitted to the ink supply amount control device 30.

Then, in Step P4, the received rotation amount Rm of the ink fountain key is written into the memory 82 for storing the target ink fountain roller rotation amount, and stored. Then, in Step P5, the target rotation amount of the ink fountain roller is read from the memory 82.

Then, in Step P6, a rotational speed command on the target rotation amount of the ink fountain roller is outputted to the ink fountain roller drive motor driver 87, and the program returns to Step P1. Thereafter, this procedure is repeated.

In the present embodiment, as described above, the image area (IAmn) in the range corresponding to each ink fountain key of each printing unit is found, and the difference (IAm(n1-1)−IAmn1) between the image areas of the adjacent ink fountain keys is found. If this difference (absolute value) is equal to or greater than a certain value (first reference value R1m: first reference value in the claim) in even one of the ranges, the ink distribution roller 4e is automatically thrown on the ink oscillating roller 5b to supply a larger amount of ink to the ink form rollers 6b, 6c on the dampening side, thus establishing an ink transport route where a ghost or the like minimally occurs (i.e., first ink transport route). If there is no such range, on the other hand, the ink distribution roller 4e is automatically thrown off the ink oscillating roller 5b to supply a smaller amount of ink to the ink form rollers 6b, 6c on the dampening side, thus establishing an ink transport route where color irregularities or the like minimally occur (i.e., second ink transport route).

By so doing, the burden on the operator is lightened, and the rate of operation is increased. Furthermore, forgetting to do switching is avoided, thus eliminating a waste of printing material.

If, in the present embodiment, the difference (IAm(n1-1)−IAmn1) between the image area rates of the adjacent ink fountain keys is equal to or greater than the certain value (first reference value R1m), the average of the image areas (IAmn) of the entire image is further obtained. Only when the obtained average value (IAam) is equal to or greater than a certain value (second reference value R2m: second reference value in the claim), the ink distribution roller 4e is automatically thrown on the ink oscillating roller 5b to supply a larger amount of ink to the ink form rollers 6b, 6c on the dampening side, thus establishing the ink transport route where a ghost or the like minimally occurs (i.e., first ink transport route). When the average value is smaller than the certain value (second reference value R2m), on the other hand, the ink distribution roller 4e is automatically thrown off the ink oscillating roller 5b to supply a smaller amount of ink to the ink form rollers 6b, 6c oil the dampening side, thus establishing the ink transport route where the ink is minimally emulsified (i.e., second ink transport route). Furthermore, the average value (IAam) of the image areas (IAmn) is the value obtained by dividing the total value (IAs) of the image areas by the total number Nmax of the ink fountain keys of the respective printing units. Since the total number Nmax of the ink fountain keys of the respective printing units is a constant value, it goes without saying that the total value (IAs) may be obtained instead of the average value (IAam) of the image areas (IAmn), and this total value (IAs) may be compared with the certain value (second reference value R2m).

By so doing, the operator's judgment becomes unnecessary, the burden on the operator is lightened, the operator's mistake in switching is avoided, and the rate of operation is further increased. Also, a waste of printing material is eliminated further. In the above embodiment, moreover, the ink distribution roller 4e is thrown oil the ink oscillating roller 5b when the image area rate difference Dt is equal to or greater than the first reference value and the average value Dav is equal to or greater than the second reference value. However, the ink distribution roller 4e may be thrown on the ink oscillating roller 5b when the image area rate difference Dt is greater than the first reference value and the average value Dav is greater than the second reference value.

### Embodiment 3

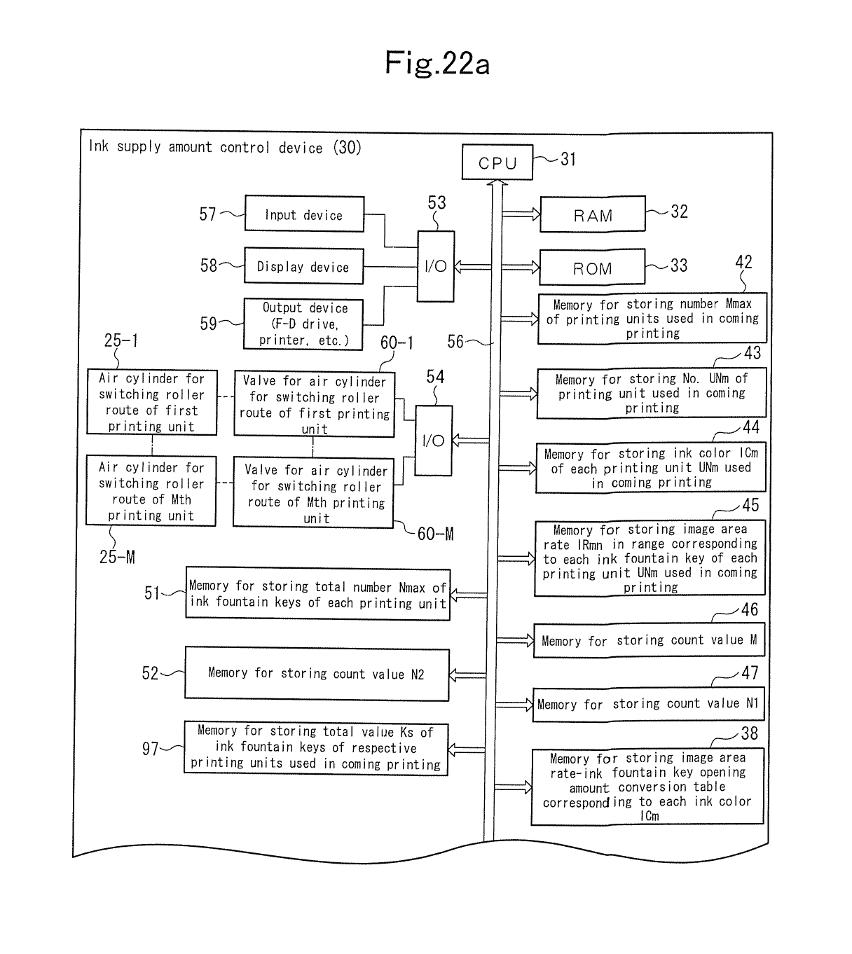

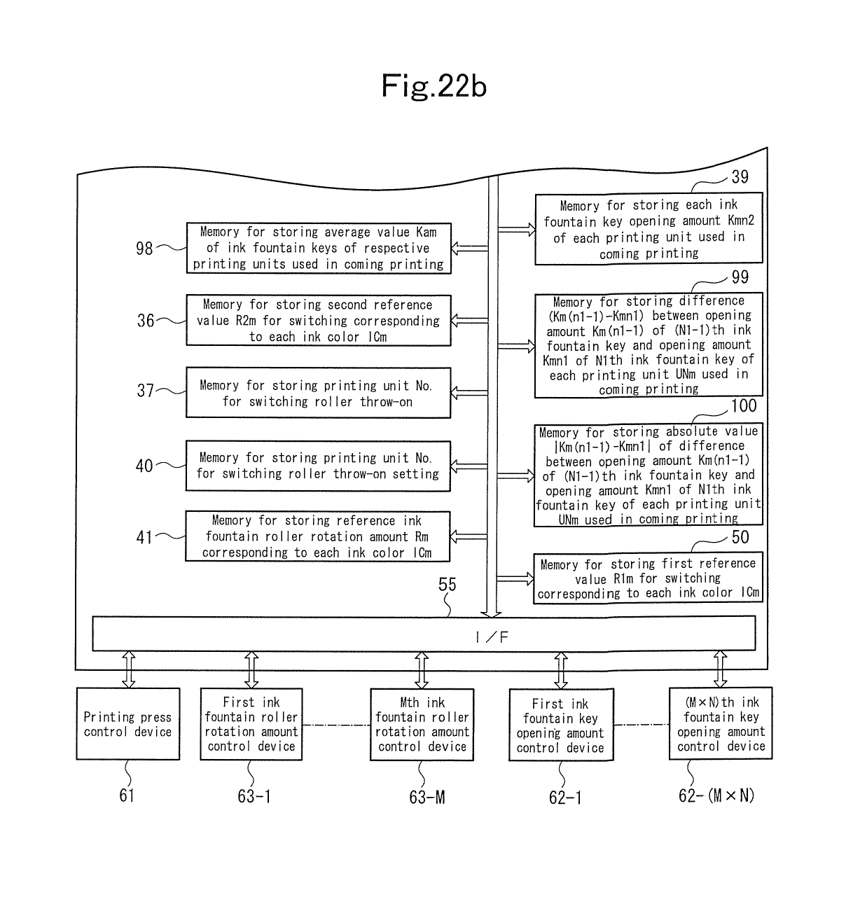

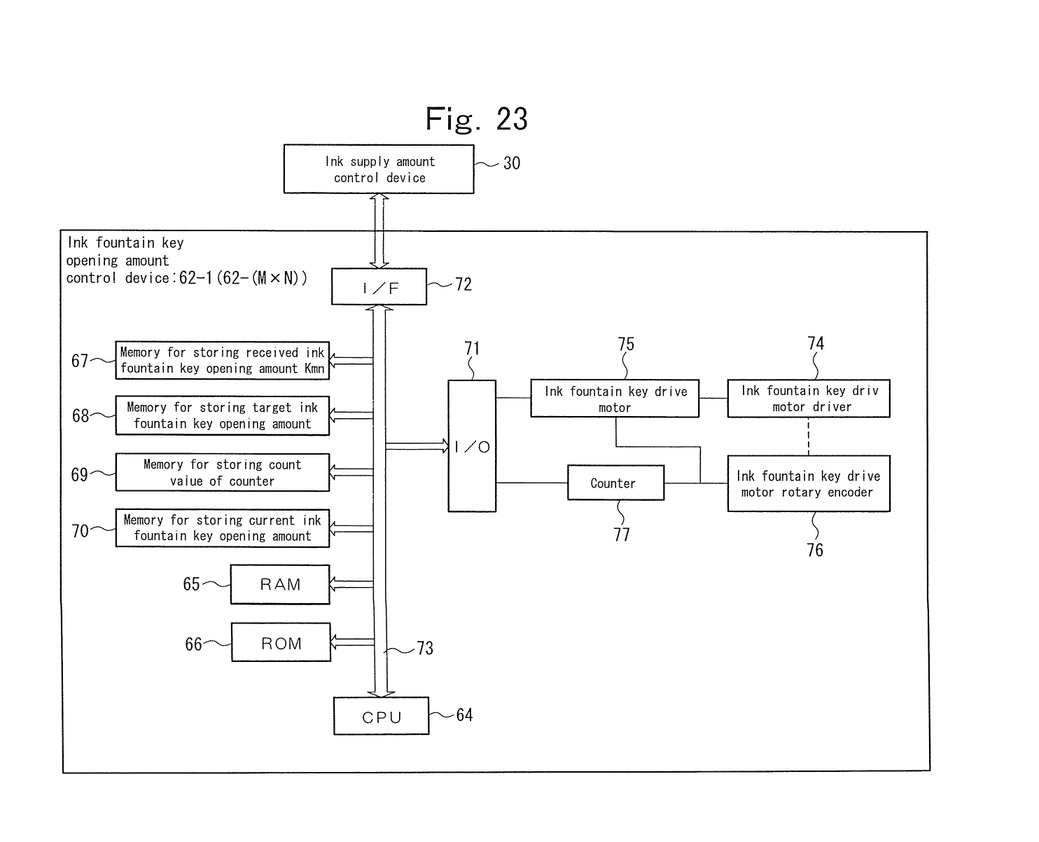

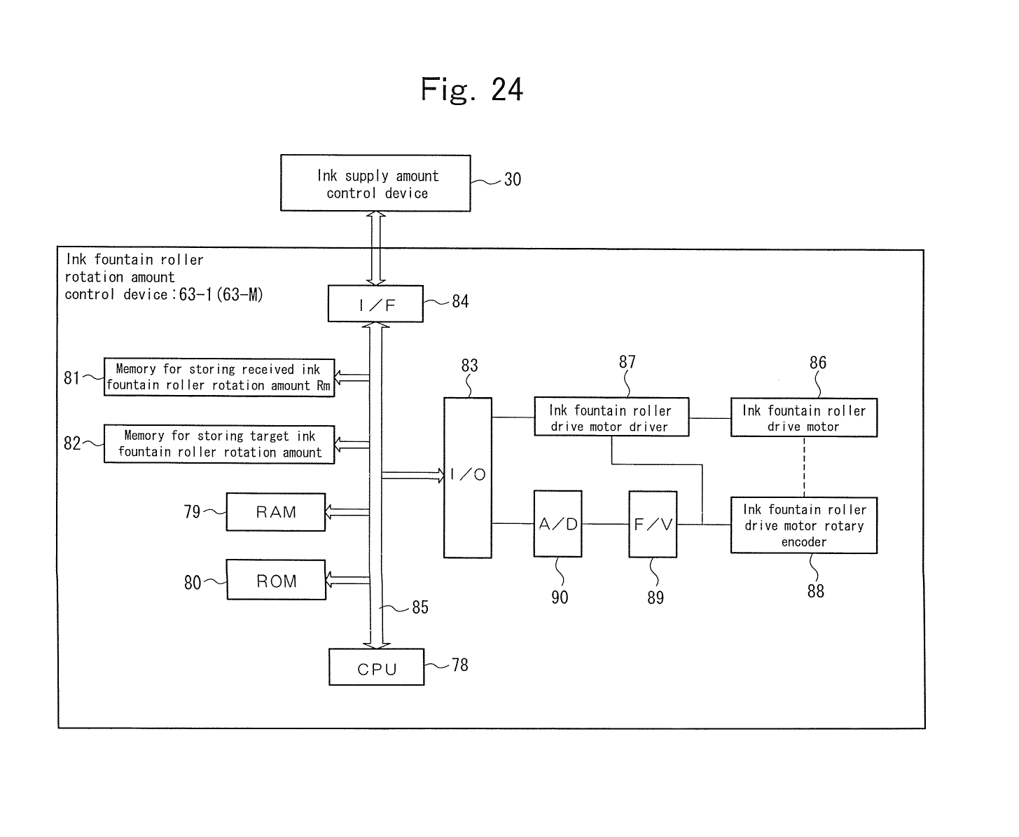

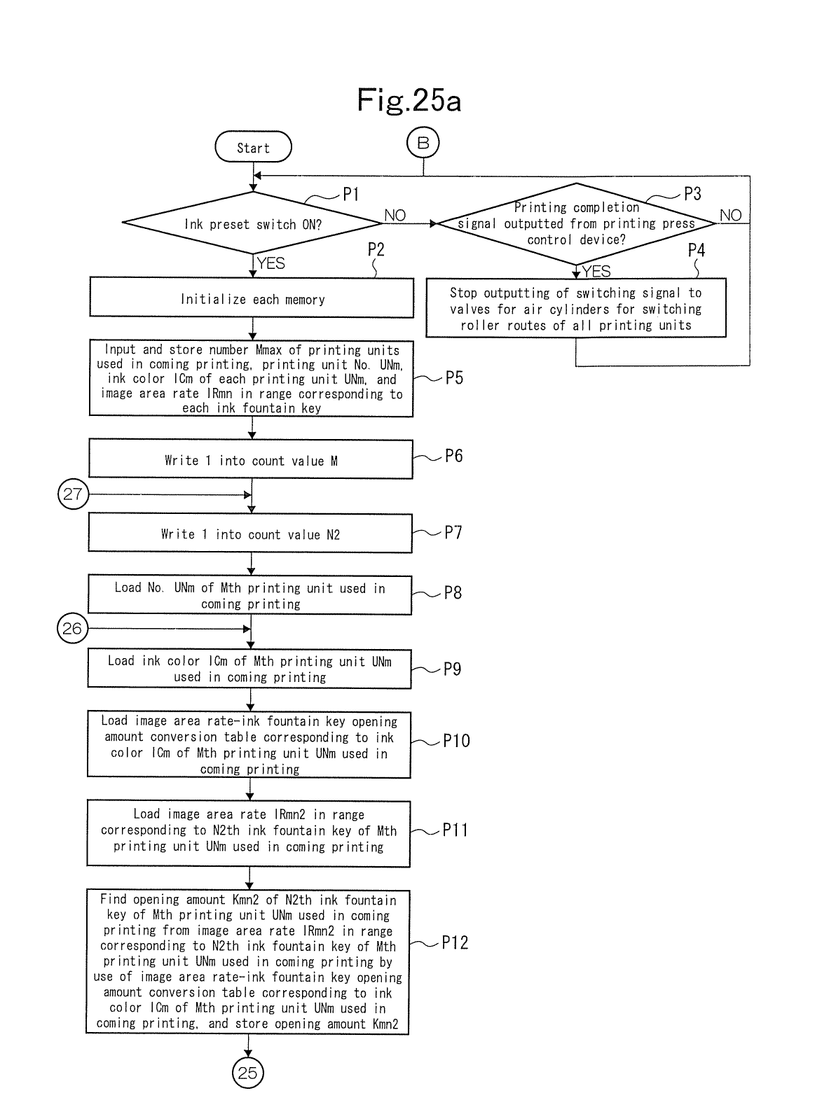

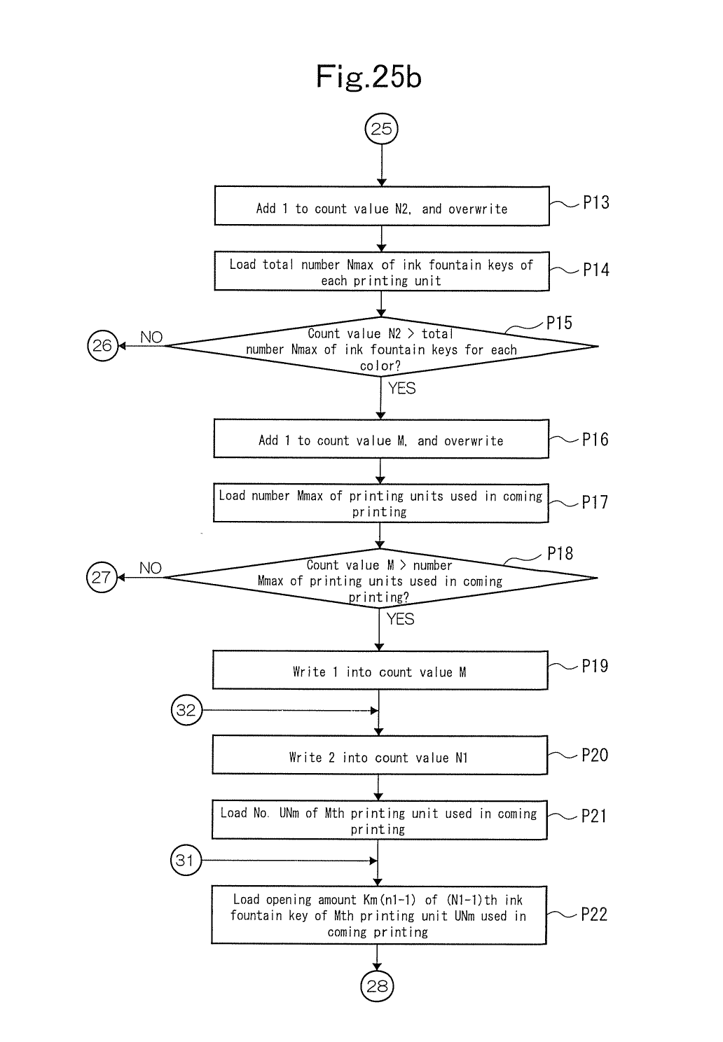

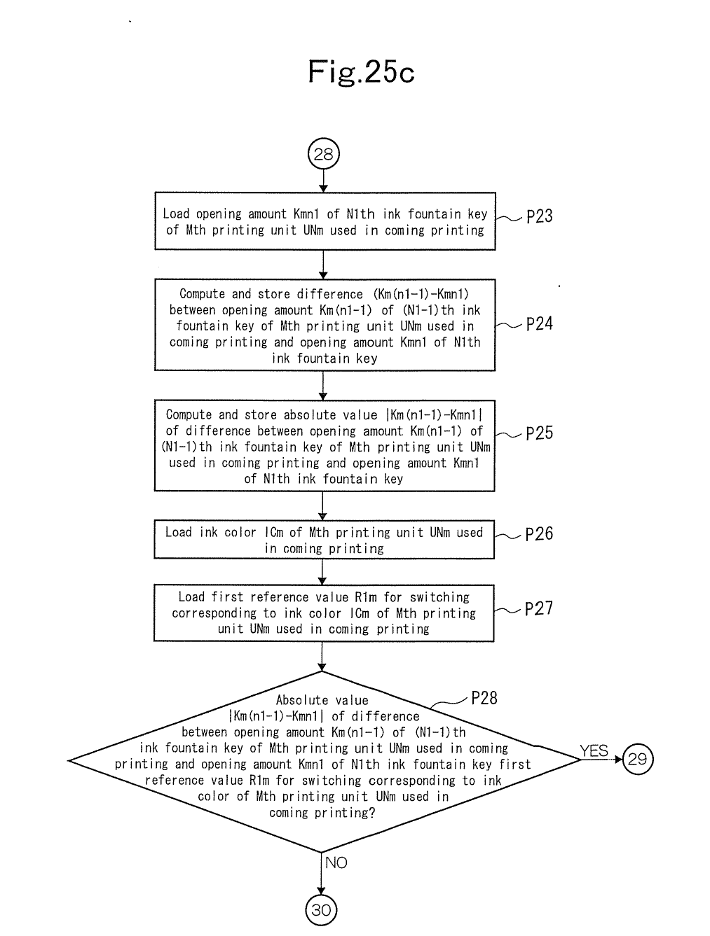

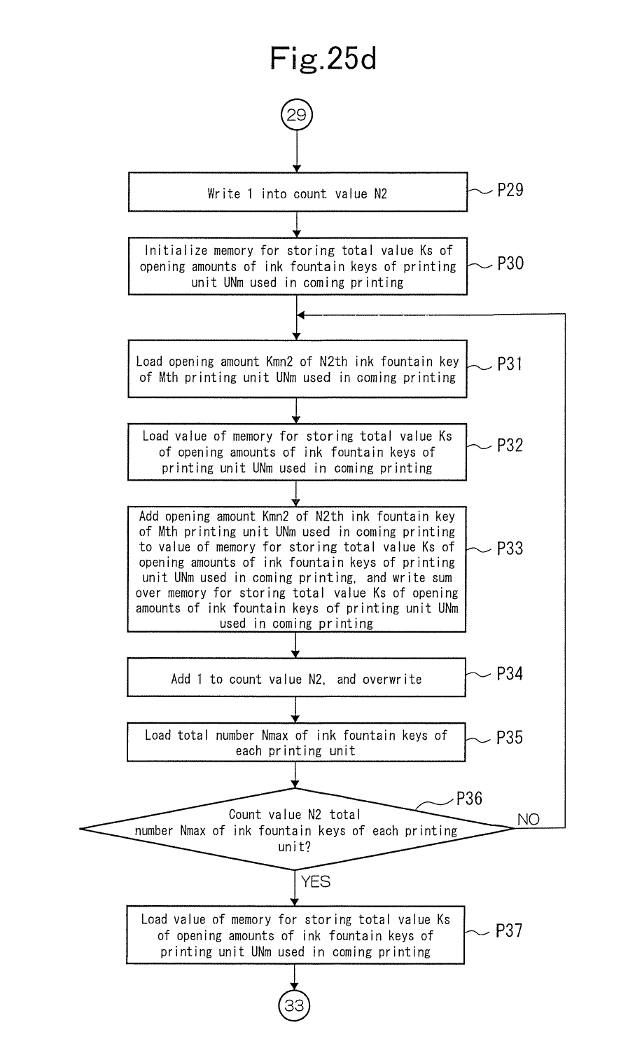

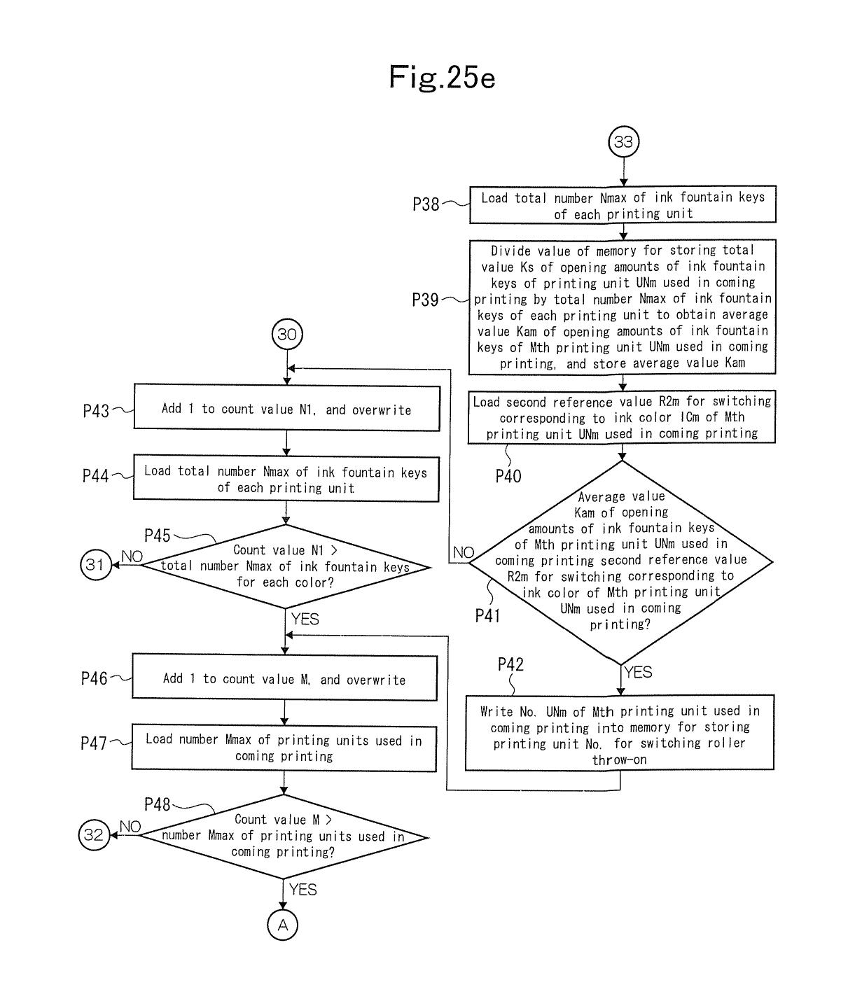

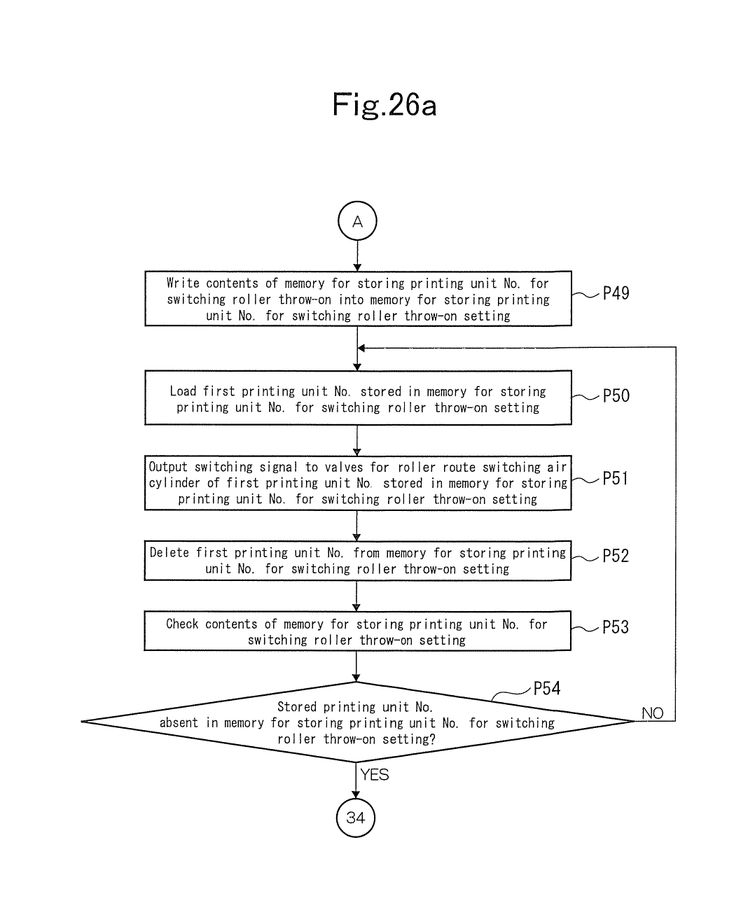

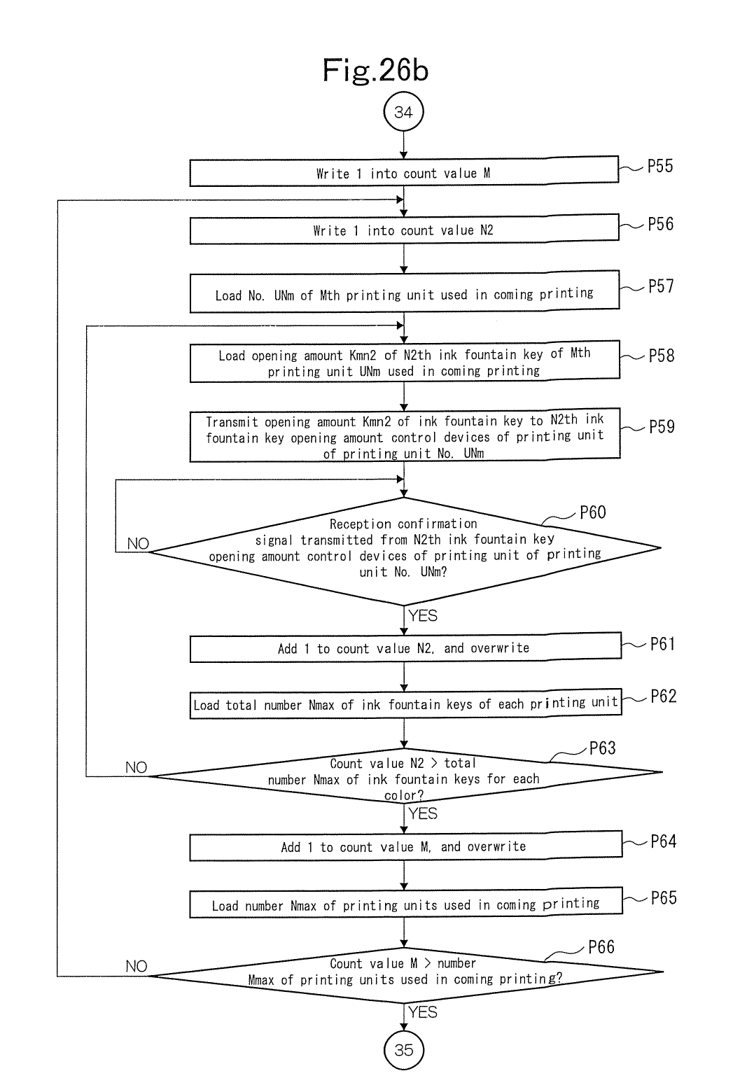

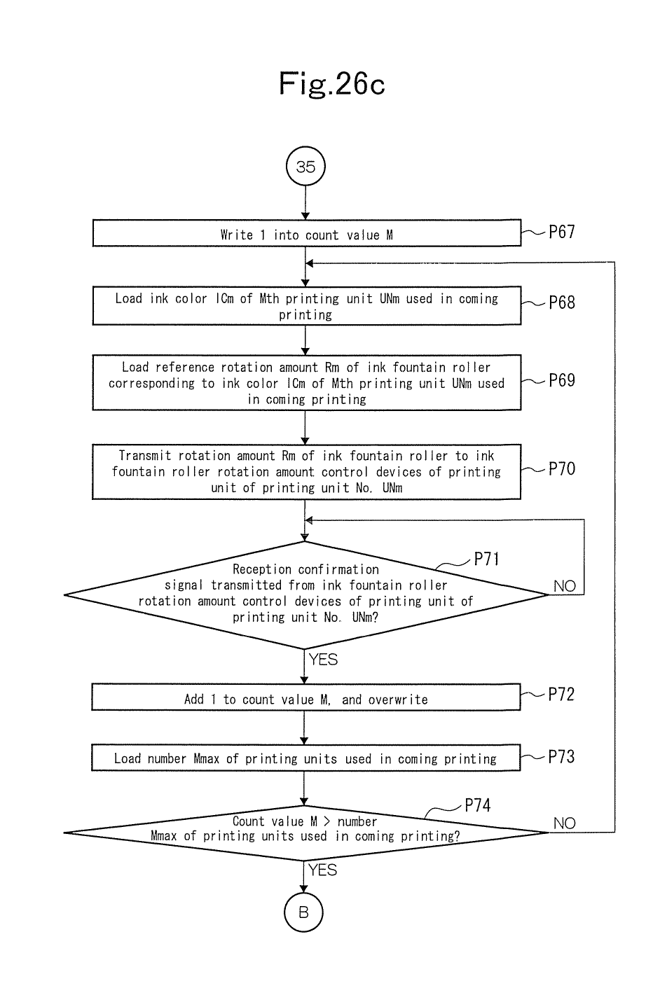

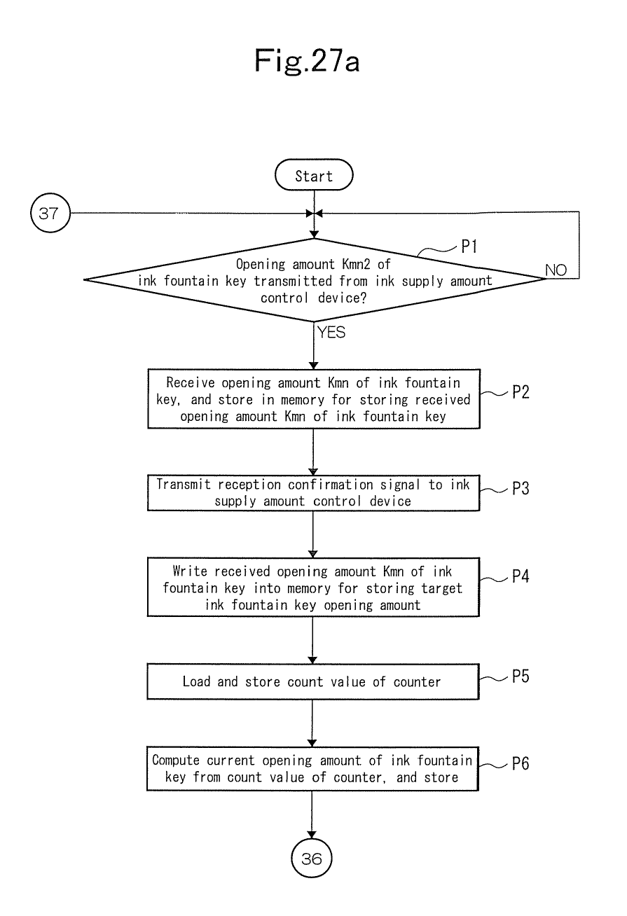

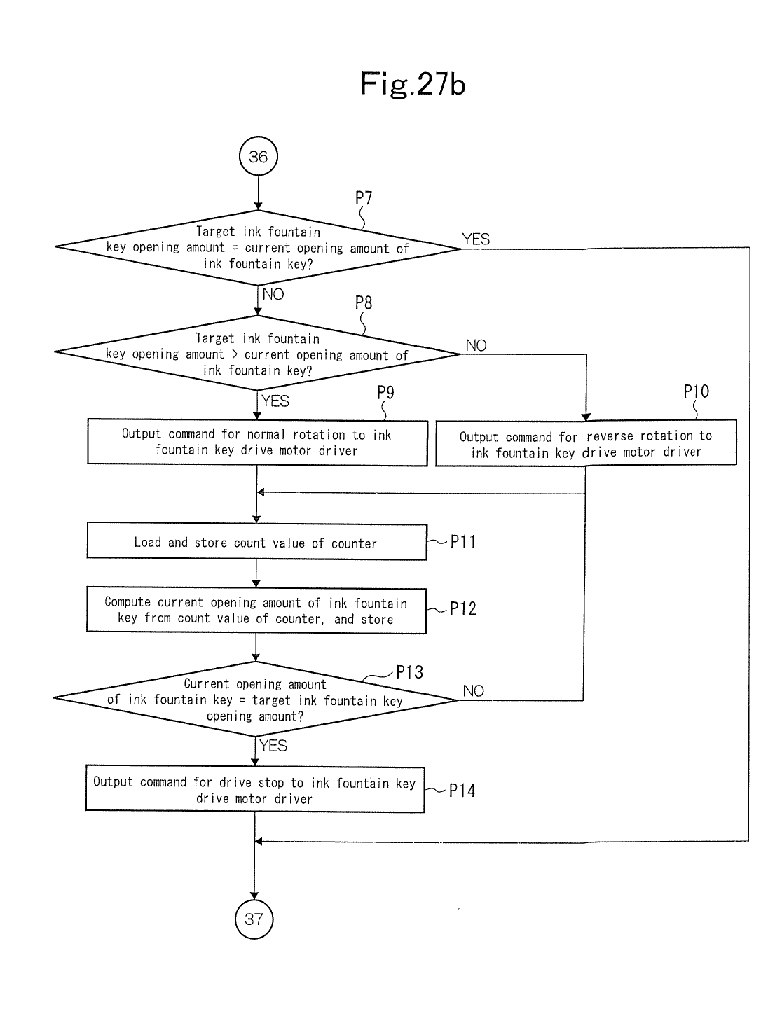

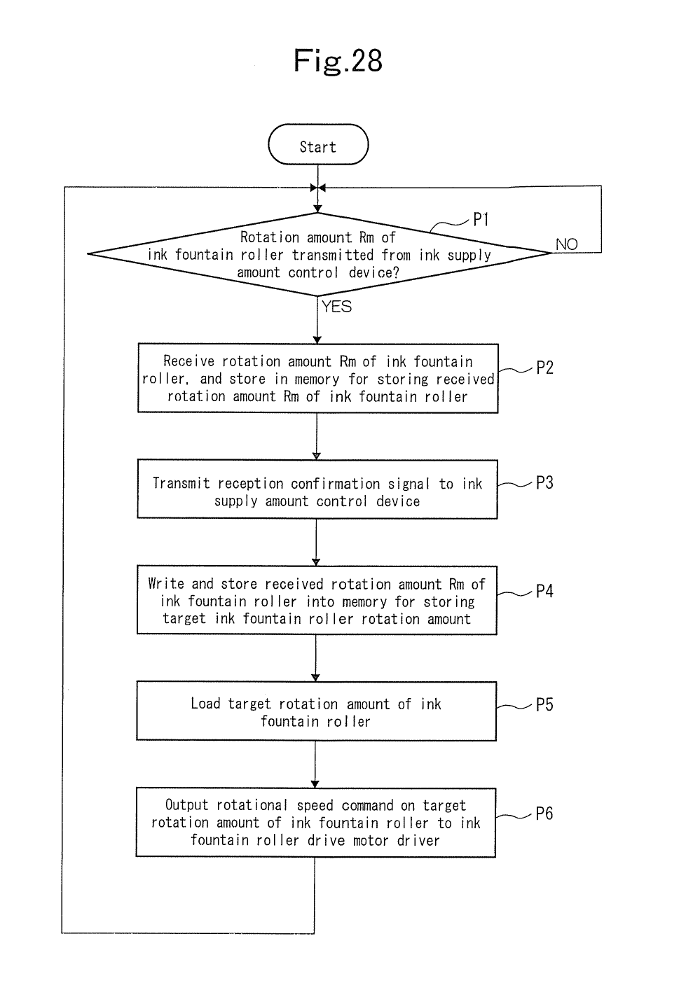

FIG. 22a is a block diagram of an ink supply amount control device showing Embodiment 3 of the present invention. FIG. 22b is a block diagram of the ink supply amount control device. FIG. 23 is a block diagram of an ink fountain key opening amount control device in Embodiment 3. FIG. 24 is a block diagram of an ink fountain roller rotation amount control device in Embodiment 3. FIG. 25a is an action flow chart of the ink supply amount control device. FIG. 25b is an action flow chart of the ink supply amount control device. FIG. 25c is an action flow chart of the ink supply amount control device. FIG. 25d is an action flow chart of the ink supply amount control device. FIG. 25e is an action flow chart of the ink supply amount control device. FIG. 26a is an action flow chart of the ink supply amount control device. FIG. 26b is an action flow chart of the ink supply amount control device. FIG. 26c is an action flow chart of the ink supply amount control device. FIG. 27a is an action flow chart of the ink fountain key opening amount control device. FIG. 27b is an action flow chart of the ink fountain key opening amount control device. FIG. 28 is an action flow chart of the ink fountain roller rotation amount control device.

The configuration of the switching means for the ink transport route in the present embodiment is the same as that in Embodiment 1. Thus, duplicate explanations are omitted by reference to FIGS. 1 to 3.

The ink supply amount control device 30 of the present embodiment comprises CPU 31, RAM 32, ROM 33, an input/output device 53, an input/output device 54, an interface 55, and the following memories connected by a bus-line (BUS) 56, as shown in FIGS. 22a and 22b: A memory 36 for storing a second reference value R2m for switching corresponding to each ink color ICm; a memory 37 for storing a printing unit No. for switching roller throw-on; a memory 38 for storing an image area rate-ink fountain key opening amount conversion table corresponding to each ink color ICm; a memory 39 for storing the ink fountain key opening amount Kmn2 of each printing unit used in the coming printing; a memory 40 for storing a printing unit No. for switching roller throw-on setting; a memory 41 for storing a reference ink fountain roller rotation amount Rm corresponding to each ink color ICm; a memory 42 for storing the number Mmax of the printing units used in the coming printing; a memory 43 for storing the No. UNm of a printing unit used in the coming printing; a memory 44 for storing the ink color ICm of each printing unit UNm used in the coming printing; a memory 45 for storing an image area rate IRmn in a range corresponding to each ink fountain key of each printing unit UNm used in the coming printing; a memory 46 for storing a count value M; a memory 47 for storing a count value N1; a memory 50 for storing a first reference value R1m for switching corresponding to each ink color ICm; a memory 51 for storing the total number Nmax of the ink fountain keys of each printing unit; a memory 52 for storing a count value N2; a memory 97 for storing the total value Ks of the ink fountain keys of each printing unit used in the coming printing; a memory 98 for storing the average value Kam of the ink fountain keys of the respective printing units used in the coming printing; a memory 99 for storing the difference (Km(n1-1)−Kmn1) between the opening amount Km(n1-1) of the (N1-1)th ink fountain key and the opening amount Kmn1 of the N1th ink fountain key of each printing unit UNm used in the coming printing; and a memory 100 for storing the absolute value |Km(n1-1)−Kmn1| of the difference between the opening amount Km(n1-1) of the (N1-1)th ink fountain key and the opening amount Kmn1 of the N1th ink fountain key of each printing unit UNm used in the coining printing.

An input device 57, such as a keyboard, various switches, and a button, a display device 58, such as CRT and a lamp, and an output device 59, such as an F-D drive, and a printer, are connected to the input/output device 53. To the input/output device 54, there are connected a valve 60-1 for an air cylinder for switching the roller route of the first printing unit through a valve 60-M for an air cylinder for switching the roller route of the Mth printing unit corresponding to the air cylinder 25-1 for switching the roller route of the first printing unit through the air cylinder 25-M for switching the roller route of the Mth printing unit.

To the interface 55, there are connected a printing press control device 61, a first (first printing unit) ink fountain roller rotation amount control device 63-1 through an Mth (Mth printing unit) ink fountain roller rotation amount control device 63-M, and a first ink fountain key opening amount control device 62-1 through an (M×N)th ink fountain key opening amount control device 62-(M×N).

The printing press control device 61 controls the entire printing press, including a feeding unit, first to Mth printing units, and a delivery unit which are not shown.

As shown in FIG. 23, the first ink fountain key opening amount control device 62-1 through the (M×N)th ink fountain key opening amount control device 62-(M×N) comprise the following: CPU 64, RAM 65, ROM 66, and a memory 67 for storing a received ink fountain key opening amount Kmn, a memory 68 for storing a target ink fountain key opening amount, a memory 69 for storing the count value of a counter, and a memory 70 for storing a current ink fountain key opening amount are connected via a buts-line (BUS) 73 together with an input/output device 71 and an interface 72.

To the input/output device 71, an ink fountain key drive motor 74 is connected via an ink fountain key drive motor driver 75, and an ink fountain key drive motor rotary encoder 76 incorporated in the ink fountain key drive motor 74 is connected via a counter 77. A detection signal from the ink fountain key drive motor rotary encoder 76 is inputted into the ink fountain key drive motor driver 75. The aforementioned ink supply amount control device 30 is connected to the interface 72.

As shown in FIG. 24, the first ink fountain roller rotation amount control device 63-1 through the Mth ink fountain roller rotation amount control device 63-M comprise CPU 78, RAM 79, ROM 80, and a memory 81 for storing a received ink fountain roller rotation amount Rm, and a memory 82 for storing a target ink fountain roller rotation amount connected via a bus-line (BUS) 85 together with an input/output device 83 and an interface 84.

To the input/output device 83, an ink fountain roller drive motor 86 is connected via an ink fountain roller drive motor driver 87, and an ink fountain roller drive motor rotary encoder 88 incorporated in the ink fountain roller drive motor 86 is connected via an F/V converter 89 and an A/D converter 90. A detection signal from the ink fountain roller drive motor rotary encoder 88 is inputted into the ink fountain roller drive motor driver 87. The aforementioned ink supply amount control device 30 is connected to the interface 84.

Because of the above configuration, the ink supply amount control device 30 acts in accordance with action flows shown in FIGS. 25a through 25e and FIGS. 26a to 26c.

That is, it is determined in Step P1 whether an ink preset switch in the input/output device 57 is ON or not. If ON, each memory is initialized in Step P2. If not ON, it is determined in Step P3 whether a printing completion signal has been outputted from the printing press control device 61. If YES, outputting of a switching signal to the valves 60-1 through 60-M for air cylinders for switching the roller routes of all printing units is stopped in Step P4, and the program returns to Step P1. If NO, the program immediately returns to Step P1.

Then, in Step P5, the number Mmax of the printing units used in the coming printing, the printing unit No. UNm, the ink color ICm of each printing unit UNm, and the image area rate IRmn in a range corresponding to each ink fountain key are inputted, and stored into the memories 42 to 45. Then, in Step P6, 1 is written into the memory 46 for storing the count value M. In Step P7, 1 is written into the memory 52 for storing the count value N2.

Then, in Step P8, the No. UNm of the Mth printing unit used in the coming printing is read from the memory 43. Then, in Step P9, the ink color ICm of the Mth printing unit UNm used in the coming printing is read from the memory 44. Then, in Step P10, an image area rate-ink fountain key opening amount conversion table corresponding to the ink color ICm of the Mth printing unit UNm used in the coming printing is read from the memory 38.

Then, in Step P11, an image area rate IRmn2 in a range corresponding to the N2th ink fountain key of the Mth printing unit UNm used in the coming printing is read from the memory 45. Then, in Step P12, the opening amount Kmn2 of the N2th ink fountain key of the Mth printing unit UNm used in the coming printing is found from the image area rate IRmn2 in the range corresponding to the N2th ink fountain key of the Mth printing unit UNm used in the coming printing by use of the image area rate-ink fountain key opening amount conversion table corresponding to the ink color ICm of the Mth printing unit UNm used in the coming printing, and the opening amount Kmn2 is stored in the memory 39.

Then, in Step P13, 1 is added to the count value N2, and the sum is written over the memory 52. Then, in Step P14, the total number Nmax of the ink fountain keys of each printing unit is read from the memory 51, and in Step P15, it is determined whether the count value N2 is greater than the total number Nmax of the ink fountain keys for each color.

If YES in Step P15, 1 is added to the count value M, and the sum is written over the memory 46 in Step P16. If NO in Step P15, the program returns to Step P9.

Then, in Step P17, the number Mmax of the printing units used in the coming printing is read from the memory 42. Then, in Step P18, it is determined whether the count value M is greater than the number Mmax of the printing units used in the coming printing. If YES, 1 is written into the memory 46 for storing the count value M, in Step P19. If NO, the program returns to Step P7.

Then, in Step P20, 2 is written into the memory 47 for storing the count value N1. Then, in Step P21, the No. UNm of the Mth printing unit used in the coming printing is read from the memory 43. Then, in Step P22, the opening amount Km(n1-1) of the (N1-1)th ink fountain key of the Mth printing unit UNm used in the coming printing is read from the memory 39.

Then, in Step P23, the opening amount Kmn1 of the N1th ink fountain key of the Mth printing unit UNm used in the coming printing is read from the memory 39. Then, in Step P24, the difference (Km(n1-1)−Kmn1) between the opening amount Km(n1-1) of the (N1-1)th ink fountain key of the Mth printing unit UNm used in the coming printing and the opening amount Kmn1 of the N1th ink fountain key is computed, and stored into the memory 99.

Then, in Step P25, the absolute value |Km(n1-1)−Kmn1| of the difference between the opening amount Km(n1-1) of the (N1-1)th ink fountain key of the Mth printing unit UNm used in the coming printing and the opening amount Kmn1 of the N1th ink fountain key is computed, and stored into the memory 100. Then, in Step P26, the ink color ICm of the Mth printing unit UNm used in the coming printing is read from the memory 44.

Then, in Step P27, the first reference value R1m for switching corresponding to the ink color ICm of the Mth printing unit UNm used in the coming printing is read from the memory 50. Then, in Step P28, it is determined whether the absolute value |Km(n1-1)−Kmn1| of the difference between the opening amount Km(n1-1) of the (N1-1)th ink fountain key of the Mth printing unit UNm used in the coming printing and the opening amount Kmn1 of the N1th ink fountain key is equal to or larger than the first reference value R1m for switching corresponding to the ink color of the Mth printing unit UNm used in the coming printing.

If YES in Step P28, 1 is written into the memory 52 for storing the count value N2 in Step P29. If NO, the program shifts to Step P43 to be described later.

Then, in Step P30, the memory 97 for storing the total value Ks of the opening amounts of the ink fountain keys of the printing unit UNm used in the coming printing is initialized. Then, in Step P31, the opening amount Kmn2 of the N2th ink fountain key of the Mth printing unit UNm used in the coming printing is read from the memory 39. Then, in Step P32, the value of the memory 97 for storing the total value Ks of the opening amounts of the ink fountain keys of the printing unit UNm used in the coming printing is loaded.

Then, in Step P33, the opening amount Kmn2 of the N2th ink fountain key of the Mth printing unit UNm used in the coming printing is added to the value of the memory for storing the total value Ks of the opening amounts of the ink fountain keys of the printing unit UNm used in the coming printing, and the sum is written over the memory 97 for storing the total value Ks of the opening amounts of the ink fountain keys of the printing unit UNm used in the coming printing. Then, in Step P34, 1 is added to the count value N2, and the sum is written over the memory 52.

Then, in Step P35, the total number Nmax of the ink fountain keys of each printing unit is read from the memory 51. Then, in Step P36, it is determined whether the count value N2 is equal to or greater than the total number Nmax of the ink fountain keys of each printing unit. If YES, the value of the memory 97 for storing the total value Ks of the opening amounts of the ink fountain keys of the printing unit UNm used in the coming printing is loaded in Step P37. If NO, the program returns to Step P31.

Then, in Step P38, the total number Nmax of the ink fountain keys of each printing unit is read from the memory 51. Then, in Step P39, the value of the memory for storing the total value Ks of the opening amounts of the ink fountain keys of the printing unit UNm used in the coming printing is divided by the total number Nmax of the ink fountain keys of each printing unit to obtain the average value Kam of the opening amounts of the ink fountain keys of the Mth printing unit UNm used in the coming printing, and the average value Kam is stored in the memory 98.

Then, in Step P40, the second reference value R2m for switching corresponding to the ink color ICm of the Mth printing unit UNm used in the coming printing is read from the memory 36. Then, in Step P41, it is determined whether the average value Kam of the opening amounts of the ink fountain keys of the Mth printing unit UNm used in the coming printing is equal to or greater than the second reference value R2m for switching corresponding to the ink color of the Mth printing unit UNm used in the coming printing.

If YES in Step P41, the No. UNm of the Mth printing unit used in the coming printing is written into the memory 37 for storing the printing unit No. for switching roller throw-on in Step P42. Then, the program shifts to Step P46 to be described later. If NO, 1 is added to the count value N1, and the sum is written over the memory 47, in Step P43.

Then, in Step P44, the total number Nmax of the ink fountain keys of each printing unit is read from the memory 51. Then, in Step P45, it is determined whether the count value N1 is greater than the total number Nmax of the ink fountain keys for each color. If YES, 1 is added to the count value M, and the sum is written over the memory 46, in Step P46. If NO, the program returns to Step P22.

Then, in Step P47, the number Mmax of the printing units used in the coming printing is read from the memory 42. Then, in Step P48, it is determined whether the count value M is greater than the number Mmax of the printing units used in the coming printing. If YES, the contents of the memory 37 for storing the printing unit No. for switching roller throw-on are written into the memory 40 for storing the printing unit No. for switching roller throw-on setting in Step P49. If NO, the program returns to Step P20.

Then, the first printing unit No. stored in the memory 40 for storing the printing unit No. for switching roller throw-on setting is loaded in Step P50. Then, in Step P51, a switching signal is outputted to the valves 60-1 through 60-M for the roller route switching air cylinders of the first printing unit No. stored in the memory 40 for storing the printing unit No. for switching roller throw-on setting. Then, in Step P52, the first printing unit No. is deleted from the memory 40 for storing the printing unit No. for switching roller throw-on setting.

Then, in Step P53, the contents of the memory 40 for storing the printing unit No. for switching roller throw-on setting are checked. Then, in Step P54, it is determined whether the stored printing unit No. is absent in the memory 40 for storing the printing unit No. for switching roller throw-on setting. If YES, 1 is written into the memory 46 for storing the count value M in Step P55. If NO, the program returns to Step P50.

Then, in Step P56, 1 is written into the memory 52 for storing the count value N2. Then, in Step P57, the No. UNm of the Mth printing unit used in the coming printing is read from the memory 43. Then, in Step P58, the opening amount Kmn2 of the N2th ink fountain key of the Mth printing unit UNm used in the coming printing is read from the memory 39.

Then, in Step P59, the opening amount Kmn2 of the ink fountain key is transmitted to the N2th ink fountain key opening amount control devices 62-1 through 62-(M×N) of the printing unit of the printing unit No. UNm. Then, if a reception confirmation signal is transmitted from the N2th ink fountain key opening amount control devices 62-1 through 62-(M×N) of the printing unit of the printing unit No. UNm in Step P60, 1 is added to the count value N2, and written over the memory 52, in Step P61.

Then, in Step P62, the total number Nmax of the ink fountain keys of each printing unit is read from the memory 51. Then, in Step P63, it is determined whether the count value N2 is greater than the total number Nmax of the ink fountain keys for each color. If YES, 1 is added to the count value M, and written over the memory 46, in Step P64. If NO, the program returns to Step P58.

Then, in Step P65, the number Mmax of the printing units used in the coming printing is read from the memory 42. Then, in Step P66, it is determined whether the count value M is greater than the number Mmax of the printing units used in the coming printing. If YES, 1 is written into the memory 46 for storing the count value M in Step P67. If NO, the program returns to Step P56.

Then, in Step P68, the ink color ICm of the Mth printing unit UNm used in the coming printing is read from the memory 44. Then, in Step P69, the reference rotation amount Rm of the ink fountain roller corresponding to the ink color ICm of the Mth printing unit UNm used in the coming printing is read from the memory 41. Then, in Step P70, the rotation amount Rm of the ink fountain roller is transmitted to the ink fountain roller rotation amount control devices 63-1 through 63-M of the printing unit of the printing unit No. UNm.

Then, if a reception confirmation signal is transmitted from the ink fountain roller rotation amount control devices 63-1 through 63-M of the printing unit of the printing unit No. UNm in Step P71, 1 is added to the count value M, and the sum is written over the memory 46, in Step P72. Then, in Step P73, the number Mmax of the printing units used in the coming printing is read from the memory 42.

Then, in Step P74, it is determined whether the count value M is greater than the number Mmax of the printing units used in the coming printing. If YES, the program returns to Step P1. If NO, the program returns to Step P68. Thereafter, this procedure is repeated.

The first ink fountain key opening amount control device 62-1 through the (M×N)th ink fountain key opening amount control device 62-(M×N) also act in accordance with action flows shown in FIGS. 27a and 27b.

That is, if the opening amount Kmn2 of the ink fountain key is transmitted from the ink supply amount control device 30 in Step P1, the opening amount Kmn of the ink fountain key is received, and stored in the memory 67 for storing the opening amount Kmn of the ink fountain key in Step P2. Then, in Step P3, a reception confirmation signal is transmitted to the ink supply amount control device 30.

Then, in Step P4, the received opening amount Kmn of the ink fountain key is written into the memory 68 for storing the target ink fountain key opening amount. Then, in Step P5, the count value of the counter 77 is loaded, and stored into the memory 69. Then, in Step P6, the current opening amount of the ink fountain key is computed from the count value of the counter 77, and stored in the memory 70.

Then, in Step P7, it is determined whether the target ink fountain key opening amount is equal to the current opening amount of the ink fountain key. If YES, the program returns to Step P1. If NO, it is determined in Step P8 whether the target ink fountain key opening amount is larger than the current opening amount of the ink fountain key.

If YES in Step P8, a command for normal rotation is outputted to the ink fountain key drive motor driver 75 in Step P9. If NO, a command for reverse rotation is outputted to the ink fountain key drive motor driver 75 in Step P10.

Then, in Step P11, the count value of the counter 77 is loaded, and stored in the memory 69. Then, in Step P12, the current opening amount of the ink fountain key is computed from the count value of the counter 77, and stored in the memory 70.

Then, in Step P13, it is determined whether the current opening amount of the ink fountain key is equal to the target ink fountain key opening amount. If YES, a command for drive stop is outputted to the ink fountain key drive motor driver 75 in Step P14. Then, the program returns to Step P1. If NO, the program returns to Step P11. Thereafter, this procedure is repeated.

The first ink fountain roller rotation amount control device 63-1 through the Mth ink fountain roller rotation amount control device 63-M act in accordance with an action flow shown in FIG. 28.

That is, if the rotation amount Rm of the ink fountain roller is transmitted from the ink supply amount control device 30 in Step P1, the rotation amount Rm of the ink fountain roller is received, and stored in the memory 81 for storing the received rotation amount Rm of the ink fountain roller in Step P2. Then, in Step P3, a reception confirmation signal is transmitted to the ink supply amount control device 30.

Then, in Step P4, the received rotation amount Rm of the ink fountain key is written into the memory 82 for storing the target ink fountain roller rotation amount, and stored. Then, in Step P5, the target rotation amount of the ink fountain roller is read from the memory 82.

Then, in Step P6, a rotational speed command on the target rotation amount of the ink fountain roller is outputted to the ink fountain roller drive motor driver 87, and the program returns to Step P1. Thereafter, this procedure is repeated.

In the present embodiment, as described above, the opening amount (Kmn) of each ink fountain key of each printing unit is found, and the difference (Km(n1-1)−Kmn1) between the opening amounts of the adjacent ink fountain keys is found. If this difference (absolute value) is equal to or greater than a certain value (first reference value R1m: third reference value in the claim) in even one of the ranges (see FIG. 5b), the ink distribution roller 4e is automatically thrown on the ink oscillating roller 5b to supply a larger amount of ink to the ink form rollers 6b, 6c on the dampening side, thus establishing an ink transport route where a ghost or the like minimally occurs (i.e., first ink transport route). If there is no such range (see FIG. 5a), on the other hand, the ink distribution roller 4e is automatically thrown off the ink oscillating roller 5b to supply a smaller amount of ink to the ink form rollers 6b, 6c on the dampening side, thus establishing an ink transport route where color irregularities or the like minimally occur (i.e., second ink transport route).

By so doing, the burden on the operator is lightened, and the rate of operation is increased. Furthermore, forgetting to do switching is avoided, thus eliminating a waste of printing material.

If, in the present embodiment, the difference (Km(n1-1)−Kmn1) between the opening amounts of the adjacent ink fountain keys is equal to or greater than the certain value (first reference value R1m), the average of the opening amounts of the respective ink fountain keys is obtained. Only when the obtained average value (Kam) is equal to or greater than a certain value (second reference value R2m: fourth reference value in the claim), the ink distribution roller 4e is automatically thrown on the ink oscillating roller 5b to supply a larger amount of ink to the ink form rollers 6b, 6c on the dampening side, thus establishing the ink transport route where a ghost or the like minimally occurs (i.e., first ink transport route). When the average value is smaller than the certain value (second reference value R2m), on the other hand, the ink distribution roller 4e is automatically thrown off the ink oscillating roller 5b to supply a smaller amount of ink to the ink form rollers 6b, 6c on the dampening side, thus establishing the ink transport route where the ink is minimally emulsified (i.e., second ink transport route). Furthermore, the average value (Kam) of the opening amounts of the ink fountain keys is the value obtained by dividing the total value (Ks) of the opening amounts of the ink fountain keys by the total number Nmax of the ink fountain keys of the respective printing units. Since the total number Nmax of the ink fountain keys of the respective printing units is a constant value, it goes without saying that the total value (Ks) may be obtained instead of the average value (Kam) of the opening amounts (Kmn) of the ink fountain keys, and this total value (Ks) may be compared with the certain value (second reference value R2m).

By so doing, the operator's judgment becomes unnecessary, the burden on the operator is lightened, the operator's mistake in switching is avoided, and the rate of operation is further increased. Also, a waste of printing material is eliminated further. In the above embodiment, moreover, the ink distribution roller 4e is thrown on the ink oscillating roller 5b when the opening amount difference (Km(n1-1)−Kmn1) is equal to or greater than the first reference value and the average value (Kam) is equal to or greater than the second reference value. However, the ink distribution roller 4e may be thrown on the ink oscillating roller 5b when the opening amount difference (Km(n1-1)−Kmn1) of the ink fountain key is greater than the first reference value and the average value (Kam) is greater than the second reference value.

### Embodiment 4

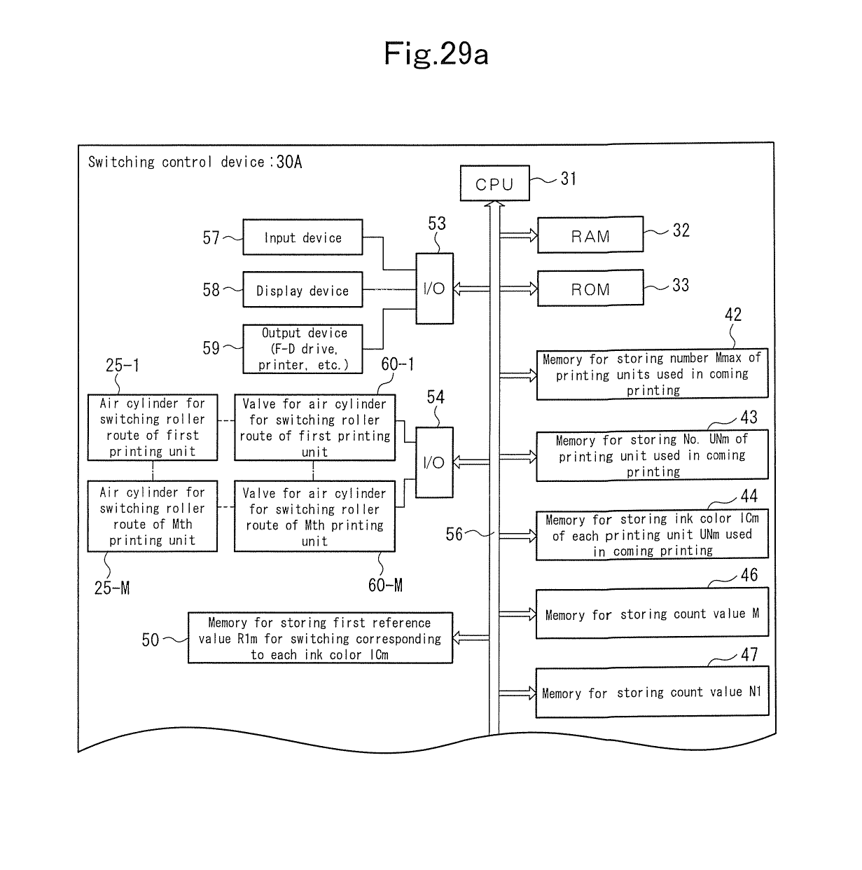

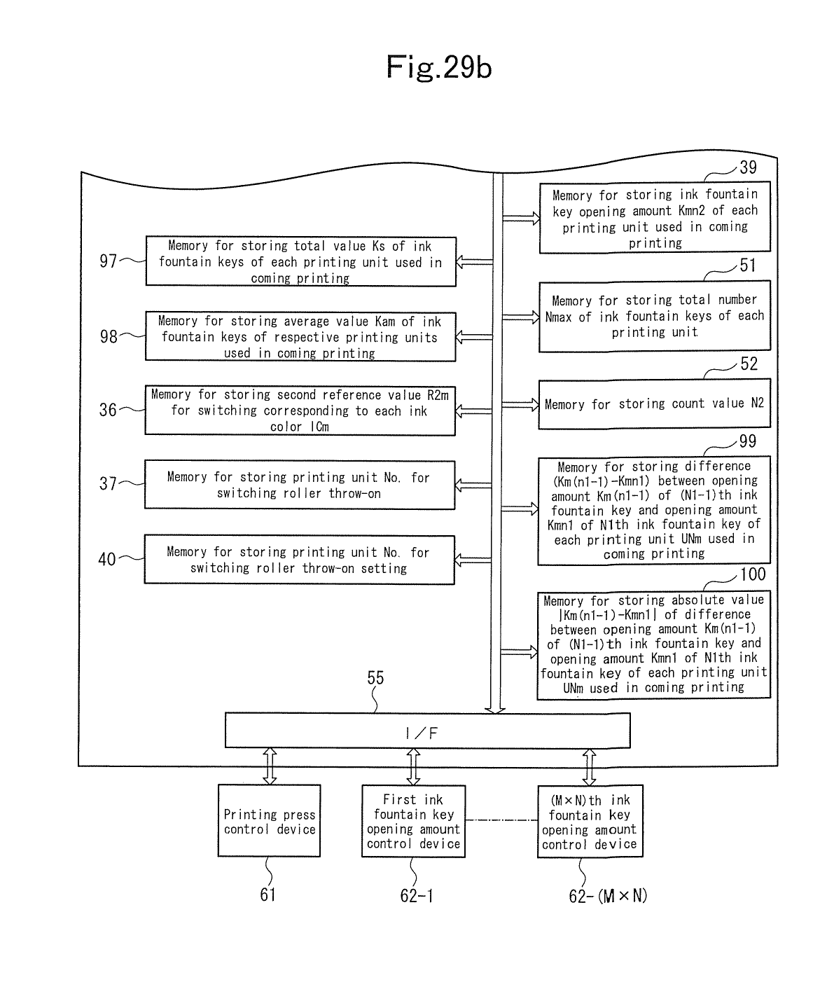

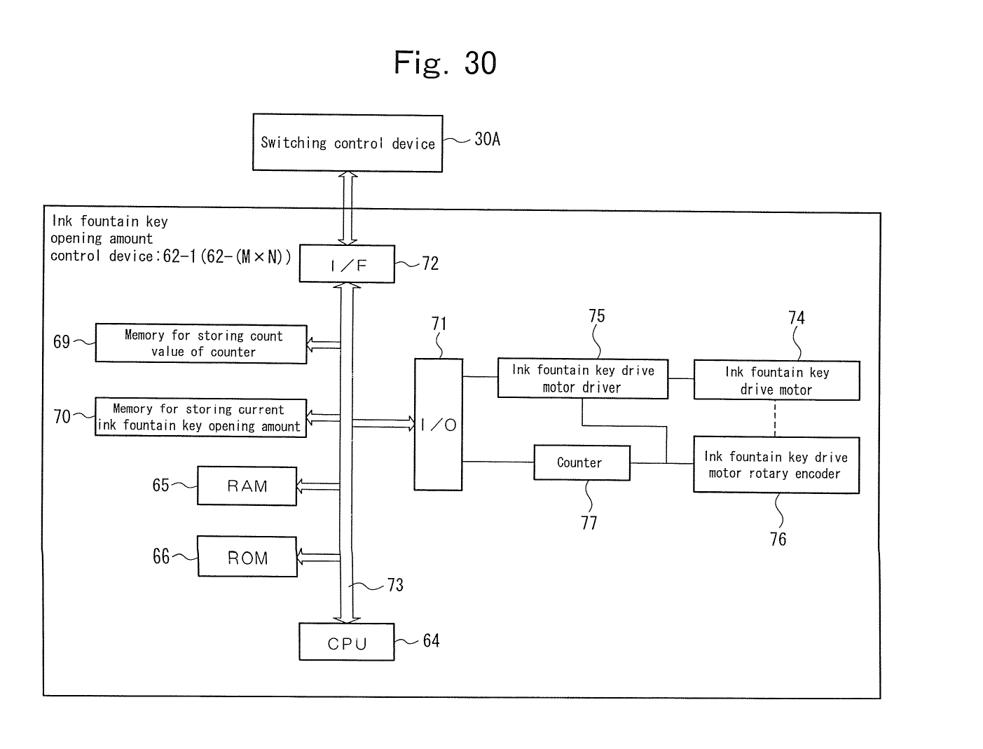

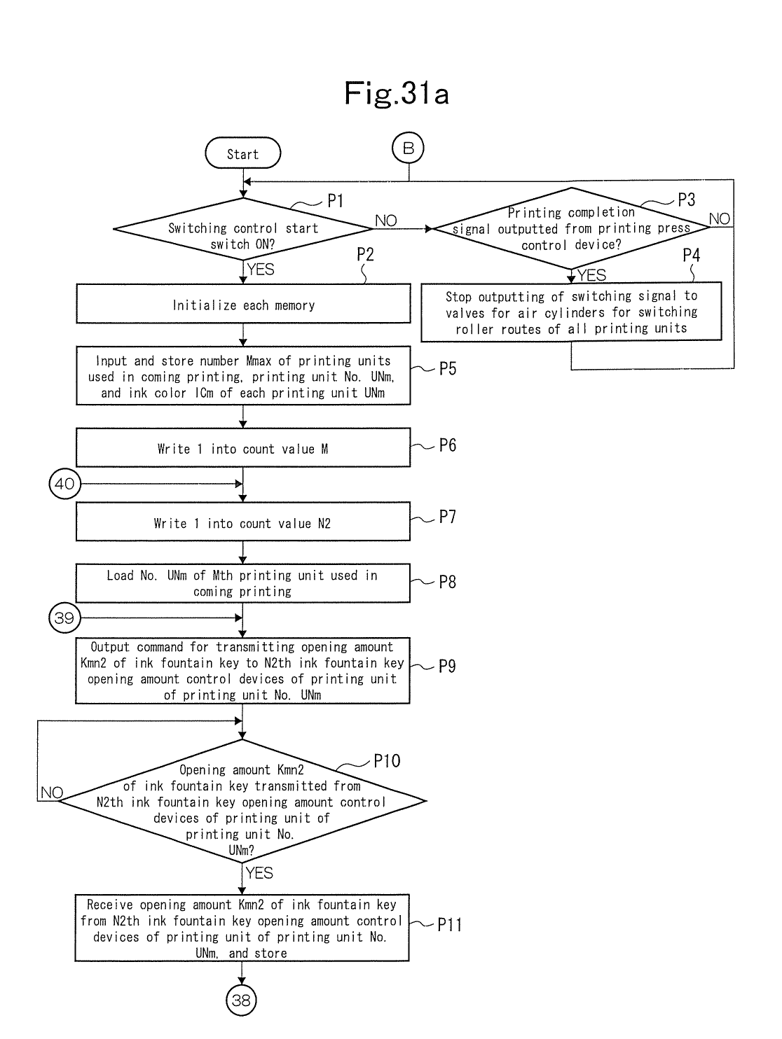

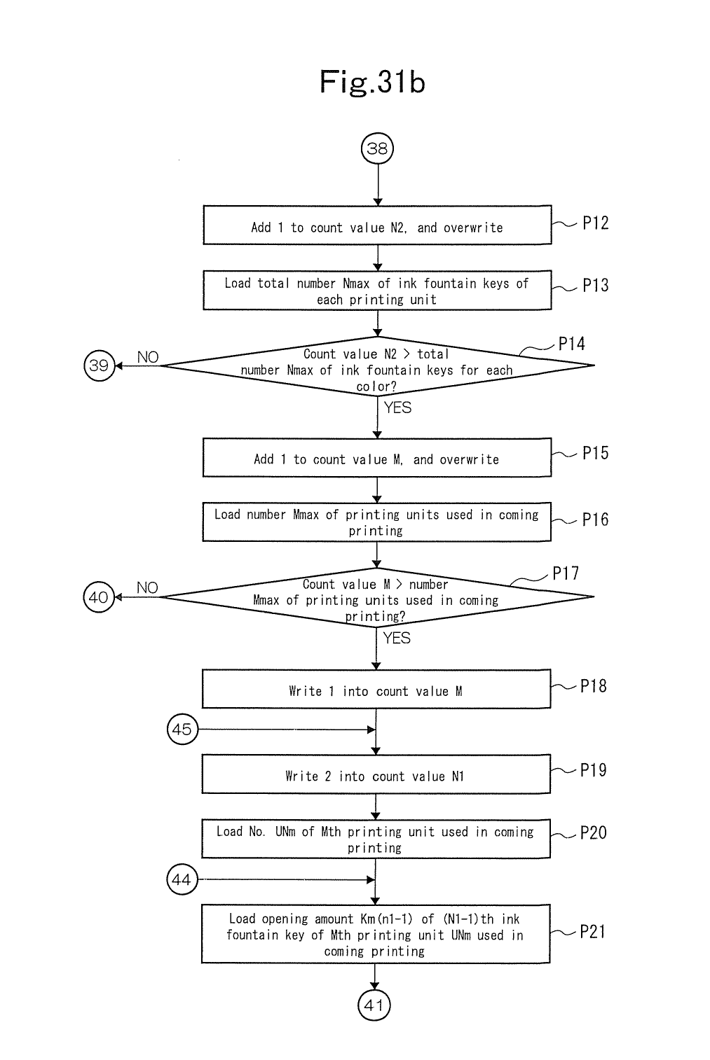

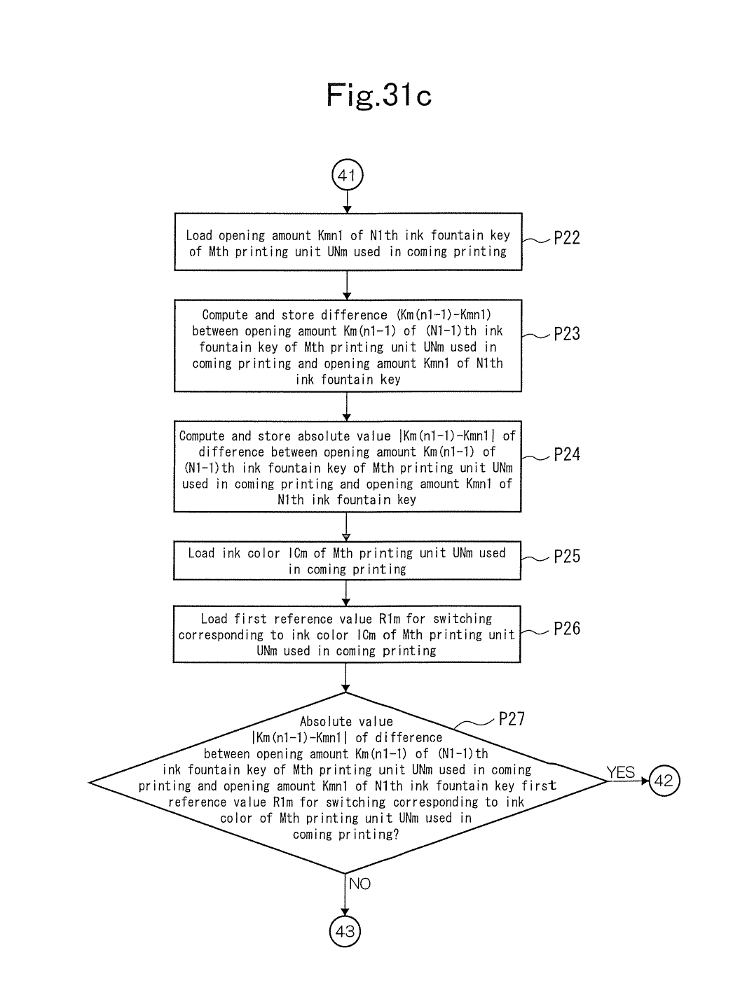

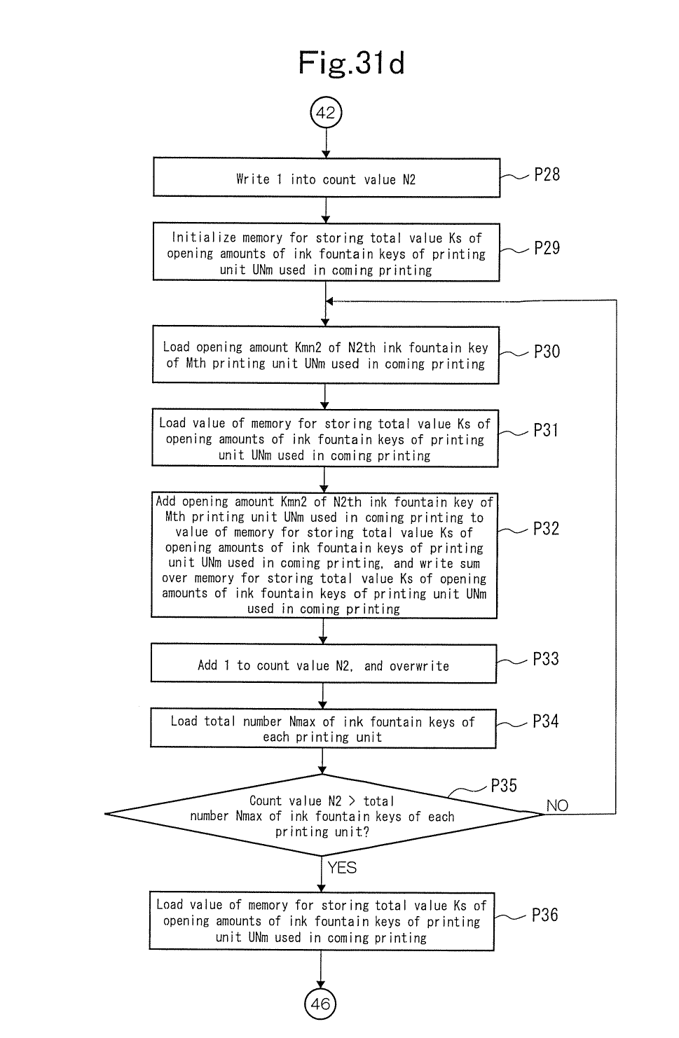

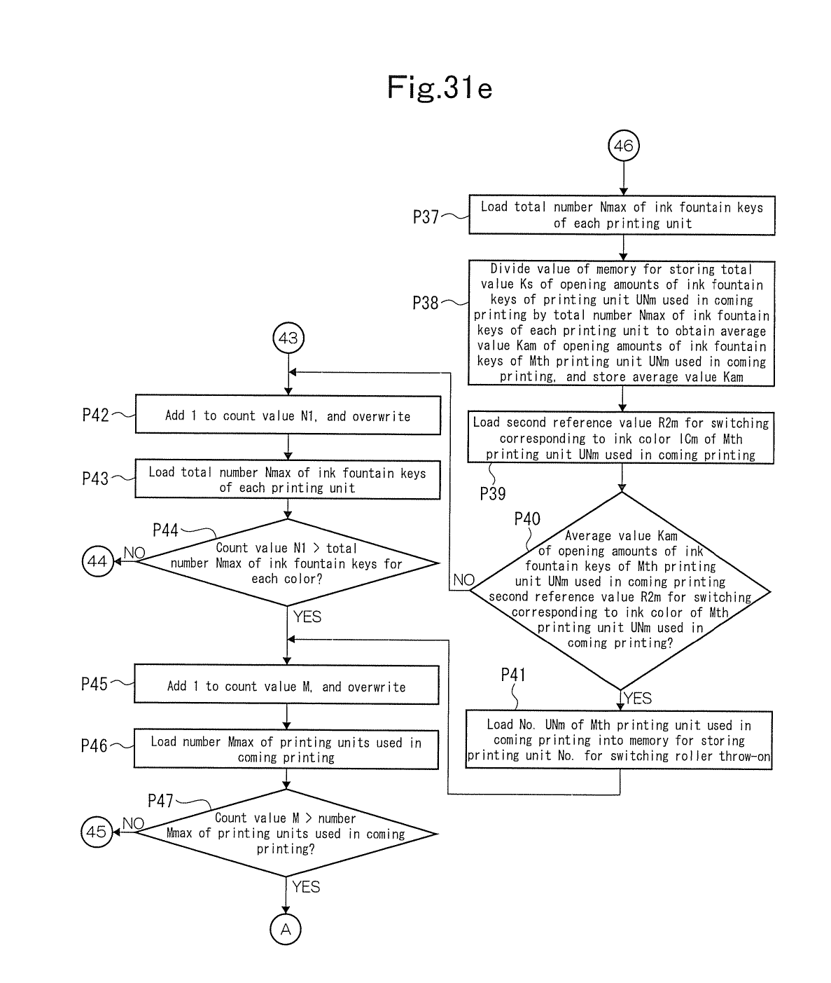

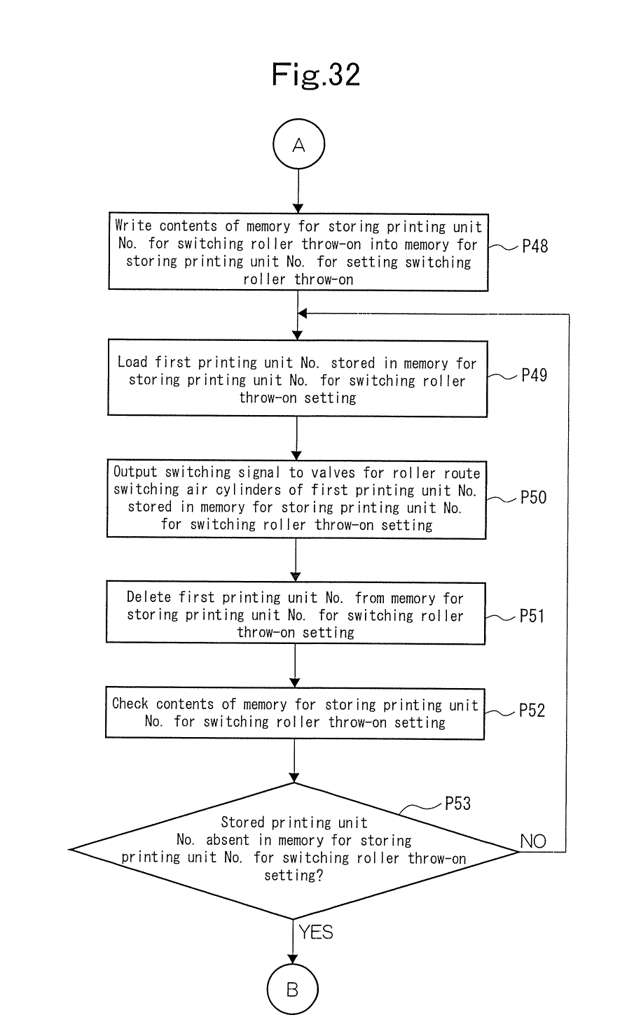

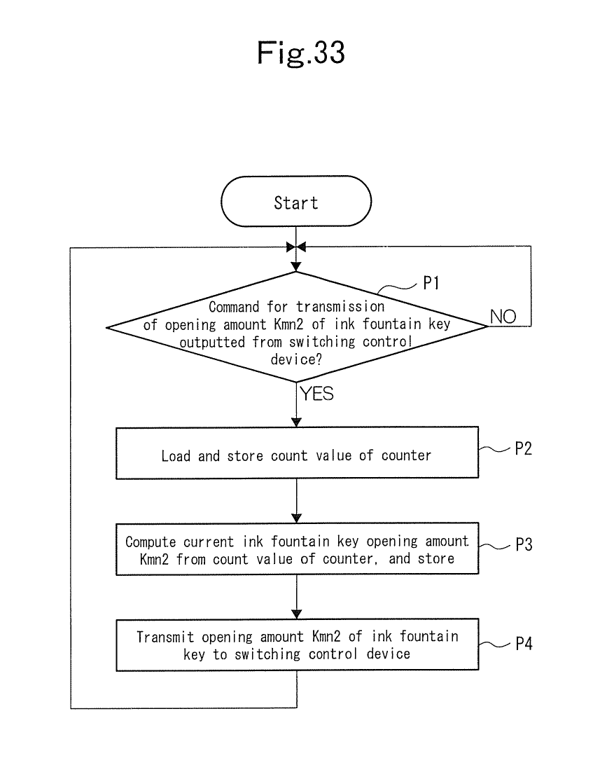

FIG. 29a is a block diagram of a switching control device showing Embodiment 4 of the present invention. FIG. 29b is a block diagram of the switching control device. FIG. 30 is a block diagram of an ink fountain key opening amount control device in Embodiment 4. FIG. 31a is an action flow chart of the switching control device. FIG. 31b is an action flow chart of the switching control device. FIG. 31c is an action flow chart of the switching control device. FIG. 31d is an action flow chart of the switching control device. FIG. 31e is an action flow chart of the switching control device. FIG. 32 is an action flow chart of the switching control device. FIG. 33 is an action flow chart of the ink fountain key opening amount control device.

In the present embodiment, the configuration of the switching means for the ink transport route is the same as that in Embodiment 1, except that the roller route switching air cylinders 25-1 to 25-M of the first to Mth printing units in Embodiment 1 are driven and controlled by a switching control device 30A to be described later. Thus, duplicate explanations will be omitted by reference to FIGS. 1 to 3.

The switching control device 30A of the present embodiment comprises CPU 31, RAM 32, ROM 33, an input/output device 53, an input/output device 54, an interface 55, and the following memories connected by a bus-line (BUS) 56, as shown in FIGS. 29a and 29b: A memory 36 for storing a second reference value R2m for switching corresponding to each ink color ICm; a memory 37 for storing a printing unit No. for switching roller throw-on; a memory 39 for storing the ink fountain key opening amount Kmn2 of each printing unit used in the coming printing; a memory 40 for storing a printing unit No. for switching roller throw-on setting; a memory 42 for storing the number Mmax of the printing units used in the coming printing; a memory 43 for storing the No. UNm of a printing unit used in the coming printing; a memory 44 for storing the ink color ICm of each printing unit UNm used in the coming printing; a memory 46 for storing a count value M; a memory 47 for storing a count value N1; a memory 50 for storing a first reference value R1m for switching corresponding to each ink color ICm; a memory 51 for storing the total number Nmax of the ink fountain keys of each printing unit; a memory 52 for storing a count value N2; a memory 97 for storing the total value Ks of the ink fountain keys of each printing unit used in the coming printing; a memory 98 for storing the average value Kam of the ink fountain keys of the respective printing units used in the coming printing; a memory 99 for storing the difference (Km(n1-1)−Kmn1) between the opening amount Km(n1-1) of the (N1-1)th ink fountain key and the opening amount Kmn1 of the N1th ink fountain key of each printing unit UNm used in the coming printing; and a memory 100 for storing the absolute value |Km(n1-1)−Kmn1| of the difference between the opening amount Km(n1-1) of the (N1-1)th ink fountain key and the opening amount Kmn1 of the N1th ink fountain key of each printing unit UNm used in the coming printing.

An input device 57, such as a keyboard, various switches, and a button, a display device 58, such as CRT and a lamp, and an output device 59, such as an F-D drive, and a printer, are connected to the input/output device 53. To the input/output device 54, there are connected a valve 60-1 for an air cylinder for switching the roller route of the first printing unit through a valve 60-M for an air cylinder for switching the roller route of the Mth printing unit corresponding to the air cylinder 25-1 for switching the roller route of the first printing unit through the air cylinder 25-M for switching the roller route of the Mth printing unit.

To the interface 55, there are connected a printing press control device 61, and a first ink fountain key opening amount control device 62-1 through a (M×N)th ink fountain key opening amount control device 62-(M×N).

The printing press control device 61 controls the entire printing press, including a feeding unit, first to Mth printing units, and a delivery unit which are not shown.

As shown in FIG. 30, the first ink fountain key opening amount control device 62-1 through the (M×N)th ink fountain key opening amount control device 62-(M×N) comprise the following: CPU 64, RAM 65, ROM 66, and a memory 69 for storing the count value of a counter, and a memory 70 for storing a current ink fountain key opening amount are connected via a bus-line (BUS) 73 together with an input/output device 71 and an interface 72.

To the input/output device 71, an ink fountain key drive motor 74 is connected via an ink fountain key drive motor driver 75, and an ink fountain key drive motor rotary encoder 76 incorporated in the ink fountain key drive motor 74 is connected via a counter 77. A detection signal from the ink fountain key drive motor rotary encoder 76 is inputted into the ink fountain key drive motor driver 75. The aforementioned switching control device 30A is connected to the interface 72.

Because of the above configuration, the switching control device 30A acts in accordance with action flows shown in FIGS. 31a through 31e and FIG. 32.

That is, it is determined in Step P1 whether a switching control start switch in the input/output device 57 is ON or not. If ON, each memory is initialized in Step P2. If not ON, it is determined in Step P3 whether a printing completion signal has been outputted from the printing press control device 61. If YES, outputting of a switching signal to the valves 60-1 through 60-M for air cylinders for switching the roller routes of all printing units is stopped in Step P4, and the program returns to Step P1. If NO, the program immediately returns to Step P1.

Then, in Step P5, the number Mmax of the printing units used in the coming printing, the printing unit No. UNm, and the ink color ICm of each printing unit UNm are inputted, and stored into the memories 42 to 44. Then, in Step P6, 1 is written into the memory 46 for storing the count value M. Also, in Step P7, 1 is written into the memory 52 for storing the count value N2.

Then, in Step P8, the No. UNm of the Mth printing unit used in the coming printing is read from the memory 43. Then, in Step P9, a command for transmitting the opening amount Kmn2 of the ink fountain key is outputted to the N2th ink fountain key opening amount control devices 62-1 to 62-(M×N) of the printing unit of the printing unit No. UNm. Then, if, in Step P10, the opening amount Kmn2 of the ink fountain key is transmitted from the N2th ink fountain key opening amount control devices 62-1 to 62-(M×N) of the printing unit of the printing unit No. UNm, the opening amount Kmn2 of the ink fountain key is received from the N2th ink fountain key opening amount control devices 62-1 to 62-(M×N) of the printing unit of the printing unit No. UNm, and stored in the memory 39, in Step P11.

Then, in Step P12, 1 is added to the count value N2, and the sum is written over the memory 52. Then, in Step P13, the total number Nmax of the ink fountain keys of each printing unit is read from the memory 51, and in Step P14, it is determined whether the count value N2 is greater than the total number Nmax of the ink fountain keys for each color.

If YES in Step P14, 1 is added to the count value M, and the sum is written over the memory 46 in Step P15. If NO in Step P14, the program returns to Step P9.

Then, in Step P16, the number Mmax of the printing units used in the coming printing is read from the memory 42. Then, in Step P17, it is determined whether the count value M is greater than the number Mmax of the printing units used in the coming printing. If YES, 1 is written into the memory 46 for storing the count value M, in Step P18. If NO, the program returns to Step P7.

Then, in Step P19, 2 is written into the memory 47 for storing the count value N1. Then, in Step P20, the No. UNm of the Mth printing unit used in the coming printing is read from the memory 43. Then, in Step P21, the opening amount Km(n1-1) of the (N1-1)th ink fountain key of the Mth printing unit UNm used in the coming printing is read from the memory 39.

Then, in Step P22, the opening amount Kmn1 of the N1th ink fountain key of the Mth printing unit UNm used in the coming printing is read from the memory 39. Then, in Step P23, the difference (Km(n1-1)−Kmn1) between the opening amount Km(n1-1) of the (N1-1)th ink fountain key of the Mth printing unit UNm used in the coming printing and the opening amount Kmn1 of the N1th ink fountain key is computed, and stored into the memory 99.

Then, in Step P24, the absolute value |Km(n1-1)−Kmn1| of the difference between the opening amount Km(n1-1) of the (N1-1)th ink fountain key of the Mth printing unit UNm used in the coming printing and the opening amount Kmn1 of the N1th ink fountain key is computed, and stored into the memory 100. Then, in Step P25, the ink color ICm of the Mth printing unit UNm used in the coming printing is read from the memory 44.

Then, in Step P26, the first reference value R1m for switching corresponding to the ink color ICm of the Mth printing unit UNm used in the coming printing is read from the memory 50. Then, in Step P27, it is determined whether the absolute value |Km(n1-1)−Kmn1| of the difference between the opening amount Km(n1-1) of the (N1-1)th ink fountain key of the Mth printing unit UNm used in the coming printing and the opening amount Kmn1 of the N1th ink fountain key is equal to or larger than the first reference value R1m for switching corresponding to the ink color of the Mth printing unit UNm used in the coming printing.

If YES in Step P27, 1 is written into the memory 52 for storing the count value N2 in Step P28. If NO, the program shifts to Step P42 to be described later.

Then, in Step P29, the memory 97 for storing the total value Ks of the opening amounts of the ink fountain keys of the printing unit UNm used in the coming printing is initialized. Then, in Step P30, the opening amount Kmn2 of the N2th ink fountain key of the Mth printing unit UNm used in the coming printing is read from the memory 39. Then, in Step P31, the value of the memory 97 for storing the total value Ks of the opening amounts of the ink fountain keys of the printing unit UNm used in the coming printing is loaded.

Then, in Step P32, the opening amount Kmn2 of the N2th ink fountain key of the Mth printing unit UNm used in the coming printing is added to the value of the memory for storing the total value Ks of the opening amounts of the ink fountain keys of the printing unit UNm used in the coming printing, and the sum is written over the memory 97 for storing the total value Ks of the opening amounts of the ink fountain keys of the printing unit UNm used in the coming printing. Then, in Step P33, 1 is added to the count value N2, and the sum is written over the memory 52.

Then, in Step P34, the total number Nmax of the ink fountain keys of each printing unit is read from the memory 51. Then, in Step P35, it is determined whether the count value N2 is greater than the total number Nmax of the ink fountain keys of each printing unit. If YES, the value of the memory 97 for storing the total value Ks of the opening amounts of the ink fountain keys of the printing unit UNm used in the coming printing is loaded in Step P36. If NO, the program returns to Step P30.

Then, in Step P37, the total number Nmax of the ink fountain keys of each printing unit is read from the memory 51. Then, in Step P38, the value of the memory for storing the total value Ks of the opening amounts of the ink fountain keys of the printing unit UNm used in the coming printing is divided by the total number Nmax of the ink fountain keys of each printing unit to obtain the average value Kam of the opening amounts of the ink fountain keys of the Mth printing unit UNm used in the coming printing, and the average value Kam is stored in the memory 98.

Then, in Step P39, the second reference value R2m for switching corresponding to the ink color ICm of the Mth printing unit UNm used in the coming printing is read from the memory 36. Then, in Step P40, it is determined whether the average value Kam of the opening amounts of the ink fountain keys of the Mth printing unit UNm used in the coming printing is equal to or greater than the second reference value R2m for switching corresponding to the ink color of the Mth printing unit UNm used in the coming printing.

If YES in Step P40, the No. UNm of the Mth printing unit used in the coming printing is written into the memory 37 for storing the printing unit No. for switching roller throw-on in Step P41. Then, the program shifts to Step P45 to be described later. If NO, 1 is added to the count value N1, and the sum is written over the memory 47, in Step P42.

Then, in Step P43, the total number Nmax of the ink fountain keys of each printing unit is read from the memory 51. Then, in Step P44, it is determined whether the count value N1 is greater than the total number Nmax of the ink fountain keys for each color. If YES, 1 is added to the count value M, and the sum is written over the memory 46, in Step P45. If NO, the program returns to Step P21.

Then, in Step P46, the number Mmax of the printing units used in the coming printing is read from the memory 42. Then, in Step P47, it is determined whether the count value M is greater than the number Mmax of the printing units used in the coming printing. If YES, the contents of the memory 37 for storing the printing unit No. for switching roller throw-on are written into the memory 40 for storing the printing unit No. for switching roller throw-on setting in Step P48. If NO, the program returns to Step P20.

Then, the first printing unit No. stored in the memory 40 for storing the printing unit No. for switching roller throw-on setting is loaded in Step P49. Then, in Step P50, a switching signal is outputted to the valves 60-1 through 60-M for the roller route switching air cylinders of the first printing unit No. stored in the memory 40 for storing the printing unit No. for switching roller throw-on setting. Then, in Step P51, the first printing unit No. is deleted from the memory 40 for storing the printing unit No. for switching roller throw-on setting.

Then, in Step P52, the contents of the memory 40 for storing the printing unit No. for switching roller throw-on setting are checked. Then, in Step P53, it is determined whether the stored printing unit No. is absent in the memory 40 for storing the printing unit No. for switching roller throw-on setting. If YES, the program returns to Step P1. If NO, the program returns to Step P49.

The first ink fountain key opening amount control device 62-1 through the (M×N)th ink fountain key opening amount control device 62-(M×N) also act in accordance with an action flow shown in FIG. 33.

That is, if the opening amount Kmn2 of the ink fountain key is transmitted from the switching control device 30A in Step P1, the count value of the counter 77 is loaded, and stored in the memory 69 in Step P2. Then, in Step P3, the current ink fountain key opening amount is computed from the count value of the counter 77, and stored in the memory 70.

Then, in Step P4, the opening amount Kmn2 of the ink fountain key is transmitted to the switching control device 30A. Thereafter, this procedure is repeated.

In the present embodiment, as described above, the opening amount (Kmn) of each ink fountain key of each printing unit is found, and the difference (Km(n1-1)−Kmn1) between the opening amounts of the adjacent ink fountain keys is found. If this difference (absolute value) is equal to or greater than a certain value (first reference value R1m: third reference value in the claim) in even one of the ranges (see FIG. 5b), the ink distribution roller 4e is automatically thrown on the ink oscillating roller 5b to supply a larger amount of ink to the ink form rollers 6b, 6c on the dampening side, thus establishing an ink transport route where a ghost or the like minimally occurs (i.e., first ink transport route). If there is no such range (see FIG. 5a), on the other hand, the ink distribution roller 4e is automatically thrown off the ink oscillating roller 5b to supply a smaller amount of ink to the ink form rollers 6b, 6c on the dampening side, thus establishing an ink transport route where color irregularities or the like minimally occur (i.e., second ink transport route).

By so doing, the burden on the operator is lightened, and the rate of operation is increased. Furthermore, forgetting to do switching is avoided, thus eliminating a waste of printing material.

If, in the present embodiment, the difference (Km(n1-1)−Kmn1) between the opening amounts of the adjacent ink fountain keys is equal to or greater than the certain value (first reference value R1m), the average of the opening amounts of the respective ink fountain keys is obtained. Only when the obtained average value (Kam) is equal to or greater than a certain value (second reference value R2m: fourth reference value in the claim), the ink distribution roller 4e is automatically thrown on the ink oscillating roller 5b to supply a larger amount of ink to the ink form rollers 6b, 6c on the dampening side, thus establishing the ink transport route where a ghost or the like minimally occurs (i.e., first ink transport route). When the average value is smaller than the certain value (second reference value R2m), on the other hand, the ink distribution roller 4e is automatically thrown off the ink oscillating roller 5b to supply a smaller amount of ink to the ink, form rollers 6b, 6c on the dampening side, thus establishing the ink transport route where the ink is minimally emulsified (i.e., second ink transport route). Furthermore, the average value (Kam) of the opening amounts of the ink fountain keys is the value obtained by dividing the total value (Ks) of the opening amounts of the ink fountain keys by the total number Nmax of the ink fountain keys of the respective printing units. Since the total number Nmax of the ink fountain keys of the respective printing units is a constant value, it goes without saying that the total value (Ks) may be obtained instead of the average value (Kam) of the opening amounts (Kmn) of the ink fountain keys, and this total value (Ks) may be compared with the certain value (second reference value R2m).

By so doing, the operator's judgment becomes unnecessary, the burden on the operator is lightened, the operator's mistake in switching is avoided, and the rate of operation is further increased. Also, a waste of printing material is eliminated further. In the above embodiment, moreover, the ink distribution roller 4e is thrown on the ink oscillating roller 5b when the opening amount difference (Km(n1-1)−Kmn1) is equal to or greater than the first reference value and the average value (Kam) is equal to or greater than the second reference value. However, the ink distribution roller 4e may be thrown on the ink oscillating roller 5b when the opening amount difference (Km(n1-1)−Kmn1) of the ink fountain key is greater than the first reference value and the average value (Kam) is greater than the second reference value.

Furthermore, in the present embodiment, unlike Embodiment 3, the actual ink fountain key opening amount (Kmn) is detected by the detection signal from the ink fountain key drive motor rotary encoder 76, without using the image area rate-ink fountain key opening amount conversion table corresponding to each ink color ICm. Thus, there is the advantage that the control device can be simplified.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ink transport route switching method in an inking device of a printing press, the inking device being arranged to supply ink stored in an ink fountain to a printing plate via an ink transport route composed of a plurality of ink rollers, and the inking device being equipped with a switching roller which moves to a first position and a second position to switch the ink transport route between a first ink transport route and a second ink transport route,
the ink transport route switching method comprising:
finding image area rates or image areas in a plurality of ranges, divided in a lateral direction, of an image to be printed;
finding a difference between the image area rates or the image areas in the adjacent ranges;
comparing the difference between the image area rates or the image areas with a first reference value for switching the ink transport route; and
moving the switching roller to the first position or the second position based on results of the comparison.

2. The ink transport route switching method in an inking device of a printing press according to claim 1, wherein
the first ink transport route is the ink transport route in which a ghost occurs with lower possibility than the second ink transport route, and
when the difference between the image area rates or the image areas is equal to or greater than, or is greater than, the first reference value, the switching roller is moved to the first position.

3. The ink transport route switching method in an inking device of a printing press according to claim 1, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the difference between the image area rates or the image areas is equal to or greater than, or is greater than, the first reference value, the switching roller is moved to the first position.

4. The ink transport route switching method in an inking device of a printing press according to claim 1, further comprising:
finding an average of the image area rates, or an average or a sum of the image areas, of a whole of the image to be printed;
comparing the average of the image area rates, or the average or the sum of the image areas, with a second reference value for switching the ink transport route; and
moving the switching roller to the first position or the second position based on results of the comparison.

5. The ink transport route switching method in an inking device of a printing press according to claim 4, wherein
the first ink transport route is the ink transport route in which a ghost occurs with lower possibility than the second ink transport route, and
when the average of the image area rates, or the average or the sum of the image areas is equal to or greater than, or is greater than, the second reference value, the switching roller is moved to the first position.

6. The ink transport route switching method in an inking device of a printing press according to claim 4, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the average of the image area rates, or the average or the sum of the image areas is equal to or greater than, or is greater than, the second reference value, the switching roller is moved to the first position.

7. The ink transport route switching method in an inking device of a printing press according to claim 1, wherein
the plurality of the ranges divided in the lateral direction are ranges corresponding to ink fountain keys.

8. An ink transport route switching method in an inking device of a printing press, the inking device being arranged to supply ink stored in an ink fountain to an ink fountain roller through clearances between ink fountain keys and the ink fountain roller, and supply the ink supplied to the ink fountain roller to a printing plate via an ink transport route composed of a plurality of ink rollers, and the inking device being equipped with a switching roller which moves to a first position and a second position to switch the ink transport route between a first ink transport route and a second ink transport route,
the ink transport route switching method comprising:
finding a difference between opening amounts of the adjacent ink fountain keys;
comparing the difference between the opening amounts of the ink fountain keys with a third reference value for switching the ink transport route; and
moving the switching roller to the first position or the second position based on results of the comparison.

9. The ink transport route switching method in an inking device of a printing press according to claim 8, wherein
the first ink transport route is the ink transport route in which a ghost occurs with lower possibility than the second ink transport route, and
when the difference between the opening amounts of the ink fountain keys is equal to or greater than, or is greater than, the third reference value, the switching roller is moved to the first position.

10. The ink transport route switching method in an inking device of a printing press according to claim 8, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the difference between the opening amounts of the ink fountain keys is equal to or greater than, or is greater than, the third reference value, the switching roller is moved to the first position.

11. The ink transport route switching method in an inking device of a printing press according to claim 8, further comprising:
finding an average or a sum of the opening amounts of all the ink fountain keys for each color;
comparing the average or the sum of the opening amounts of all the ink fountain keys for each color with a fourth reference value for switching the ink transport route; and
moving the switching roller to the first position or the second position based on results of the comparison.

12. The ink transport route switching method in an inking device of a printing press according to claim 11, wherein
the first ink transport route is the ink transport route in which a ghost occurs with lower possibility than the second ink transport route, and
when the average or the sum of the opening amounts of all the ink fountain keys for each color is equal to or greater than, or is greater than, the fourth reference value, the switching roller is moved to the first position.

13. The ink transport route switching method in an inking device of a printing press according to claim 11, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the average or the sum of the opening amounts of all the ink fountain keys for each color is equal to or greater than, or is greater than, the fourth reference value, the switching roller is moved to the first position.

14. The ink transport route switching method in an inking device of a printing press according to claim 1 or 8, further comprising performing processings for each color.

15. An ink transport route switching apparatus in an inking device of a printing press, the inking device being arranged to supply ink stored in an ink fountain to a printing plate via an ink transport route composed of a plurality of ink rollers, and the inking device being equipped with a switching roller which moves to a first position and a second position to switch the ink transport route between a first ink transport route and a second ink transport route,
the ink transport route switching apparatus comprising:
a control device which
finds image area rates or image areas in a plurality of ranges, divided in a lateral direction, of an image to be printed,
finds a difference between the image area rates or the image areas in the adjacent ranges,
compares the difference between the image area rates or the image areas with a first reference value for switching the ink transport route, and
moves the switching roller to the first position or the second position based on results of the comparison.

16. The ink transport route switching apparatus in an inking device of a printing press according to claim 15, wherein
the first ink transport route is the ink transport route in which a ghost occurs with lower possibility than the second ink transport route, and
when the difference between the image area rates or the image areas is equal to or greater than, or is greater than, the first reference value, the control device moves the switching roller to the first position.

17. The ink transport route switching apparatus in an inking device of a printing press according to claim 15, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the difference between the image area rates or the image areas is equal to or greater than, or is greater than, the first reference value, the control device moves the switching roller to the first position.

18. The ink transport route switching apparatus in an inking device of a printing press according to claim 15, wherein the control device
finds an average of the image area rates, or an average or a sum of the image areas, of a whole of the image to be printed,
compares the average of the image area rates, or the average or the sum of the image areas, with a second reference value for switching the ink transport route; and
moves the switching roller to the first position or the second position based on results of the comparison.

19. The ink transport route switching apparatus in an inking device of a printing press according to claim 18, wherein
the first ink transport route is the ink transport route in which a ghost occurs with lower possibility than the second ink transport route, and
when the average of the image area rates, or the average or the sum of the image areas is equal to or greater than, or is greater than, the second reference value, the control device moves the switching roller to the first position.

20. The ink transport route switching apparatus in an inking device of a printing press according to claim 18, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the average of the image area rates, or the average or the sum of the image areas is equal to or greater than, or is greater than, the second reference value, the control device moves the switching roller to the first position.

21. The ink transport route switching apparatus in an inking device of a printing press according to claim 15, wherein
the plurality of the ranges divided in the lateral direction are ranges corresponding to ink fountain keys.

22. An ink transport route switching apparatus in an inking device of a printing press, the inking device being arranged to supply ink stored in an ink fountain to an ink fountain roller through clearances between ink fountain keys and the ink fountain roller, and supply the ink supplied to the ink fountain roller to a printing plate via an ink transport route composed of a plurality of ink rollers, and the inking device being equipped with a switching roller which moves to a first position and a second position to switch the ink transport route between a first ink transport route and a second ink transport route,
the ink transport route switching apparatus comprising:
a control device which
finds a difference between opening amounts of the adjacent ink fountain keys,
compares the difference between the opening amounts of the ink fountain keys with a third reference value for switching the ink transport route, and
moves the switching roller to the first position or the second position based on results of the comparison.

23. The ink transport route switching apparatus in an inking device of a printing press according to claim 22, wherein
the first ink transport route is the ink transport route in which a ghost occurs with lower possibility than the second ink transport route, and
when the difference between the opening amounts of the ink fountain keys is equal to or greater than, or is greater than, the third reference value, the control device moves the switching roller to the first position.

24. The ink transport route switching apparatus in an inking device of a printing press according to claim 22, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the difference between the opening amounts of the ink fountain keys is equal to or greater than, or is greater than, the third reference value, the control device moves the switching roller to the first position.

25. The ink transport route switching apparatus in an inking device of a printing press according to claim 22, wherein the control device
finds an average or a sum of the opening amounts of all the ink fountain keys for each color,
compares the average or the sum of the opening amounts of all the ink fountain keys for each color with a fourth reference value for switching the ink transport route, and
moves the switching roller to the first position or the second position based on results of the comparison.

26. The ink transport route switching apparatus in an inking device of a printing press according to claim 25, wherein
the first ink transport route is the ink transport route in which a ghost occurs with lower possibility than the second ink transport route, and
when the average or the sum of the opening amounts of all the ink fountain keys for each color is equal to or greater than, or is greater than, the fourth reference value, the control device moves the switching roller to the first position.

27. The ink transport route switching apparatus in an inking device of a printing press according to claim 25, the inking device further comprising a plurality of ink form rollers for supplying the ink to the printing plate, and a dampener for supplying dampening water to the printing plate, wherein
the first ink transport route is the ink transport route for supplying a larger amount of the ink to the ink form rollers on a side of the dampener than the second ink transport route, and
when the average or the sum of the opening amounts of all the ink fountain keys for each color is equal to or greater than, or is greater than, the fourth reference value, the control device moves the switching roller to the first position.

28. The ink transport route switching apparatus in an inking device of a printing press according to claim 15 or 22, arranged to perform processings for each color.
